(19) United States
(12) Patent Application Publication
(10) Pub. No.: US 2008/0284934 A1
(43) Pub. Date: Nov. 20, 2008

(54) LIQUID CRYSTAL DISPLAY DEVICE

(75) Inventors: Atsushi UMEZAKI, Atsugi (JP); Hajime KIMURA, Atsugi (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 12/120,732

(22) Filed: May 15, 2008

(30) Foreign Application Priority Data
May 18, 2007 (JP) 2007-132898

(51) Int. Cl. G02F 1/1368; G02F 1/1343; G09G 3/36

(52) U.S. Cl. 349/43; 349/139

(57) ABSTRACT

To reduce the number of components such as IC chips so that decrease in size and thickness of a display module and an electronic device on which the display module is mounted is achieved. Further, to reduce the number of components such as IC chips so that an inexpensive display module and an electronic device on which the display module is mounted are provided. An electronic device or a display module includes two display panels. One of the display panels (i.e., a peripheral portion of a display region of the one of the display panels) is provided with circuits which are necessary for operating the display panels or circuits which are necessary for an electronic device in which the display panels are incorporated. Then, the display panels or the electronic device in which the display panels are incorporated are/is driven by the circuits incorporated in the display panels.

### BACKGROUND OF THE INVENTION

1. Field of the Invention

The present invention relates to an object, a method, or a method for producing an object. In particular, the present invention relates to a display device or a semiconductor device.

2. Description of the Related Art

A liquid crystal display module which displays images by using a liquid crystal panel has been used for an image display portion of an electronic device such as a mobile phone. Further, a display module in which an organic electroluminescence (organic EL) panel is used instead of a liquid crystal panel has been put to practical use.

A display module is formed by connecting a display panel formed by using a liquid crystal element or an organic EL element and a circuit board on which a driver IC or a power supply IC is mounted with a flexible printed wiring board. A flexible printed wiring board is a resin film provided with wiring patterns formed thereover, and a driver IC is also directly mounted thereon in some cases.

An electronic device such as a mobile phone has become high functional, and an electronic device which is provided with a digital still camera or a video camera as well as a main screen and a sub screen on both surfaces of a folding housing has become the mainstream (for example, see Reference 1: Japanese Published Patent Application No. 2004-260433).

However, with high function and highly added value of an electronic device such as a mobile phone, the number of components which should be stored in a housing has been increased, and a proportion of a printed wiring board on which various IC chips, a CCD camera, and the like are mounted has not been negligible. Meanwhile, decrease in size, thickness, and weight of an electronic device such as a mobile phone has been necessary, which is incompatible with highly added value. Decrease in size and thickness of a display module and an electronic device on which the display module is mounted has been intended to be realized in Reference 2 (Japanese Published Patent Application No. 2007-47714).

### SUMMARY OF THE INVENTION

However, in Reference 2, there is a problem in that decrease in size and thickness of a display module and an electronic device on which the display module is mounted is limited because a large number of IC chips are used.

In view of the foregoing problems, it is an object of the present invention to reduce the number of components such as IC chips so that decrease in size and thickness of a display module and an electronic device on which the display module is mounted is achieved. It is another object of the present invention to reduce the number of components such as IC chips so that an inexpensive display module and an electronic device on which the display module is mounted are provided.

An electronic device or a display module includes two display panels. One of the display panels (i.e., a peripheral portion of a display region of the one of the display panels) is provided with circuits which are necessary for operating the display panels or circuits which are necessary for an electronic device in which the display panels are incorporated. Then, the display panels or the electronic device in which the display panels are incorporated are/is driven by the circuits incorporated in the display panels.

A liquid crystal display device in accordance with one aspect of the present invention includes a first display panel including a first terminal and a first display screen having a first liquid crystal element; a second display panel including a second terminal, a circuit group, and a second display screen having a second liquid crystal element; and a substrate including a wiring. The circuit group is electrically connected to the first terminal through the second terminal and the wiring.

A liquid crystal display device in accordance with another aspect of the present invention includes a first display panel including a first terminal and a first display screen having a first liquid crystal element; a second display panel including a second terminal, a circuit group, and a second display screen having a second liquid crystal element; a substrate including a wiring; and an integrated circuit. The circuit group is electrically connected to the first terminal through the second terminal and the wiring. The integrated circuit is electrically connected to the second terminal through the wiring.

A liquid crystal display device in accordance with another aspect of the present invention includes a first display panel including a first terminal and a first display screen having a first liquid crystal element; a second display panel including a second terminal, a circuit group, and a second display screen having a second liquid crystal element; a substrate including a wiring; and a sensor. The circuit group is electrically connected to the first terminal through the second terminal and the wiring. The sensor is electrically connected to the second terminal through the wiring.

A liquid crystal display device in accordance with another aspect of the present invention includes a first display panel including a first terminal and a first display screen having a first liquid crystal element; a second display panel including a second terminal, a circuit group, and a second display screen having a second liquid crystal element; a substrate including a wiring; an integrated circuit; and a sensor. The circuit group is electrically connected to the first display panel through the wiring. The integrated circuit is electrically connected to the first display panel and the second display panel through the wiring. The circuit group is electrically connected to the first terminal through the second terminal and the wiring. The integrated circuit is electrically connected to the second terminal through the wiring. The sensor is electrically connected to the second terminal through the wiring.

A liquid crystal display device in accordance with another aspect of the present invention includes a first display panel including a first terminal, a level shifter, a driver circuit, and a first display screen having a first liquid crystal element; a second display panel including a second terminal, a circuit group, and a second display screen having a second liquid crystal element; and a substrate including a wiring. The circuit group is electrically connected to the first terminal through the second terminal and the wiring.

A liquid crystal display device in accordance with another aspect of the present invention includes a first display panel including a first terminal, a level shifter, a driver circuit, and a first display screen having a first liquid crystal element; a second display panel including a second terminal, a circuit group, and a second display screen having a second liquid crystal element; a substrate including a wiring; and an integrated circuit. The circuit group is electrically connected to the first terminal through the second terminal and the wiring. The integrated circuit is electrically connected to the second terminal through the wiring.

A liquid crystal display device in accordance with another aspect of the present invention includes a first display panel including a first terminal, a level shifter, a driver circuit, and a first display screen having a first liquid crystal element; a second display panel including a second terminal, a circuit group, and a second display screen having a second liquid crystal element; a substrate including a wiring; and a sensor. The circuit group is electrically connected to the first terminal through the second terminal and the wiring. The sensor is electrically connected to the second terminal through the wiring.

A liquid crystal display device in accordance with another aspect of the present invention includes a first display panel including a first terminal, a level shifter, a driver circuit, and a first display screen having a first liquid crystal element; a second display panel including a second terminal, a circuit group, and a second display screen having a second liquid crystal element; a substrate including a wiring; an integrated circuit; and a sensor. The circuit group is electrically connected to the first display panel through the wiring. The integrated circuit is electrically connected to the first display panel through the wiring. The circuit group is electrically connected to the first terminal through the second terminal and the wiring. The integrated circuit is electrically connected to the second terminal through the wiring. The sensor is electrically connected to the second terminal through the wiring.

Note that various types of switches can be used as a switch. An electrical switch, a mechanical switch, and the like are given as examples. That is, any element can be used as long as it can control a current flow, without limiting to a certain element. For example, a transistor (e.g., a bipolar transistor or a MOS transistor), a diode (e.g., a PN diode, a PIN diode, a Schottky diode, an MIM (metal insulator metal) diode, an MIS (metal insulator semiconductor) diode, or a diode-connected transistor), a thyristor, or the like can be used as a switch. Alternatively, a logic circuit combining such elements can be used as a switch.

In the case of using a transistor as a switch, polarity (a conductivity type) of the transistor is not particularly limited because it operates just as a switch. However, a transistor of polarity with smaller off-current is preferably used when off-current is to be suppressed. Examples of a transistor with smaller off-current are a transistor provided with an LDD region, a transistor with a multi-gate structure, and the like. In addition, it is preferable that an N-channel transistor be used when a potential of a source terminal is closer to a potential of a low-potential-side power supply (e.g., Vₛₛ, GND, or 0 V), while a P-channel transistor be used when the potential of the source terminal is closer to a potential of a high-potential-side power supply (e.g., V_{dd}). This is because the absolute value of gate-source voltage can be increased when the potential of the source terminal is closer to a potential of a low-potential-side power supply in an N-channel transistor and when the potential of the source terminal is closer to a potential of a high-potential-side power supply in a P-channel transistor, so that the transistor can be easily operated as a switch. This is also because the transistor does not often perform a source follower operation, so that reduction in output voltage does not often occur.

Note that a CMOS switch may be used as a switch by using both N-channel and P-channel transistors. When a CMOS switch is used, the switch can more precisely operate as a switch because current can flow when either the P-channel transistor or the N-channel transistor is turned on. For example, voltage can be appropriately output regardless of whether voltage of an input signal to the switch is high or low. In addition, since a voltage amplitude value of a signal for turning on or off the switch can be made smaller, power consumption can be reduced.

Note that when a transistor is used as a switch, the switch includes an input terminal (one of a source terminal and a drain terminal), an output terminal (the other of the source terminal and the drain terminal), and a terminal for controlling conduction (a gate terminal). On the other hand, when a diode is used as a switch, the switch does not have a terminal for controlling conduction in some cases. Therefore, when a diode is used as a switch, the number of wirings for controlling terminals can be further reduced compared to the case of using a transistor as a switch.

Note that when it is explicitly described that “A and B are connected”, the case where A and B are electrically connected, the case where A and B are functionally connected, and the case where A and B are directly connected are included therein. Here, each of A and B corresponds to an object (e.g., a device, an element, a circuit, a wiring, an electrode, a terminal, a conductive film, or a layer). Accordingly, another element may be interposed between elements having a connection relation shown in drawings and texts, without limiting to a predetermined connection relation, for example, the connection relation shown in the drawings and the texts.

For example, in the case where A and B are electrically connected, one or more elements which enable electric connection between A and B (e.g., a switch, a transistor, a capacitor, an inductor, a resistor, and/or a diode) may be provided between A and B. In addition, in the case where A and B are functionally connected, one or more circuits which enable functional connection between A and B (e.g., a logic circuit such as an inverter, a NAND circuit, or a NOR circuit, a signal converter circuit such as a DA converter circuit, an AD converter circuit, or a gamma correction circuit, a potential level converter circuit such as a power supply circuit (e.g., a dc-dc converter, a step-up dc-dc converter, or a step-down dc-dc converter) or a level shifter circuit for changing a potential level of a signal, a voltage source, a current source, a switching circuit, or an amplifier circuit such as a circuit which can increase signal amplitude, the amount of current, or the like (e.g., an operational amplifier, a differential amplifier circuit, a source follower circuit, or a buffer circuit), a signal generating circuit, a memory circuit, and/or a control circuit) may be provided between A and B. Alternatively, in the case where A and B are directly connected, A and B may be directly connected without interposing another element or another circuit therebetween.

Note that when it is explicitly described that “A and B are directly connected”, the case where A and B are directly connected (i.e., the case where A and B are connected without interposing another element or another circuit therebetween) and the case where A and B are electrically connected (i.e., the case where A and B are connected by interposing another element or another circuit therebetween) are included therein.

Note that when it is explicitly described that “A and B are electrically connected”, the case where A and B are electrically connected (i.e., the case where A and B are connected by interposing another element or another circuit therebetween), the case where A and B are functionally connected (i.e., the case where A and B are functionally connected by interposing another circuit therebetween), and the case where A and B are directly connected (i.e., the case where A and B are connected without interposing another element or another circuit therebetween) are included therein. That is, when it is explicitly described that “A and B are electrically connected”, the description is the same as the case where it is explicitly only described that “A and B are connected”.

Note that a display element, a display device which is a device having a display element, a light-emitting element, and a light-emitting device which is a device having a light-emitting element can use various types and can include various elements. For example, a display medium, whose contrast, luminance, reflectivity, transmittivity, or the like changes by an electromagnetic action, such as an EL element (e.g., an EL element including organic and inorganic materials, an organic EL element, or an inorganic EL element), an electron emitter, a liquid crystal element, electronic ink, an electrophoresis element, a grating light valve (GLV), a plasma display panel (PDP), a digital micromirror device (DMD), a piezoelectric ceramic display, or a carbon nanotube can be used as a display element, a display device, a light-emitting element, or a light-emitting device. Note that display devices using an EL element include an EL display; display devices using an electron emitter include a field emission display (FED), an SED-type flat panel display (SED: surface-conduction electron-emitter display), and the like; display devices using a liquid crystal element include a liquid crystal display (e.g., a transmissive liquid crystal display, a transflective liquid crystal display, a reflective liquid crystal display, a direct-view liquid crystal display, or a projection liquid crystal display); and display devices using electronic ink or an electrophoresis element include electronic paper.

Note that an EL element is an element having an anode, a cathode, and an EL layer interposed between the anode and the cathode. Note that as an EL layer, a layer utilizing light emission (fluorescence) from a singlet exciton, a layer utilizing light emission (phosphorescence) from a triplet exciton, a layer utilizing light emission (fluorescence) from a singlet exciton and light emission (phosphorescence) from a triplet exciton, a layer formed of an organic material, a layer formed of an inorganic material, a layer formed of an organic material and an inorganic material, a layer including a high-molecular material, a layer including a low molecular material, a layer including a low-molecular material and a high-molecular material, or the like can be used. Note that the present invention is not limited to this, and various EL elements can be used as an EL element.

Note that an electron emitter is an element in which electrons are extracted by high electric field concentration on a pointed cathode. For example, as an electron emitter, a Spindt type, a carbon nanotube (CNT) type, a metal-insulator-metal (MIM) type in which a metal, an insulator, and a metal are stacked, a metal-insulator-semiconductor (MIS) type in which a metal, an insulator, and a semiconductor are stacked, a MOS type, a silicon type, a thin film diode type, a diamond type, a surface conduction emitter SCD type, a thin film type in which a metal, an insulator, a semiconductor, and a metal are stacked, a HEED type, an EL type, a porous silicon type, a surface-conduction (SED) type, or the like can be used. However, the present invention is not limited to this, and various elements can be used as an electron emitter.

Note that a liquid crystal element is an element which controls transmission or non-transmission of light by optical modulation action of a liquid crystal and includes a pair of electrodes and a liquid crystal. Note that optical modulation action of a liquid crystal is controlled by an electric filed applied to the liquid crystal (including a horizontal electric field, a vertical electric field, and an oblique electric field). Note that the following can be used for a liquid crystal element: a nematic liquid crystal, a cholesteric liquid crystal, a smectic liquid crystal, a discotic liquid crystal, a thermotropic liquid crystal, a lyotropic liquid crystal, a low-molecular liquid crystal, a high-molecular liquid crystal, a ferroelectric liquid crystal, an anti-ferroelectric liquid crystal, a main-chain liquid crystal, a side-chain high-molecular liquid crystal, a plasma addressed liquid crystal (PALC), a banana-shaped liquid crystal, and the like. In addition, the following can be used as a diving method of a liquid crystal: a TN (twisted nematic) mode, an STN (super twisted nematic) mode, an IPS (in-plane-switching) mode, an FFS (fringe field switching) mode, an MVA (multi-domain vertical alignment) mode, a PVA (patterned vertical alignment) mode, an ASV (advanced super view) mode, an ASM (axially symmetric aligned microcell) mode, an OCB (optical compensated birefringence) mode, an ECB (electrically controlled birefringence) mode, an FLC (ferroelectric liquid crystal) mode, an AFLC (anti-ferroelectric liquid crystal) mode, a PDLC (polymer dispersed liquid crystal) mode, a guest-host mode, and the like. Note that the present invention is not limited to this, and various liquid crystal elements and driving methods can be used as a liquid crystal element and a driving method thereof.

Note that electronic paper corresponds to a device which displays an image by molecules which utilize optical anisotropy, dye molecular orientation, or the like; a device which displays an image by particles which utilize electrophoresis, particle movement, particle rotation, phase change, or the like; a device which displays an image by moving one end of a film; a device which displays an image by using coloring properties or phase change of molecules; a device which displays an image by using optical absorption by molecules; and a device which displays an image by using self-light emission by bonding electrons and holes. For example, the following can be used for electronic paper: microcapsule electrophoresis, horizontal electrophoresis, vertical electrophoresis, a spherical twisting ball, a magnetic twisting ball, a columnar twisting ball, a charged toner, electro liquid powder, magnetic electrophoresis, a magnetic thermosensitive type, an electrowetting type, a light-scattering (transparent-opaque change) type, a cholesteric liquid crystal and a photoconductive layer, a cholesteric liquid crystal device, a bistable nematic liquid crystal, a ferroelectric liquid crystal, a liquid crystal dispersed type with a dichroic dye, a movable film, coloring and decoloring properties of a leuco dye, a photochromic material, an electrochromic material, an electrodeposition material, flexible organic EL, and the like. Note that the present invention is not limited to this, and a variety of electronic paper can be used as electronic paper. Here, when microcapsule electrophoresis is used, defects of electrophoresis, which are aggregation and precipitation of phoresis particles, can be solved. Electro liquid powder has advantages such as high-speed response, high reflectivity, wide viewing angle, low power consumption, and memory properties.

Note that a plasma display panel has a structure in which a substrate having a surface provided with an electrode and a substrate having a surface provided with an electrode and a minute groove in which a phosphor layer is formed face each other at a narrow interval and a rare gas is sealed therein. Note that display can be performed by applying voltage between the electrodes to generate an ultraviolet ray so that a phosphor emits light. Note that the plasma display panel may be a DC-type PDP or an AC-type PDP. For the plasma display panel, AWS (address while sustain) driving, ADS (address display separated) driving in which a subframe is divided into a reset period, an address period, and a sustain period, CLEAR (high-contrast, low energy address and reduction of false contour sequence) driving, ALIS (alternate lighting of surfaces) method, TERES (technology of reciprocal sustainer) driving, or the like can be used. Note that the present invention is not limited to this, and various plasma display panels can be used as a plasma display panel.

Note that electroluminescence, a cold cathode fluorescent lamp, a hot cathode fluorescent lamp, an LED, a laser light source, a mercury lamp, or the like can be used as a light source of a display device in which a light source is necessary, such as a liquid crystal display (a transmissive liquid crystal display, a transflective liquid crystal display, a reflective liquid crystal display, a direct-view liquid crystal display, or a projection liquid crystal display), a display device using a grating light valve (GLV), or a display device using a digital micromirror device (DMD). Note that the present invention is not limited to this, and various light sources can be used as a light source.

Note that various types of transistors can be used as a transistor, without limiting to a certain type. For example, a thin film transistor (TFT) including a non-single crystal semiconductor film typified by amorphous silicon, polycrystalline silicon, microcrystalline (also referred to as semi-amorphous) silicon, or the like can be used. In the case of using the TFT, there are various advantages. For example, since the TFT can be formed at temperature lower than that of the case of using single-crystal silicon, manufacturing cost can be reduced or a manufacturing apparatus can be made larger. Since the manufacturing apparatus is made larger, the TFT can be formed using a large substrate. Therefore, many display devices can be formed at the same time at low cost. In addition, a substrate having low heat resistance can be used because of low manufacturing temperature. Therefore, the transistor can be formed using a light-transmitting substrate. Accordingly, transmission of light in a display element can be controlled by using the transistor formed using the light-transmitting substrate. Alternatively, part of a film which forms the transistor can transmit light because the film thickness of the transistor is thin. Therefore, the aperture ratio can be improved.

Note that when a catalyst (e.g., nickel) is used in the case of forming polycrystalline silicon, crystallinity can be further improved and a transistor having excellent electric characteristics can be formed. Accordingly, a gate driver circuit (e.g., a scan line driver circuit), a source driver circuit (e.g., a signal line driver circuit), and/or a signal processing circuit (e.g., a signal generation circuit, a gamma correction circuit, or a DA converter circuit) can be formed over the same substrate as a pixel portion.

Note that when a catalyst (e.g., nickel) is used in the case of forming microcrystalline silicon, crystallinity can be further improved and a transistor having excellent electric characteristics can be formed. At this time, crystallinity can be improved by just performing heat treatment without performing laser irradiation. Accordingly, a gate driver circuit (e.g., a scan line driver circuit) and part of a source driver circuit (e.g., an analog switch) can be formed over the same substrate. In addition, in the case of not performing laser irradiation for crystallization, crystallinity unevenness of silicon can be suppressed. Therefore, a clear image can be displayed.

Note that polycrystalline silicon and microcrystalline silicon can be formed without using a catalyst (e.g., nickel).

Note that it is preferable that crystallinity of silicon be improved to polycrystal, microcrystal, or the like in the whole panel; however, the present invention is not limited to this. Crystallinity of silicon may be improved only in part of the panel. Selective increase in crystallinity can be achieved by selective laser irradiation or the like. For example, only a peripheral driver circuit region excluding pixels may be irradiated with laser light. Alternatively, only a region of a gate driver circuit, a source driver circuit, or the like may be irradiated with laser light. Further alternatively, only part of a source driver circuit (e.g., an analog switch) may be irradiated with laser light. Accordingly, crystallinity of silicon can be improved only in a region in which a circuit needs to be operated at high speed. Since a pixel region is not particularly needed to be operated at high speed, even if crystallinity is not improved, the pixel circuit can be operated without problems. Since a region, crystallinity of which is improved, is small, manufacturing steps can be decreased, throughput can be increased, and manufacturing cost can be reduced. Since the number of necessary manufacturing apparatus is small, manufacturing cost can be reduced.

A transistor can be formed by using a semiconductor substrate, an SOI substrate, or the like. Thus, a transistor with few variations in characteristics, sizes, shapes, or the like, with high current supply capacity, and with a small size can be formed. When such a transistor is used, power consumption of a circuit can be reduced or a circuit can be highly integrated.

A transistor including a compound semiconductor or an oxide semiconductor such as ZnO, a-InGaZnO, SiGe, GaAs, IZO, ITO, or SnO, a thin film transistor obtained by thinning such a compound semiconductor or a oxide semiconductor, or the like can be used. Thus, manufacturing temperature can be lowered and for example, such a transistor can be formed at room temperature. Accordingly, the transistor can be formed directly on a substrate having low heat resistance, such as a plastic substrate or a film substrate. Note that such a compound semiconductor or an oxide semiconductor can be used for not only a channel portion of the transistor but also other applications. For example, such a compound semiconductor or an oxide semiconductor can be used as a resistor, a pixel electrode, or a light-transmitting electrode. Further, since such an element can be formed at the same time as the transistor, cost can be reduced.

A transistor formed by using an inkjet method or a printing method, or the like can be used. Accordingly, a transistor can be formed at room temperature, can be formed at a low vacuum, or can be formed using a large substrate. In addition, since the transistor can be formed without using a mask (a reticle), a layout of the transistor can be easily changed. Further, since it is not necessary to use a resist, material cost is reduced and the number of steps can be reduced. Furthermore, since a film is formed only in a necessary portion, a material is not wasted compared with a manufacturing method in which etching is performed after the film is formed over the entire surface, so that cost can be reduced.

A transistor including an organic semiconductor or a carbon nanotube, or the like can be used. Accordingly, such a transistor can be formed using a substrate which can be bent. Therefore, a device using a transistor including an organic semiconductor or a carbon nanotube, or the like can resist a shock.

Further, transistors with various structures can be used. For example, a MOS transistor, a junction transistor, a bipolar transistor, or the like can be used as a transistor. When a MOS transistor is used, the size of the transistor can be reduced. Thus, a large number of transistors can be mounted. When a bipolar transistor is used, large current can flow. Thus, a circuit can be operated at high speed.

Note that a MOS transistor, a bipolar transistor, and the like may be formed over one substrate. Thus, reduction in power consumption, reduction in size, high speed operation, and the like can be realized.

Furthermore, various transistors can be used.

Note that a transistor can be formed using various types of substrates without limiting to a certain type. For example, a single-crystal substrate, an SOI substrate, a glass substrate, a quartz substrate, a plastic substrate, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), or the like), a leather substrate, a rubber substrate, a stainless steel substrate, a substrate including a stainless steel foil, or the like can be used as a substrate. Alternatively, a skin (e.g., epidermis or corium) or hypodermal tissue of an animal such as a human being can be used as a substrate. Further alternatively, the transistor may be formed using one substrate, and then, the transistor may be transferred to another substrate. A single-crystal substrate, an SOI substrate, a glass substrate, a quartz substrate, a plastic substrate, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), or the like), a leather substrate, a rubber substrate, a stainless steel substrate, a substrate including a stainless steel foil, or the like can be used as a substrate to which the transistor is transferred. Alternatively, a skin (e.g., epidermis or corium) or hypodermal tissue of an animal such as a human being can be used as a substrate to which the transistor is transferred. Further alternatively, the transistor may be formed using one substrate and the substrate may be thinned by polishing. A single-crystal substrate, an SOI substrate, a glass substrate, a quartz substrate, a plastic substrate, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), or the like), a leather substrate, a rubber substrate, a stainless steel substrate, a substrate including a stainless steel foil, or the like can be used as a substrate to be polished. Alternatively, a skin (e.g., epidermis or corium) or hypodermal tissue of an animal such as a human being can be used as a substrate to be polished. When such a substrate is used, a transistor with excellent properties or a transistor with low power consumption can be formed, a device with high durability, high heat resistance can be provided, or reduction in weight or thickness can be achieved.

Note that a structure of a transistor can be various modes without limiting to a certain structure. For example, a multi-gate structure having two or more gate electrodes may be used. When the multi-gate structure is used, a structure where a plurality of transistors are connected in series is provided because channel regions are connected in series. With the multi-gate structure, off-current can be reduced or the withstand voltage of the transistor can be increased to improve reliability. Alternatively, with the multi-gate structure, drain-source current does not fluctuate very much even if drain-source voltage fluctuates when the transistor operates in a saturation region, so that a flat slope of voltage-current characteristics can be obtained. When the flat slope of the voltage-current characteristics is utilized, an ideal current source circuit or an active load having an extremely high resistance value can be realized. Accordingly, a differential circuit or a current mirror circuit having excellent properties can be realized. As another example, a structure where gate electrodes are formed above and below a channel may be used. When the structure where gate electrodes are formed above and below the channel is used, a channel region is increased, so that the amount of current flowing therethrough can be increased or a depletion layer can be easily formed to decrease subthreshold swing. When the gate electrodes are formed above and below the channel, a structure where a plurality of transistors are connected in parallel is provided.

Alternatively, a structure where a gate electrode is formed above a channel region, a structure where a gate electrode is formed below a channel region, a staggered structure, an inversely staggered structure, a structure where a channel region is divided into a plurality of regions, or a structure where channel regions are connected in parallel or in series can be used. Further alternatively, a source electrode or a drain electrode may overlap with a channel region (or part of it). When the structure where the source electrode or the drain electrode may overlap with the channel region (or part of it) is used, the case can be prevented in which electric charges are accumulated in part of the channel region, which would result in an unstable operation. Further alternatively, an LDD region may be provided. When the LDD region is provided, off-current can be reduced or the withstand voltage of the transistor can be increased to improve reliability. Further, when the LDD region is provided, drain-source current does not fluctuate very much even if drain-source voltage fluctuates when the transistor operates in the saturation region, so that a flat slope of voltage-current characteristics can be obtained.

Note that various types of transistors can be used as a transistor and the transistor can be formed using various types of substrates. Accordingly, all the circuits that are necessary to realize a predetermined function may be formed using the same substrate. For example, all the circuits that are necessary to realize the predetermined function may be formed using a glass substrate, a plastic substrate, a single-crystal substrate, an SOI substrate, or any other substrate. When all the circuits that are necessary to realize the predetermined function are formed using the same substrate, cost can be reduced by reduction in the number of component parts or reliability can be improved by reduction in the number of connections to circuit components. Alternatively, part of the circuits which are necessary to realize the predetermined function may be formed using one substrate and another part of the circuits which are necessary to realize the predetermined function may be formed using another substrate. That is, not all the circuits that are necessary to realize the predetermined function are required to be formed using the same substrate. For example, part of the circuits which are necessary to realize the predetermined function may be formed by transistors using a glass substrate and another part of the circuits which are necessary to realize the predetermined function may be formed using a single-crystal substrate, so that an IC chip formed by a transistor using the single-crystal substrate may be connected to the glass substrate by COG (chip on glass) and the IC chip may be provided over the glass substrate. Alternatively, the IC chip may be connected to the glass substrate by TAB (tape automated bonding) or a printed wiring board. When part of the circuits are formed using the same substrate in this manner, cost can be reduced by reduction in the number of component parts or reliability can be improved by reduction in the number of connections to circuit components. Further alternatively, when circuits with high driving voltage and high driving frequency, which consume large power, are formed using a single-crystal semiconductor substrate instead of forming such circuits using the same substrate and an IC chip formed by the circuit is used, increase in power consumption can be prevented.

Note that pixels are provided (arranged) in matrix in some cases. Here, description that pixels are provided (arranged) in matrix includes the case where the pixels are arranged in a straight line and the case where the pixels are arranged in a jagged line, in a longitudinal direction or a lateral direction. Thus, for example, in the case of performing full color display with three color elements (e.g., RGB), the following cases are included therein: the case where the pixels are arranged in stripes and the case where dots of the three color elements are arranged in a delta pattern. In addition, the case is also included therein in which dots of the three color elements are provided in Bayer arrangement. Note that the color elements are not limited to three colors, and color elements of more than three colors may be used. For example, RGBW (W corresponds to white), RGB plus one or more of yellow, cyan, and magenta, or the like may be used. Further, the sizes of display regions may be different between respective dots of color elements. Thus, power consumption can be reduced or the life of a display element can be prolonged.

Note that an active matrix method in which an active element is included in a pixel or a passive matrix method in which an active element is not included in a pixel can be used.

In an active matrix method, as an active element (a non-linear element), not only a transistor but also various active elements (non-linear elements) can be used. For example, an MIM (metal insulator metal), a TFD (thin film diode), or the like can also be used. Since such an element has few number of manufacturing steps, manufacturing cost can be reduced or yield can be improved. Further, since the size of the element is small, the aperture ratio can be improved, so that power consumption can be reduced or high luminance can be achieved.

Note that as a method other than an active matrix method, a passive matrix method in which an active element (a non-linear element) is not used can also be used. Since an active element (a non-linear element) is not used, manufacturing steps is few, so that manufacturing cost can be reduced or the yield can be improved. Further, since an active element (a non-linear element) is not used, the aperture ratio can be improved, so that power consumption can be reduced or high luminance can be achieved.

Note that a transistor is an element having at least three terminals of a gate, a drain, and a source. The transistor has a channel region between a drain region and a source region, and current can flow through the drain region, the channel region, and the source region. Here, since the source and the drain of the transistor change depending on the structure, the operating condition, and the like of the transistor, it is difficult to define which is a source or a drain. Therefore, in this specification, a region functioning as a source and a drain may not be called the source or the drain. In such a case, one of the source and the drain may be referred to as a first terminal and the other thereof may be referred to as a second terminal, for example. Alternatively, one of the source and the drain may be referred to as a first electrode and the other thereof may be referred to as a second electrode. Further alternatively, one of the source and the drain may be referred to as a source region and the other thereof may be called a drain region.

Note that a transistor may be an element having at least three terminals of a base, an emitter, and a collector. In this case, one of the emitter and the collector may be similarly referred to as a first terminal and the other terminal may be referred to as a second terminal.

Note that a gate corresponds to all or part of a gate electrode and a gate wiring (also referred to as a gate line, a gate signal line, a scan line, a scan signal line, or the like). A gate electrode corresponds to a conductive film which overlaps with a semiconductor which forms a channel region with a gate insulating film interposed therebetween. Note that part of the gate electrode overlaps with an LDD (lightly doped drain) region or the source region (or the drain region) with the gate insulating film interposed therebetween in some cases. A gate wiring corresponds to a wiring for connecting a gate electrode of each transistor to each other, a wiring for connecting a gate electrode of each pixel to each other, or a wiring for connecting a gate electrode to another wiring.

However, there is a portion (a region, a conductive film, a wiring, or the like) which functions as both a gate electrode and a gate wiring. Such a portion (a region, a conductive film, a wiring, or the like) may be referred to as either a gate electrode or a gate wiring. That is, there is a region where a gate electrode and a gate wiring cannot be clearly distinguished from each other. For example, in the case where a channel region overlaps with part of an extended gate wiring, the overlapped portion (region, conductive film, wiring, or the like) functions as both a gate wiring and a gate electrode. Accordingly, such a portion (a region, a conductive film, a wiring, or the like) may be referred to as either a gate electrode or a gate wiring.

Note that a portion (a region, a conductive film, a wiring, or the like) which is formed using the same material as a gate electrode, forms the same island as the gate electrode, and is connected to the gate electrode may also be referred to as a gate electrode. Similarly, a portion (a region, a conductive film, a wiring, or the like) which is formed using the same material as a gate wiring, forms the same island as the gate wiring, and is connected to the gate wiring may also be referred to as a gate wiring. In a strict detect, such a portion (a region, a conductive film, a wiring, or the like) does not overlap with a channel region or does not have a function of connecting the gate electrode to another gate electrode in some cases. However, there is a portion (a region, a conductive film, a wiring, or the like) which is formed using the same material as a gate electrode or a gate wiring, forms the same island as the gate electrode or the gate wiring, and is connected to the gate electrode or the gate wiring because of specifications or the like in manufacturing. Thus, such a portion (a region, a conductive film, a wiring, or the like) may also be referred to as either a gate electrode or a gate wiring.

Note that in a multi-gate transistor, for example, a gate electrode is often connected to another gate electrode by using a conductive film which is formed using the same material as the gate electrode. Since such a portion (a region, a conductive film, a wiring, or the like) is a portion (a region, a conductive film, a wiring, or the like) for connecting the gate electrode to another gate electrode, it may be referred to as a gate wiring, and it may also be referred to as a gate electrode because a multi-gate transistor can be considered as one transistor. That is, a portion (a region, a conductive film, a wiring, or the like) which is formed using the same material as a gate electrode or a gate wiring, forms the same island as the gate electrode or the gate wiring, and is connected to the gate electrode or the gate wiring may be referred to as either a gate electrode or a gate wiring. In addition, for example, part of a conductive film which connects the gate electrode and the gate wiring and is formed using a material which is different from that of the gate electrode or the gate wiring may also be referred to as either a gate electrode or a gate wiring.

Note that a gate terminal corresponds to part of a portion (a region, a conductive film, a wiring, or the like) of a gate electrode or a portion (a region, a conductive film, a wiring, or the like) which is electrically connected to the gate electrode.

Note that when a wiring is referred to as a gate wiring, a gate line, a gate signal line, a scan line, a scan signal line, there is the case in which a gate of a transistor is not connected to a wiring. In this case, the gate wiring, the gate line, the gate signal line, the scan line, or the scan signal line corresponds to a wiring formed in the same layer as the gate of the transistor, a wiring formed using the same material of the gate of the transistor, or a wiring formed at the same time as the gate of the transistor in some cases. As examples, there are a wiring for a storage capacitor, a power supply line, a reference potential supply line, and the like.

Note that a source corresponds to all or part of a source region, a source electrode, and a source wiring (also referred to as a source line, a source signal line, a data line, a data signal line, or the like). A source region corresponds to a semiconductor region including a large amount of p-type impurities (e.g., boron or gallium) or n-type impurities (e.g., phosphorus or arsenic). Therefore, a region including a small amount of p-type impurities or n-type impurities, namely, an LDD (lightly doped drain) region is not included in the source region. A source electrode is part of a conductive layer which is formed using a material different from that of a source region and is electrically connected to the source region. However, there is the case where a source electrode and a source region are collectively referred to as a source electrode. A source wiring is a wiring for connecting a source electrode of each transistor to each other, a wiring for connecting a source electrode of each pixel to each other, or a wiring for connecting a source electrode to another wiring.

However, there is a portion (a region, a conductive film, a wiring, or the like) functioning as both a source electrode and a source wiring. Such a portion (a region, a conductive film, a wiring, or the like) may be referred to as either a source electrode or a source wiring. That is, there is a region where a source electrode and a source wiring cannot be clearly distinguished from each other. For example, in the case where a source region overlaps with part of an extended source wiring, the overlapped portion (region, conductive film, wiring, or the like) functions as both a source wiring and a source electrode. Accordingly, such a portion (a region, a conductive film, a wiring, or the like) may be referred to as either a source electrode or a source wiring.

Note that a portion (a region, a conductive film, a wiring, or the like) which is formed using the same material as a source electrode, forms the same island as the source electrode, and is connected to the source electrode, or a portion (a region, a conductive film, a wiring, or the like) which connects a source electrode and another source electrode may also be referred to as a source electrode. Further, a portion which overlaps with a source region may be referred to as a source electrode. Similarly, a portion (a region, a conductive film, a wiring, or the like) which is formed using the same material as a source wiring, forms the same island as the source wiring, and is connected to the source wiring may also be referred to as a source wiring. In a strict sense, such a portion (a region, a conductive film, a wiring, or the like) does not have a function of connecting the source electrode to another source electrode in some cases. However, there is a portion (a region, a conductive film, a wiring, or the like) which is formed using the same material as a source electrode or a source wiring, forms the same island as the source electrode or the source wiring, and is connected to the source electrode or the source wiring because of specifications or the like in manufacturing. Thus, such a portion (a region, a conductive film, a wiring, or the like) may also be referred to as either a source electrode or a source wiring.

For example, part of a conductive film which connects a source electrode and a source wiring and is formed using a material which is different from that of the source electrode or the source wiring may be referred to as either a source electrode or a source wiring.

Note that a source terminal corresponds to part of a source region, a source electrode, or a portion (a region, a conductive film, a wiring, or the like) which is electrically connected to the source electrode.

Note that when a wiring is referred to as a source wiring, a source line, a source signal line, a data line, a data signal line, there is the case in which a source (a drain) of a transistor is not connected to a wiring. In this case, the source wiring, the source line, the source signal line, the data line, or the data signal line corresponds to a wiring formed in the same layer as the source (the drain) of the transistor, a wiring formed using the same material of the source (the drain) of the transistor, or a wiring formed at the same time as the source (the drain) of the transistor in some cases. As examples, there are a wiring for a storage capacitor, a power supply line, a reference potential supply line, and the like.

Note that the same can be said for a drain.

Note that a semiconductor device corresponds to a device having a circuit including a semiconductor element (e.g., a transistor, a diode, or a thyristor). The semiconductor device may also include all devices that can function by utilizing semiconductor characteristics. In addition, the semiconductor device corresponds to a device having a semiconductor material.

Note that a display element corresponds to an optical modulation element, a liquid crystal element, a light-emitting element, an EL element (an organic EL element, an inorganic EL element, or an EL element including organic and inorganic materials), an electron emitter, an electrophoresis element, a discharging element, a light-reflective element, a light diffraction element, a digital micromirror device (DMD), or the like. Note that the present invention is not limited to this.

Note that a display device corresponds to a device having a display element. The display device may include a plurality of pixels each having a display element. Note that that the display device may also include a peripheral driver circuit for driving the plurality of pixels. The peripheral driver circuit for driving the plurality of pixels may be formed over the same substrate as the plurality of pixels. The display device may also include a peripheral driver circuit provided over a substrate by wire bonding or bump bonding, namely, an IC chip connected by chip on glass (COG) or an IC chip connected by TAB or the like. Further, the display device may also include a flexible printed circuit (FPC) to which an IC chip, a resistor, a capacitor, an inductor, a transistor, or the like is attached. Note also that the display device includes a printed wiring board (PWB) which is connected through a flexible printed circuit (FPC) and to which an IC chip, a resistor, a capacitor, an inductor, a transistor, or the like is attached. The display device may also include an optical sheet such as a polarizing plate or a retardation plate. The display device may also include a lighting device, a housing, an audio input and output device, a light sensor, or the like. Here, a lighting device such as a backlight unit may include a light guide plate, a prism sheet, a diffusion sheet, a reflective sheet, a light source (e.g., an LED or a cold cathode fluorescent lamp), a cooling device (e.g., a water cooling device or an air cooling device), or the like.

Note that a lighting device corresponds to a device having a backlight unit, a light guide plate, a prism sheet, a diffusion sheet, a reflective sheet, or a light source (e.g., an LED, a cold cathode fluorescent lamp, or a hot cathode fluorescent lamp), a cooling device, or the like.

Note that a light-emitting device corresponds to a device having a light-emitting element and the like. In the case of including a light-emitting element as a display element, the light-emitting device is one of specific examples of a display device.

Note that a reflective device corresponds to a device having a light-reflective element, a light diffraction element, light-reflective electrode, or the like.

Note that a liquid crystal display device corresponds to a display device including a liquid crystal element. Liquid crystal display devices include a direct-view liquid crystal display, a projection liquid crystal display, a transmissive liquid crystal display, a reflective liquid crystal display, a transflective liquid crystal display, and the like.

Note that a driving device corresponds to a device having a semiconductor element, an electric circuit, or an electronic circuit. For example, a transistor which controls input of a signal from a source signal line to a pixel (also referred to as a selection transistor, a switching transistor, or the like), a transistor which supplies voltage or current to a pixel electrode, a transistor which supplies voltage or current to a light-emitting element, and the like are examples of the driving device. A circuit which supplies a signal to a gate signal line (also referred to as a gate driver, a gate line driver circuit, or the like), a circuit which supplies a signal to a source signal line (also referred to as a source driver, a source line driver circuit, or the like) are also examples of the driving device.

Note that a display device, a semiconductor device, a lighting device, a cooling device, a light-emitting device, a reflective device, a driving device, and the like overlap with each other in some cases. For example, a display device includes a semiconductor device and a light-emitting device in some cases. Alternatively, a semiconductor device includes a display device and a driving device in some cases.

Note that when it is explicitly described that “B is formed on A” or “B is formed over A”, it does not necessarily mean that B is formed in direct contact with A. The description includes the case where A and B are not in direct contact with each other, i.e., the case where another object is interposed between A and B. Here, each of A and B corresponds to an object (e.g., a device, an element, a circuit, a wiring, an electrode, a terminal, a conductive film, or a layer).

Accordingly, for example, when it is explicitly described that “a layer B is formed on (or over) a layer A”, it includes both the case where the layer B is formed in direct contact with the layer A, and the case where another layer (e.g., a layer C or a layer D) is formed in direct contact with the layer A and the layer B is formed in direct contact with the layer C or D. Note that another layer (e.g., a layer C or a layer D) may be a single layer or a plurality of layers.

Similarly, when it is explicitly described that “B is formed above A”, it does not necessarily mean that B is formed in direct contact with A, and another object may be interposed therebetween. Thus, for example, when it is described that “a layer B is formed above a layer A”, it includes both the case where the layer B is formed in direct contact with the layer A, and the case where another layer (e.g., a layer C or a layer D) is formed in direct contact with the layer A and the layer B is formed in direct contact with the layer C or D. Note that another layer (e.g., a layer C or a layer D) may be a single layer or a plurality of layers.

Note that when it is explicitly described that “B is formed in direct contact with A”, it includes not the case where another object is interposed between A and B but the case where B is formed in direct contact with A.

Note that the same can be said when it is described that B is formed below or under A.

Note that when an object is explicitly described in a singular form, the object is preferably singular. Note that the present invention is not limited to this, and the object can be plural. Similarly, when an object is explicitly described in a plural form, the object is preferably plural. Note that the present invention is not limited to this, and the object can be singular.

One of two display panels (i.e., a peripheral portion of a display region of the one of the display panels) is provided with a circuit which is necessary for operating the display panels or a circuit which is necessary for an electronic device in which the display panels are incorporated. Thus, a display module can be made smaller. Further, since the number of electronic components which are mounted on the display module can be reduced, the display module can be made thinner.

### BRIEF DESCRIPTION OF THE DRAWINGS

In the accompanying drawings:

FIGS. 1A and 1B illustrate structures of display modules of the present invention;

FIG. 2 illustrates a structure of a display module of the present invention;

FIGS. 3A and 3B illustrate structures of display modules of the present invention;

FIG. 4 illustrates a structure of a display module of the present invention;

FIG. 5 illustrates a structure of a display module of the present invention;

FIGS. 6A and 6B illustrate structures of display modules of the present invention;

FIG. 7 illustrates a structure of a display module of the present invention;

FIGS. 8A and 8B illustrate structures of display modules of the present invention;

FIG. 9 illustrates a structure of a display module of the present invention;

FIGS. 10A and 10B illustrate structures of display modules of the present invention;

FIG. 11 illustrates a structure of a display module of the present invention;

FIGS. 12A and 12B illustrate structures of display modules of the present invention;

FIGS. 13A and 13B illustrate an SOI substrate used in the present invention;

FIGS. 14A and 14B illustrate an SOI substrate used in the present invention;

FIGS. 15A to 15C illustrate an SOI substrate used in the present invention;

FIG. 16 illustrates an SOI substrate used in the present invention;

FIGS. 17A to 17C illustrate an SOI substrate used in the present invention;

FIGS. 18A to 18E illustrate an SOI substrate used in the present invention;

FIGS. 19A and 19B illustrate an SOI substrate used in the present invention;

FIGS. 20A to 20C illustrate an SOI substrate used in the present invention;

FIGS. 21A and 21B illustrate an SOI substrate used in the present invention;

FIGS. 22A to 22C illustrate an SOI substrate used in the present invention;

FIGS. 23A and 23B illustrate an SOI substrate used in the present invention;

FIG. 24 illustrates an electronic device of the present invention;

FIG. 25 illustrates an electronic device of the present invention;

FIGS. 26A and 26B illustrate electronic devices of the present invention;

FIGS. 27A and 27B illustrate an electronic device of the present invention;

FIG. 28 illustrates an electronic device of the present invention;

FIG. 29 illustrates an electronic device of the present invention;

FIGS. 30A to 30C illustrate electronic devices of the present invention;

FIG. 31 illustrates an electronic device of the present invention;

FIG. 32 illustrates an electronic device of the present invention;

FIG. 33 illustrates an electronic device of the present invention;

FIG. 34 illustrates an electronic device of the present invention;

FIGS. 35A and 35B illustrate an electronic device of the present invention;

FIGS. 36A and 36B illustrate an electronic device of the present invention;

FIGS. 37A to 37C illustrate electronic devices of the present invention;

FIGS. 38A and 38B illustrate electronic devices of the present invention;

FIG. 39 illustrates an electronic device of the present invention; and

FIGS. 40A and 40B illustrate a pixel of the present invention.

### DETAILED DESCRIPTION OF THE INVENTION

Hereinafter, the present invention will be described by way of embodiment modes with reference to the drawings. Note that the present invention can be implemented in various different ways and it will be readily appreciated by those skilled in the art that various changes and modifications are possible without departing from the spirit and the scope of the present invention. Therefore, the present invention should not be construed as being limited to the description of the embodiment modes of the present invention. Note that in structures of the present invention described hereinafter, like portions or portions having similar functions are denoted by common reference numerals in different drawings, and detailed description thereof is omitted.

### Embodiment Mode 1

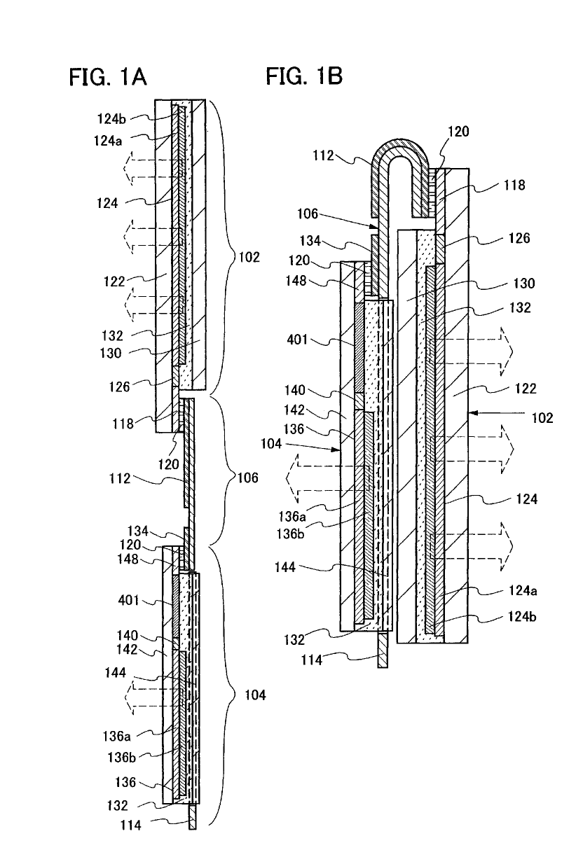

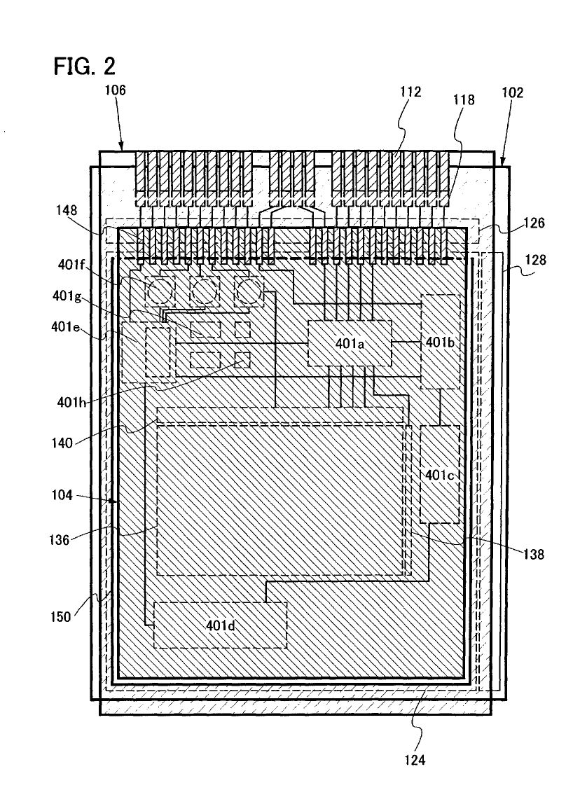

Display modules of this embodiment mode are described with reference to FIGS. 1A and 1B, and FIG. 2. FIGS. 1A and 1B, and FIG. 2 show structures of the display modules of this embodiment mode. FIGS. 1A and 1B are cross-sectional views of the display modules; FIG. 1A is a cross-sectional view of display panels which are provided in the same plane; and FIG. 1B is a cross-sectional view of the display panels which are provided back to back. FIG. 2 is a top view of the display module when it is seen from one direction. Note that since the display modules shown in FIGS. 1A and 1B are the same except for positions of the display panels, reference numerals are commonly used.

Each of the display module shown in FIG. 1A and the display module shown in FIG. 1B includes a first display panel 102, a second display panel 104, and a signal processing circuit board 106. The first display panel 102 and the second display panel 104 are provided so that images including characters, diagrams, symbols, and the like are displayed on different sides. The first display panel 102 and the second display panel 104 are different in screen size. One of the first display panel 102 and the second display panel 104 forms a main screen, and the other of the first display panel 102 and the second display panel 104 forms a sub screen.

In FIGS. 1A and 1B, external dimensions of the first display panel 102 and the second display panel 104 are made different from each other, and the external dimension (i.e., a panel area) of one of the first display panel 102 and the second display panel 104 is made smaller than that of the other of the first display panel 102 and the second display panel 104. Typically, the second display panel 104 which forms the sub screen is made smaller than the first display panel 102 which forms the main screen. In addition, in order to form a compact display module, the first display panel 102 and the second display panel 104 are provided back to back to be disposed in contact with each other or adjacent to each other, as shown in FIG. 1B. For example, the second display panel 104 is provided on an inner side of the first display panel 102.

The signal processing circuit board 106 shown in FIGS. 1A and 1B is connected to a terminal 118 of the first display panel 102 through a conductive member 120 by a first terminal 112. When the conductive member 120 is sandwiched between the first terminal 112 and the terminal 118, the conductive member 120 exhibits electrically anisotropic properties in which electric resistance between both the terminals is decreased and adjacent terminals are electrically insulated. Such a conductive member 120 is provided by using, for example, a material in which conductive fine particles (or fine particles having conductive surfaces) are dispersed in a resin medium at a concentration that the conductive fine particles are localized so as not to interact with each other. In this case, when an interval between the first terminal 112 and the terminal 118 is approximately the same as the size of the conductive fine particles, both the terminals are conducted. Similarly, a second terminal 134 of the signal processing circuit board 106 is connected to a terminal 148 of the second display panel 104 through the conductive member 120.

Note that an anisotropic conductive material can be used as the conductive member 120. An anisotropic conductive material has three functions of adhesion, conductivity, and insulation. In particular, a high molecular material called an ACF (anisotropic conductive film) or an ACP (anisotropic conductive paste) has conductivity in a thickness direction and insulating properties in a plane direction by thermocompression bonding processing.

The signal processing circuit board 106 has a surface in which the terminal 118 of the first display panel 102 and the terminal 148 of the second display panel 104 are electrically connected by a wiring extending from these connection portions. In this case, the second terminal 134 which is electrically connected to the terminal 148 of the second display panel 104 is provided over the first display panel 102. When a surface of the first display panel 102, which is opposite to a display surface, is effectively used as shown in FIG. 1B, a compact display module can be formed.

As shown in FIG. 1B, in order to connect the terminal 148 of the second display panel 104 and the first terminal 112 which is electrically connected to the terminal 118 of the first display panel 102, the signal processing circuit board 106 is preferably formed by using a flexible substrate 114 which forms an insulating surface. A polyimide film is typically used as the flexible substrate 114; however, another resin film or fiber-reinforced plastic may be used. The thickness of the flexible substrate 114 may be 30 to 300 μm, typically 80 to 160 μm. When the second display panel 104 which is disposed inside the signal processing circuit board 106 is thicker than the signal processing circuit board 106, an opening portion which is obtained by cutting part of the signal processing circuit board 106 out may be provided so that the second terminal 134 overlaps with the terminal 148 of the second display panel 104.

The second display panel 104 shown in FIGS. 1A and 1B is provided with a circuit unit 401. The circuit unit 401 is electrically connected to the terminal 148 of the second display panel 104. Examples of the circuit unit 401 are various circuits such as a driver circuit of a display panel, a timing controller, an audio/image signal processing circuit, a memory, a power supply circuit, a high-frequency circuit, a filter, a security circuit, a central processing unit (CPU), an amplifier circuit, and an interface circuit for connecting another external device such as optical communication, LAN, or USB. Note that in this specification, a circuit having any one of or a plurality of functions of a driver circuit of a display panel, a timing controller, an audio/image signal processing circuit, a memory, a power supply circuit, a high-frequency circuit, a filter, a security circuit, a central processing unit (CPU), an amplifier circuit, and an interface circuit for connecting another external device such as optical communication, LAN, or USB is also referred to as a circuit group.

FIG. 2 shows a timing controller 401a which controls a signal transmitted to the display panel, an audio/image processor 401b which controls a signal transmitted to the timing controller 401a, a CPU 401c, a memory 401d, a power supply IC 401e, a power transistor 401f, a capacitor 401g, and a coil 401h as the circuit unit 401. The timing controller 401a selects a place to which a signal is transmitted by a switching switch or a program and can be shared between the first display panel 102 and the second display panel 104. The CPU 401c controls a key input signal and a power supply system.

In the first display panel 102, a display portion 124 and the terminal 118 are formed over a first substrate 122. Besides, a scan line driver circuit 128 and a signal line driver circuit 126 may be formed. Needless to say, part of or all these driver circuits may be formed in the second display panel 104 as the circuit unit 401 or part of the circuit unit 401. In the display portion 124, a plurality of dots (hereinafter also referred to as pixels), which are the minimum units of image display, are arranged two-dimensionally in an X direction and a Y direction. The display portion 124 includes a driving element array 124a and a display element array 124b as components. When further subdivided, the driving element array 124a includes a switching element which controls ON/OFF of a signal, and a non-linear element which controls a current flow may be combined when needed.

The scan line driver circuit 128 and/or the signal line driver circuit 126 can be formed by using the same element as the driving element array 124a. In this case, a transistor, more preferably a thin film transistor (hereinafter referred to as a TFT) is often used as the element. Needless to say, a capacitor, a resistor, or an inductor may also be included. The terminal 118 is also formed by using the same conductive layer as an electrode or a wiring of these elements.

A transistor is often used as a typical switching element. A transistor can have a single-drain structure in which a channel formation region is provided between a pair of a source and a drain, an LDD structure in which a low-concentration drain (LDD) is provided between a channel formation region and a drain, or the like. Alternatively, a transistor may have a multi-gate structure in which a plurality of gate electrodes are interposed (a plurality of channel formation regions are arranged in series) between a pair of a source and a drain. In addition, single-crystal silicon, polycrystalline silicon, or amorphous silicon can be used for a semiconductor layer included in a transistor. As a structure of a transistor, a bottom-gate structure in which a semiconductor layer is formed after forming a gate electrode may be used as well as a top-gate structure in which a gate electrode is formed after forming a semiconductor layer. The bottom-gate structure is particularly preferable in the case of using amorphous silicon. Note that the present invention is not limited to this, and various elements can be used as a switching element.

The display element array 124b can be formed by using an element, optical characteristics of which are changed by electric action (e.g., a liquid crystal element), an element which emits light by carrier injection (e.g., an electroluminescence element (hereinafter also referred to as an EL element), a light-emitting diode, or a light-emitting transistor), an element which discharges electric charge (e.g., an electron source element), or the like. Note that the present invention is not limited to this, and various elements can be used as the display element array 124b.

In the second display panel 104, a display portion 136, the circuit unit 401, and the terminal 148 are formed on a second substrate 142. Besides, a scan line driver circuit 138 and a signal line driver circuit 140 may be formed. A driving element array 136a and a display element array 136b in the display portion 136 have the same structures as the driving element array and the display element array in the first display panel 102. As for the structure of such a display portion, the first display panel 102 and the second display panel 104 can be formed by using the same kind of driving element arrays and display element arrays, or may be formed by using different kinds of driving element arrays and display element arrays. For example, the display element arrays in both the first display panel 102 and the second display panel 104 can be formed by using EL elements, or one of them may be formed by using a liquid crystal element. In order to reduce the area of the circuit unit 401 formed on the second display panel 104, it is preferable that a circuit be shared between the first display panel 102 and the second display panel 104. In that case, it is preferable to use the same kind of display element arrays as in the case of forming both the display element arrays by using EL elements. Note that description “sharing of a circuit between the first display panel 102 and the second display panel 104” corresponds to forming of a structure in which a circuit for driving the display panels, for example, a timing controller, an audio/image signal processing circuit, a memory, a power supply circuit, a high-frequency circuit, a filter, a security circuit, a central processing unit (CPU), an amplifier circuit, or the like is operated by using the same circuit group.

Here, a single-crystal semiconductor layer (an SOI layer) with uniform crystal orientation, which is bonded over a substrate having an insulating surface or an insulating substrate, is preferably used as a semiconductor layer of a transistor included in the circuit unit 401. Thus, the crystal orientation of the single-crystal semiconductor layer is uniform, so that high-performance field-effect transistors which are uniform can be obtained. That is, variation in values of important transistor characteristics, such as the threshold voltage and mobility can be suppressed, so that high performance such as high mobility can be achieved. When the transistor in which the single-crystal semiconductor layer (the SOI layer) with uniform crystal orientation, which is bonded over the substrate having an insulating surface or the insulating substrate, is used for the circuit unit 401, power consumption of the circuit unit 401 can be reduced and processing speed of the circuit unit 401 can be increased. Note that the present invention is not limited to this, and a variety of silicon such as single-crystal silicon, polycrystalline silicon, microcrystalline silicon, and non-crystal silicon can be used as the semiconductor layer of the transistor included in the circuit unit 401.

Note that a transistor in which a single-crystal semiconductor layer (an SOI layer) with uniform crystal orientation, which is bonded over a substrate having an insulating surface or an insulating substrate, can be used as elements included in the driving element array 136a, the scan line driver circuit 138, and the signal line driver circuit 140 formed in the second display panel 104. Similarly, a transistor in which a single-crystal semiconductor layer (an SOI layer) with uniform crystal orientation, which is bonded over a substrate having an insulating surface or an insulating substrate, can be used as elements included in the driving element array 124a, the scan line driver circuit 128, and the signal line driver circuit 126 formed in the first display panel 102.

Various combinations can be applied to the first display panel 102 and the second display panel 104. For example, the driving element array 124a of the first display panel 102 can be formed by using a TFT to obtain a so-called active matrix driving panel, and the second display panel 104 can also be the active matrix driving panel. In this combination, the driving element array 136a of the second display panel 104 may be omitted to obtain a passive matrix panel or a segment display panel.

The first display panel 102 and the second display panel 104 can be made different in screen size and number of pixels. For example, in a usage as a mobile phone, the first display panel 102 can be a 2.4-inch type having the number of pixels of 320×240 as a QVGA (the number of pixels of 320×240×3 (RGB)), and the second display panel 104 can be a 1.1-inch type having the number of pixels of 128×96. In addition, in a usage as a computer provided with an opening and closing display screen, such as a notebook computer, the first display panel 102 can be a 15-inch type having the number of pixels of 1024×768 as an XGA (the number of pixels of 1024×768×3 (RGB)), and the second display panel 104 can be a 3-inch type having the number of pixels of 320×240 as a QVGA. Besides, the screen size and the number of pixels of the first display panel 102 and the second display panel 104 can be combined as appropriate to be applied to various electronic devices.

In the first display panel 102, at least the display portion 124 is covered with a first sealing substrate 130. The first sealing substrate 130 is fixed to the first substrate 122 with a sealing material 132. This structure is preferably employed particularly in the case of using an EL element for the display element array 124b. The first substrate 122 has a function of maintaining mechanical strength as a flat display panel as well as a function of fixing the display portion 124, the scan line driver circuit 128, the signal line driver circuit 126, and the terminal 118 by organically connecting them. Mechanical strength corresponds to thickness which prevents the display module from being easily damaged due to a shock or vibration when the display module is incorporated in a housing of an electronic device or the like, or sufficient strength which prevents the display module from being damaged in handling of a device in manufacturing. In this case, when the first substrate 122 has certain thickness to maintain the mechanical strength, the first sealing substrate 130 can be thinner than the first substrate 122. Note that when the first sealing substrate 130 is made thinner, strength thereof may be supplemented by combining a reinforcing material such as a resin film with the first sealing substrate 130.

Similarly, in the second display panel 104, a second sealing substrate 144 is fixed to the second substrate 142 with the sealing material 132. In this case, when the second substrate 142 has certain thickness to maintain mechanical strength, the second sealing substrate 144 can be thinner than the second substrate 142. Further, when the second display panel 104 is smaller than the first display panel 102, the second substrate 142 can be thinner than the first substrate 122, and the second sealing substrate 144 can be thinner than the first sealing substrate 130.

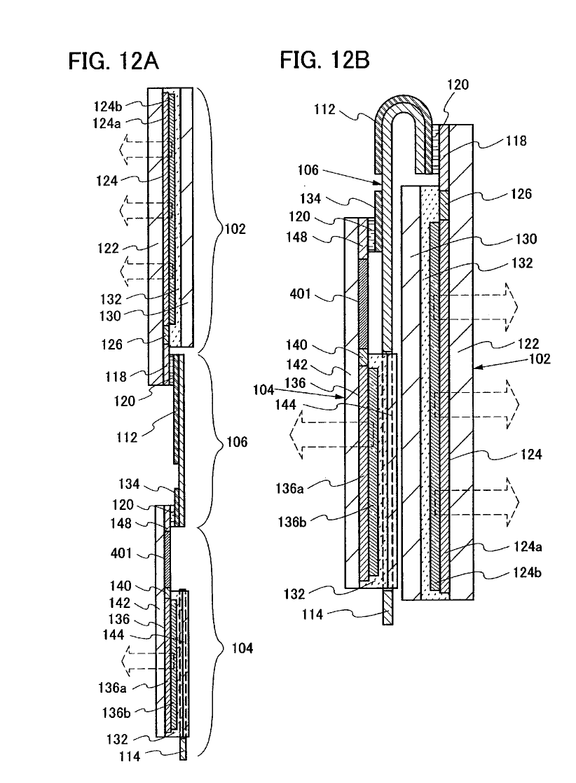

Note that in the second display panel 104, the circuit unit 401 is covered with the second sealing substrate 144. Therefore, the circuit unit 401 can be prevented from being damaged in manufacturing steps. In addition, a material included in the circuit unit 401 can be prevented from being oxidized. Note that the present invention is not limited to this, and the circuit unit 401 is not necessarily covered with the second sealing substrate 144 in the second display panel 104. FIGS. 12A and 12B are cross-sectional views of display modules in this case. FIGS. 12A and 12B are cross-sectional views of the display modules; FIG. 12A is a cross-sectional view of display panels which are provided in the same plane; and FIG. 12B is a cross-sectional view of the display panels which are provided back to back. Note that since the display modules shown in FIGS. 12A and 12B are the same except for positions of the display panels, reference numerals are commonly used. In the display modules shown in FIGS. 12A and 12B, the second sealing substrate 144 can be made smaller because the circuit unit 401 is not sealed, unlike the display modules shown in FIGS. 1A and 1B. In addition, parasitic capacitance of the circuit unit 401 can be reduced.

When the first sealing substrate 130 of the first display panel 102 and the second sealing substrate 144 of the second display panel 104 shown in FIGS. 12A and 12B are disposed in contact with each other, both the sealing substrates can be further thinned. Alternatively, the sealing substrate of the second display panel 104 may be omitted, and the first sealing substrate 130 may be shared between the first display panel 102 and the second display panel 104.

For example, the first substrate 122 and the first sealing substrate 130 shown in FIGS. 12A and 12B are each formed by using a glass substrate having a thickness of 0.5 mm; the second substrate 142 is formed by using a glass substrate having a thickness of 0.5 mm; and the second sealing substrate 144 is formed by using a glass substrate having a thickness of 0.3 mm. Then, the total thickness is 1.8 mm. In consideration of the flexible substrate 114 having a thickness of 30 to 300 μm, the total thickness is approximately 2 mm. In consideration of thicknesses of the driving element array and the display element array in the display portion and the sealing material, the total thickness thereof is less than 1 mm. Therefore, the thickness of the display module in this embodiment mode can be 3 mm or less. In a display module, it is necessary to determine the thickness of a glass substrate, which influences the thickness most, in consideration of the display panel size; however, the thickness can be freely selected in the range of 0.1 to 2 mm, preferably 0.4 to 0.7 mm.

FIGS. 1A and 1B, and FIG. 2 each show the case in which the second display panel 104 is provided with circuits and various elements which are necessary for operating the first display panel 102 and the second display panel 104 or circuits and various elements which are necessary for an electronic device in which the first display panel 102 and the second display panel 104 are incorporated as the circuit unit 401. However, the present invention is not limited to this, and various structures can be used for the display module. Some examples of display modules which are different from those in FIGS. 1A and 1B, and FIG. 2 are described below.

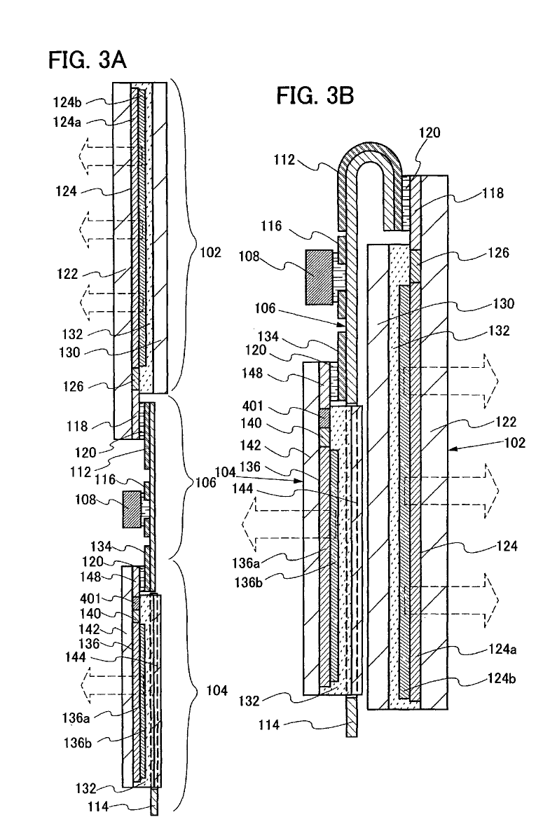

First, the case in which part of the circuit unit 401 is mounted on a display module as an IC chip is described with reference to FIGS. 3A and 3B, FIG. 4, and FIG. 5. Note that as an IC chip, there are a driver circuit of a display panel, a timing controller, an audio/image signal processing circuit, a memory, a power supply circuit, a high-frequency circuit, a filter, a security circuit, a central processing unit (CPU), an amplifier circuit, and an interface circuit for connecting another external device such as optical communication, LAN, or USB, for example.

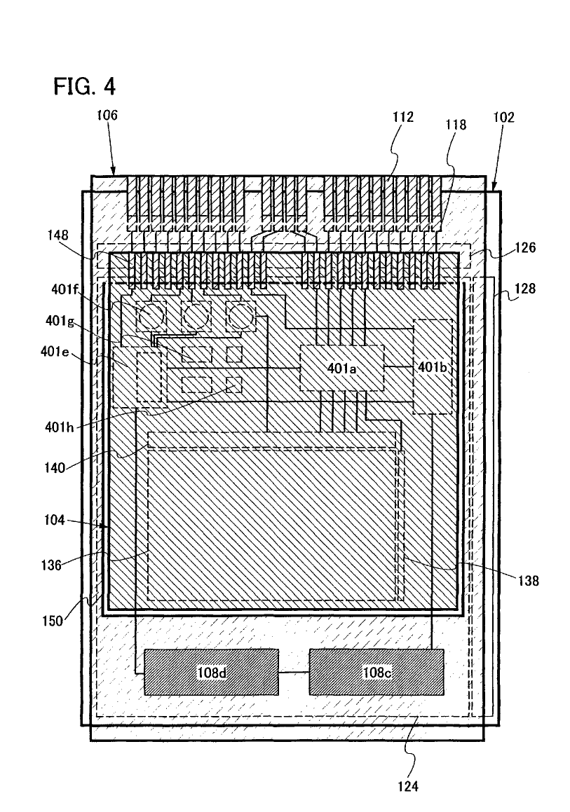

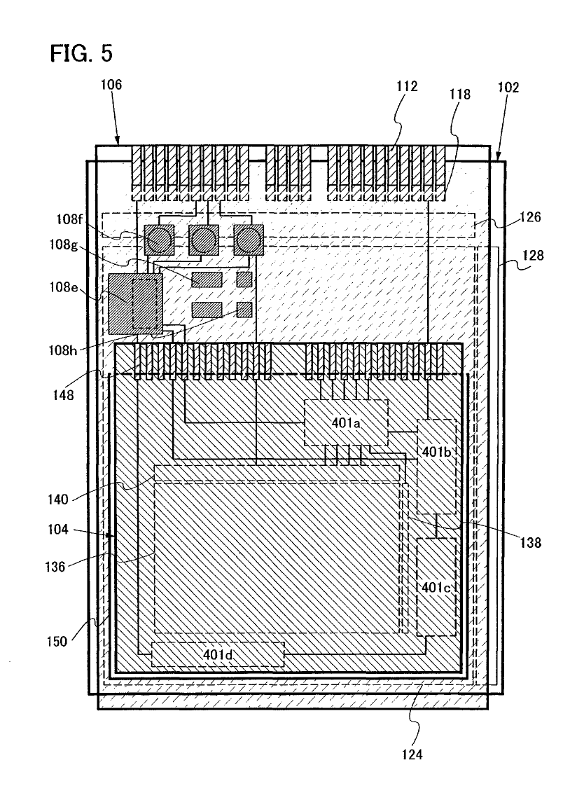

FIGS. 3A and 3B, FIG. 4, and FIG. 5 show structures of display modules. FIGS. 3A and 3B are cross-sectional views of the display modules; FIG. 3A is a cross-sectional view of display panels which are provided in the same plane; and FIG. 3B is a cross-sectional view of the display panels which are provided back to back. FIG. 4 is a top view of the display module when it is seen from one direction. FIG. 5 is a top view of a display module which is different from a display nodule of FIG. 4 when it is seen from one direction. Note that structures which are the same as the structures in FIGS. 1A and 1B, and FIG. 2 are denoted by common reference numerals, and description thereof is omitted.

The signal processing circuit board 106 shown in FIGS. 3A and 3B is connected to the terminal 118 of the first display panel 102 through the conductive member 120 by the first terminal 112. The signal processing circuit board 106 has a surface on which an IC chip 108 is mounted by a wiring 116 extending from this connection portion. The IC chip 108 is prepared as an individual component and is mounted so as to be electrically connected to the connection portion of the wiring 116 which is arranged as appropriate. As a method for mounting the IC chip 108, a connection method such as face down bonding or wire bonding is applied. The IC chip 108 is mounted so that a mounted surface overlaps with the first display panel 102. In this case, the second terminal 134 which is electrically connected to the terminal 148 of the second display panel 104 is provided over the first display panel 102.

FIG. 4 shows the CPU 108c and the memory 108d which are mounted on the signal processing circuit board 106. Besides, driver ICs (for scan line driving and signal line driving) of the first display panel 102 and the second display panel 104 can be mounted thereon. As the circuit unit 401, the timing controller 401a which controls a signal transmitted to the display panel, the audio/image processor 401b which controls a signal transmitted to the timing controller 401a, the power supply IC 401e, the power transistor 401f, the capacitor 401g, and the coil 401h are shown. In FIG. 4, when a large-scale CPU (in which the number of transistors is large) is mounted on the display module as the IC chip, the area of the circuit unit can be decreased. When a CPU in which high-speed operations are necessary is mounted on the display module as the IC chip, yield can be improved. When the memory is mounted on the display module as the IC chip, steps of forming the second display panel can be simplified.

An example which is different from that of FIG. 4 is described. FIG. 5 shows a power supply IC 108e, a power transistor 108f, a capacitor 108g, and a coil 108h which are mounted on the signal processing circuit board 106. As the circuit unit 401, the timing controller 401a which controls a signal transmitted to the display panel, the audio/image processor 401b which controls a signal transmitted to the timing controller 401a, the CPU 401c, the memory 401d are shown. In FIG. 5, when power supply-type circuits and elements are mounted on the display module as the IC chip, the power supply-type circuits and elements can be formed by using bipolar transistors having high current supply capability. Since it is not necessary to form bipolar transistors for the circuit unit, steps of forming the second display panel can be simplified.

Note that FIGS. 4 and 5 are examples. Therefore, the present invention is not limited to the structures shown in FIGS. 4 and 5. As the display module, a structure can be used in which the second display panel 104 is provided with part of circuits and various elements which are necessary for operating the first display panel 102 and the second display panel 104 or part of circuits and various elements which are necessary for an electronic device in which the first display panel 102 and the second display panel 104 are incorporated, and another part thereof is mounted on the signal processing circuit board 106 as the IC chip 108.

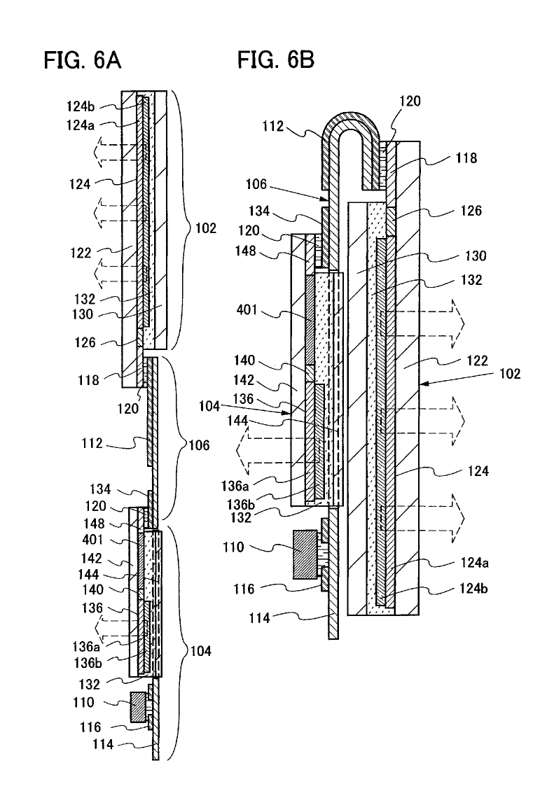

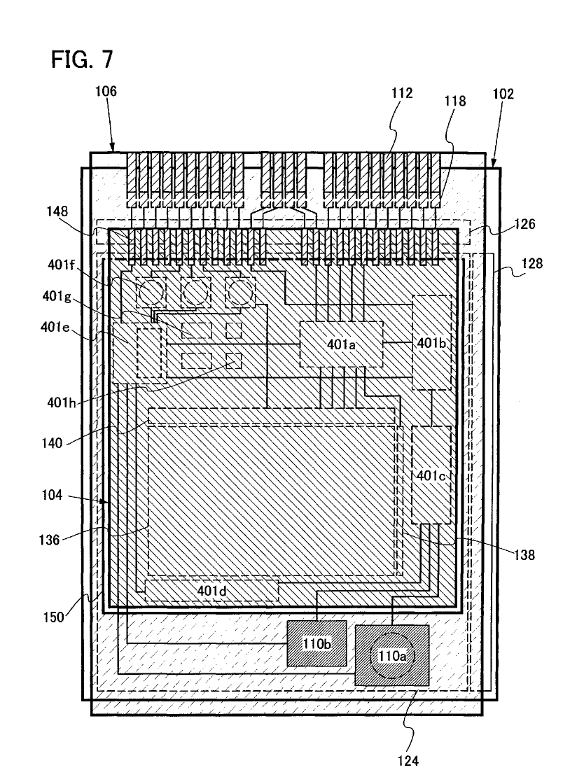

Next, the case of mounting a sensor chip on a display module is described with reference to FIGS. 6A and 6B, and FIG. 7. Note that there are various kinds of sensor chips such as an optical sensor, a CCD module (camera), a temperature sensor, a humidity sensor, an acceleration sensor, a vibration sensor, a direction sensor, a gas sensor, and a particulate sensor (e.g., a smoke sensor or a pollen sensor), for example.

FIGS. 6A and 6B, and FIG. 7 show structures of display modules. FIGS. 6A and 6B are cross-sectional views of the display modules; FIG. 6A is a cross-sectional view of display panels which are provided in the same plane; and FIG. 6B is a cross-sectional view of the display panels which are provided back to back. FIG. 7 is a top view of the display module when it is seen from one direction. Note that structures which are the same as the structures in FIGS. 1A to 5 are denoted by common reference numerals, and description thereof is omitted.

The signal processing circuit board 106 shown in FIGS. 6A and 6B is connected to the terminal 118 of the first display panel 102 through the conductive member 120 by the first terminal 112. The signal processing circuit board 106 has a surface on which a sensor chip 110 is mounted by the wiring 116 extending from this connection portion. The sensor chip 110 is prepared as an individual component and is mounted so as to be electrically connected to the connection portion of the wiring 116 which is arranged as appropriate. As a method for mounting the sensor chip 110, a connection method such as face down bonding or wire bonding is applied. The sensor chip 110 is mounted so that a mounted surface overlaps with the first display panel 102. In this case, the second terminal 134 which is electrically connected to the terminal 148 of the second display panel 104 is provided over the first display panel 102.

FIG. 7 shows a CCD module 110a and an optical sensor 110b which are mounted on the signal processing circuit board 106. When the CCD module 110a is mounted on the display module, the display module can have a function as a still camera or a video camera. When the optical sensor 110b is mounted on the display module, luminance of the display panel can be changed by change in ambient luminance.

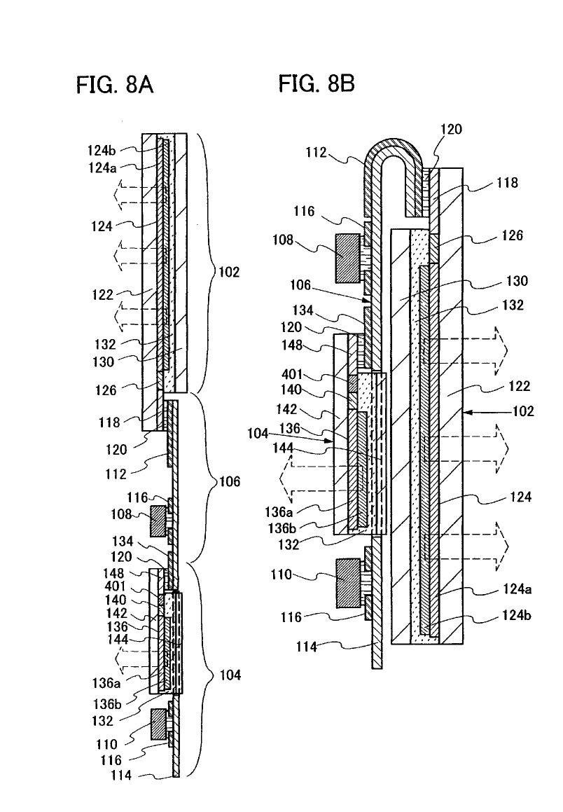

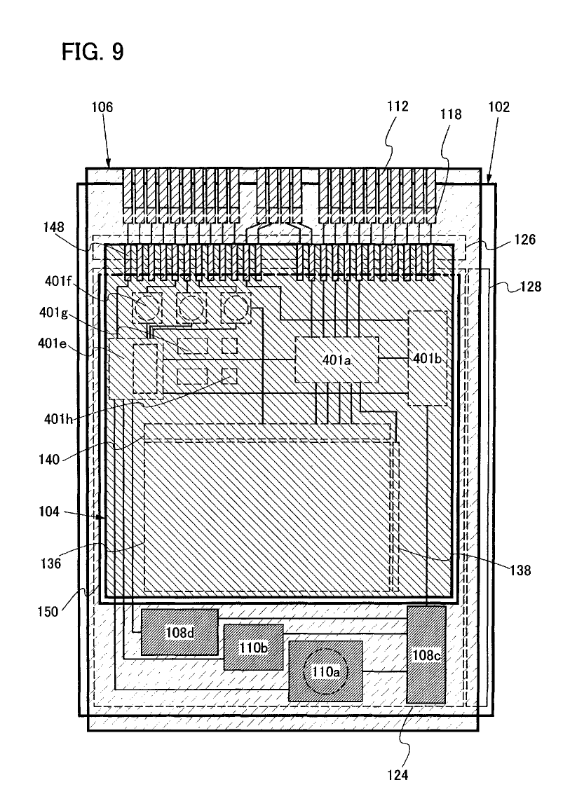

Next, the case in which part of the circuit unit 401 is mounted on the display module as the IC chip and the sensor chip is mounted on the display module is described with reference to FIGS. 8A and 8B, and FIG. 9.

FIGS. 8A and 8B, and FIG. 9 show structures of display modules. FIGS. 8A and 8B are cross-sectional views of the display modules; FIG. 8A is a cross-sectional view of display panels which are provided in the same plane; FIG. 8B is a cross-sectional view of the display panels which are provided back to back. FIG. 9 is a top view of the display module when it is seen from one direction. Note that structures which are the same as the structures in FIGS. 1A to 7 are denoted by common reference numerals, and description thereof is omitted.

The signal processing circuit board 106 shown in FIGS. 8A and 8B is connected to the terminal 118 of the first display panel 102 through the conductive member 120 by the first terminal 112. The signal processing circuit board 106 has a surface on which the IC chip 108 and the sensor chip 110 are mounted by a wiring 116 extending from this connection portion. The IC chip 108 and the sensor chip 110 are prepared as individual components and are mounted so as to be electrically connected to the connection portion of the wiring 116 which is arranged as appropriate. As a method for mounting the IC chip 108 and the sensor chip 110, a connection method such as face down bonding or wire bonding is applied. The IC chip 108 and the sensor chip 110 are mounted so that a mounted surface overlaps with the first display panel 102. In this case, the second terminal 134 which is electrically connected to the terminal 148 of the second display panel 104 is provided over the first display panel 102.

FIG. 9 shows the CCD module 110a, the optical sensor 110b, the CPU 108c, and the memory 108d which are mounted on the signal processing circuit board 106. Besides, driver ICs (for scan line driving and signal line driving) of the first display panel 102 and the second display panel 104 can be mounted thereon. As the circuit unit 401, the timing controller 401a which controls a signal transmitted to the display panel, the audio/image processor 401b which controls a signal transmitted to the timing controller 401a, the power supply IC 401e, the power transistor 401f, the capacitor 401g, and the coil 401h are shown. When the CCD module 110a is mounted on the display module, the display module can have a function as a still camera or a video camera. When the optical sensor 110b is mounted on the display module, luminance of the display panel can be changed by change in ambient luminance. When a large-scale CPU (in which the number of transistors is large) is mounted on the display module as the IC chip, the area of the circuit unit can be decreased. When a CPU in which high-speed operations are necessary is mounted on the display module as the IC chip, yield can be improved. When the memory is mounted on the display module as the IC chip, steps of forming the second display panel can be simplified.

Note that FIGS. 8A and 8B, and FIG. 9 are examples. Therefore, the present invention is not limited to the structures shown in FIGS. 8A and 8B, and FIG. 9. As the display module, a structure can be used in which the second display panel 104 is provided with part of circuits and various elements which are necessary for operating the first display panel 102 and the second display panel 104 or part of circuits and various elements which are necessary for an electronic device in which the first display panel 102 and the second display panel 104 are incorporated, and another part thereof is mounted on the signal processing circuit board 106 as the IC chip 108.

As described above, one of two display panels provided back to back is provided with circuits and various elements which are necessary for operating the display panels or circuits and various elements which are necessary for an electronic device in which the display panels are incorporated. Thus, electronic components (IC chips) which are mounted can be reduced or eliminated. Since the electronic components are reduced or eliminated, an inexpensive display module can be provided at low cost. In addition, since the electronic components are reduced or eliminated, a display module can be made smaller. Further, since the electronic components are reduced or eliminated, a display module can be made thinner.

Note that although this embodiment mode is described with reference to various drawings, the contents (or may be part of the contents) described in each drawing can be freely applied to, combined with, or replaced with the contents (or may be part of the contents) described in another drawing. Further, even more drawings can be formed by combining each part with another part in the above-described drawings.

Similarly, the contents (or may be part of the contents) described in each drawing of this embodiment mode can be freely applied to, combined with, or replaced with the contents (or may be part of the contents) described in a drawing in another embodiment mode. Further, even more drawings can be formed by combining each part with part of another embodiment mode in the drawings of this embodiment mode.

Note that this embodiment mode shows an example of an embodied case of the contents (or may be part of the contents) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 2

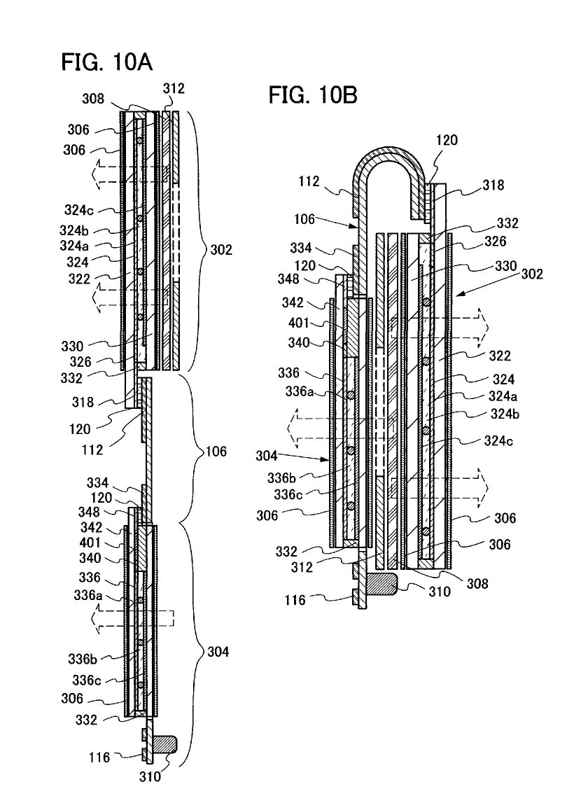

In this embodiment mode, display modules including a plurality of liquid crystal display panels which form a main screen and a sub screen are described with reference to FIGS. 10A and 10B. FIGS. 10A and 10B are cross-sectional views of the display modules; FIG. 10A is a cross-sectional view of display panels which are provided in the same plane; and FIG. 10B is a cross-sectional view of the display panels which are provided back to back. Note that since the display modules shown in FIGS. 10A and 10B are the same except for positions of the display panels, reference numerals are commonly used. Note that structures which are the same as the structures in FIGS. 1A to 9 are denoted by common reference numerals, and description thereof is omitted.

Each of the display modules of this embodiment mode shown in FIGS. 10A and 10B includes a first display panel 302, a second display panel 304, and the signal processing circuit board 106 including a timing controller of both the display panels. The first display panel 302 and the second display panel 304 are provided so that images including characters, diagrams, symbols, and the like are displayed on different sides. Note that the first display panel 302 and the second display panel 304 are different in screen size. One of the first display panel 302 and the second display panel 304 forms a main screen, and the other of the first display panel 302 and the second display panel 304 forms a sub screen.

In FIGS. 10A and 10B, external dimensions of the first display panel 302 and the second display panel 304 are made different from each other, and the external dimension (i.e., panel area) of one of the first display panel 302 and the second display panel 304 is made smaller than that of the other of the first display panel 302 and the second display panel 304. Typically, the second display panel 304 which forms the sub screen is made smaller than the first display panel 302 which forms the main screen. In addition, in order to form a compact display module, the first display panel 302 and the second display panel 304 are provided back to back with a backlight unit 308 interposed therebetween, as shown in FIG. 10B. The backlight unit 308 has a structure in which a light guide plate is combined with a diffusion plate, a lens sheet, and the like to emit light from a light source 310 across surfaces. In this case, each of the first display panel 302 and the second display panel 304 may be provided with the backlight unit 308.

The signal processing circuit board 106 shown in FIGS. 10A and 10B is connected to a terminal 318 of the first display panel 302 through the conductive member 120 by the first terminal 112. When the conductive member 120 is sandwiched between the first terminal 112 and the terminal 318, the conductive member 120 exhibits electrically anisotropic properties in which electric resistance between both the terminals is decreased and adjacent terminals are electrically insulated. Such a conductive member 120 is provided by using, for example, a material in which conductive fine particles (or fine particles having conductive surfaces) are dispersed in a resin medium at a concentration that the conductive fine particles localized so as not to interact with each other. In this case, when an interval between the first terminal 112 and the terminal 318 is approximately the same as the size of the conductive fine particles, both the terminals are conducted. Similarly, the signal processing circuit board 106 is connected to a terminal 348 of the second display panel 304 through the conductive member 120 by using a second terminal 334.

The signal processing circuit board 106 has a surface in which the terminal 318 of the first display panel 302 and the terminal 348 of the second display panel 304 are electrically connected by a wiring extending from these connection portions. In this case, the second terminal 334 which is electrically connected to the terminal 348 of the second display panel 304 is provided over the first display panel 302. When a surface of the first display panel 302, which is opposite to a display surface, is effectively used as shown in FIG. 10B, a compact display module can be formed.

As shown in FIG. 10B, in order to connect the terminal 348 of the second display panel 304 and the first terminal 112 which is electrically connected to the terminal 318 of the first display panel 302, the signal processing circuit board 106 is preferably formed by using the flexible substrate 114 which forms an insulating surface. A polyimide film is typically used as the flexible substrate 114; however, another resin film or fiber-reinforced plastic may be used. The thickness of the flexible substrate 114 may be 30 to 300 μm, typically 80 to 160 μm. When the second display panel 304 which is disposed inside the signal processing circuit board 106 is thicker than the signal processing circuit board 106, the opening portion which is obtained by cutting part of the signal processing circuit board 106 out may be provided so that the second terminal 334 overlaps with the terminal 348 of the second display panel 304.

The second display panel 304 shown in FIGS. 10A and 10B is provided with the circuit unit 401. The circuit unit 401 is electrically connected to the terminal 348 of the second display panel 304. Here, examples of the circuit unit 401 are various circuits such as a driver circuit of a display panel, a timing controller, an audio/image signal processing circuit, a memory, a power supply circuit, a high-frequency circuit, a filter, a security circuit, a central processing unit (CPU), an amplifier circuit, an interface circuit for connecting another external device such as optical communication, LAN, or USB, and a backlight control unit.

In the first display panel 302, a display portion 324 and the terminal 318 are formed over a first substrate 322. Besides, a scan line driver circuit 328 (and a signal line driver circuit 326) may be formed. Needless to say, part of or all these driver circuits may be formed in the second display panel 304 as the circuit unit 401 or part of the circuit unit 401. In the display portion 324, a plurality of pixels are arranged two-dimensionally in an X direction and a Y direction. The display portion 324 includes a driving element array 324a, a display element array 324b, and a color filter array 324c as components.

The driving element array 324a includes a switching element which controls ON/OFF of a signal, and a non-linear element which controls a current flow may be combined when needed. A transistor is often used as a typical switching element. A transistor can have a single-drain structure in which a channel formation region is provided between a pair of a source and a drain, an LDD structure in which a low-concentration drain (LDD) is provided between a channel formation region and a drain, or the like. Alternatively, a transistor may have a multi-gate structure in which a plurality of gate electrodes are interposed (a plurality of channel formation regions are arranged in series) between a pair of a source and a drain. In addition, single-crystal silicon, polycrystalline silicon, or amorphous silicon can be used for a semiconductor layer included in a transistor. As a structure of a transistor, a bottom-gate structure in which a semiconductor layer is formed after forming a gate electrode may be used as well as a top-gate structure in which a gate electrode is formed after forming a semiconductor layer. The bottom-gate structure is particularly preferable in the case of using amorphous silicon.

Note that for the driving element array 324a, an MIM element may be used as well as a transistor. Note that the display portion 324 is a passive matrix type, the driving element array 324a can be omitted.

The display element array 324b is formed by using a liquid crystal element, optical characteristics of which are changed by electric action. A liquid crystal element is formed by a liquid crystal material which is filled between a pair of electrodes. The liquid crystal material is interposed between the first substrate 322 and a second substrate 330 and is sealed with a sealing material 332. The liquid crystal element which is interposed between a counter electrode and a pixel electrode is supplied with voltage which is a potential difference between both the electrodes, and a polarization state of light which is transmitted through a liquid crystal is changed in accordance with the voltage. That is, when light from the backlight unit 308 is transmitted through the liquid crystal and polarizing plates 306, light and dark in accordance with the polarization state of light are displayed. When the color filter array 324c is combined with this, color display can be performed. As the liquid crystal material, a TN liquid crystal is typically used. In this manner, a liquid crystal panel is completed. In this case, when the structure of the pixel electrode is changed, the display element array 324b which is operated in an MVA mode or an IPS mode can be employed.

In the second display panel 304, a display portion 336, the circuit unit 401, and the terminal 348 are formed on a second substrate 142. Besides, a driver circuit 340 may be formed. A driving element array 336a, a display element array 336b, and a color filter array 336c of the display portion 336 and the driver circuit 340 in the second substrate 342 of the second display panel 304 can be formed by using the same components as those in the first display panel 302. In order to reduce the area of the circuit unit 401 formed in the second display panel 304, it is preferable that a circuit be shared between the first display panel 302 and the second display panel 304. In that case, it is preferable to use the same kind of display element arrays as in the case of forming both the display element arrays by using liquid crystal elements.

Here, a single-crystal semiconductor layer (an SOI layer) with uniform crystal orientation, which is bonded over a substrate having an insulating surface or an insulating substrate, is preferably used as a semiconductor layer of a transistor included in the circuit unit 401. Thus, the crystal orientation of the single-crystal semiconductor layer is uniform, so that high-performance field-effect transistors which are uniform can be obtained. That is, variation in values of important transistor characteristics, such as the threshold voltage and mobility can be suppressed, so that high performance such as high mobility can be achieved. When the transistor in which the single-crystal semiconductor layer (the SOI layer) with uniform crystal orientation, which is bonded over the substrate having an insulating surface or the insulating substrate, is used for the circuit unit 401, power consumption of the circuit unit 401 can be reduced and processing speed of the circuit unit 401 can be increased. Note that the present invention is not limited to this, and a variety of silicon such as single-crystal silicon, polycrystalline silicon, microcrystalline silicon, and non-crystal silicon can be used as the semiconductor layer of the transistor included in the circuit unit 401.

Note that a transistor in which a single-crystal semiconductor layer (an SOI layer) with uniform crystal orientation, which is bonded over a substrate having an insulating surface or an insulating substrate, can be used as elements included in the driving element array 336a and the driver circuit 340 formed on the second display panel 304. Similarly, a transistor in which a single-crystal semiconductor layer (an SOI layer) with uniform crystal orientation, which is bonded over a substrate having an insulating surface or an insulating substrate, can be used as elements included in the driving element array 3224a and the scan line driver circuit 328 (and the signal line driver circuit 326) formed in the first display panel 302.

The first display panel 302 and the second display panel 304 can be made different in screen size and number of pixels. For example, in a usage as a mobile phone, the first display panel 302 can be a 2.1-inch type having the number of pixels of 320×240 as a QVGA (the number of pixels of 320×240×3 (RGB)), and the second display panel 304 can be a 0.9-inch type having the number of pixels of 88×64. In addition, in a usage as a computer provided with an opening and closing display screen, such as a notebook computer, the first display panel 302 can be a 15-inch type having the number of pixels of 1024×768 as an XGA (the number of pixels of 1024×768×3 (RGB)), and the second display panel 304 can be a 3-inch type having the number of pixels of 320×240 as a QVGA. Besides, the screen sizes and the number of pixels of the first display panel 302 and the second display panel 304 can be combined as appropriate to be applied to various electronic devices.

The light source 310 of the backlight unit 308 can also be incorporated in the circuit unit 401 formed in the second display panel 304. As the light source 310, a cold cathode fluorescent lamp or an electroluminescence (EL) light source can be used as well as a light-emitting diode (LED). In addition, a light-shielding plate 312 is provided between the backlight unit 308, and the second display panel 304 and the signal processing circuit substrate 106. In this structure, light of the backlight unit 308 is prevented from leaking to the second display panel 304 side having a smaller area than the first display panel 302. An opening portion is formed in the light-shielding plate 312 so that light from the backlight unit 308 reaches a display screen of the second display panel 304.

Note that similarly to Embodiment Mode 1, part of the circuit unit 401 may be mounted on the display module as an IC chip. A sensor chip may be mounted on the display module. Part of the circuit unit 401 may be mounted on the display module as an IC chip and the sensor chip may also be mounted on the display module. Note that as an IC chip, there are a driver circuit of a display panel, a timing controller, an audio/image signal processing circuit, a memory, a power supply circuit, a high-frequency circuit, a filter, a security circuit, a central processing unit (CPU), an amplifier circuit, and an interface circuit for connecting another external device such as optical communication, LAN, or USB, for example. Note that there are various kinds of sensor chips such as an optical sensor, a CCD module (camera), a temperature sensor, a humidity sensor, an acceleration sensor, a vibration sensor, a direction sensor, a gas sensor, and a particulate sensor (e.g., a smoke sensor or a pollen sensor), for example.

As described above, one of two display panels provided back to back is provided with circuits and various elements which are necessary for operating the display panel or circuits and various elements which are necessary for an electronic device in which the display panel is incorporated. Thus, electronic components (IC chips) which are mounted can be reduced or eliminated. Since the electronic components are reduced or eliminated, an inexpensive display module can be provided at low cost. In addition, since the electronic components are reduced or eliminated, a display module can be made smaller. Further, since the electronic components are reduced or eliminated, a display module can be made thinner.

Although the case in which a liquid crystal display panel is used is described in this embodiment mode, a field emission display (FED) using an electron emitter, an SED-type flat panel display (SED: surface-conduction electron-emitter display), or a display using a contrast medium (e.g., electronic ink) can be used.

Note that although this embodiment mode is described with reference to various drawings, the contents (or may be part of the contents) described in each drawing can be freely applied to, combined with, or replaced with the contents (or may be part of the contents) described in another drawing. Further, even more drawings can be formed by combining each part with another part in the above-described drawings.

Similarly, the contents (or may be part of the contents) described in each drawing of this embodiment mode can be freely applied to, combined with, or replaced with the contents (or may be part of the contents) described in a drawing in another embodiment mode. Further, even more drawings can be formed by combining each part with part of another embodiment mode in the drawings of this embodiment mode.

Note that this embodiment mode shows an example of an embodied case of the contents (or may be part of the contents) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 3

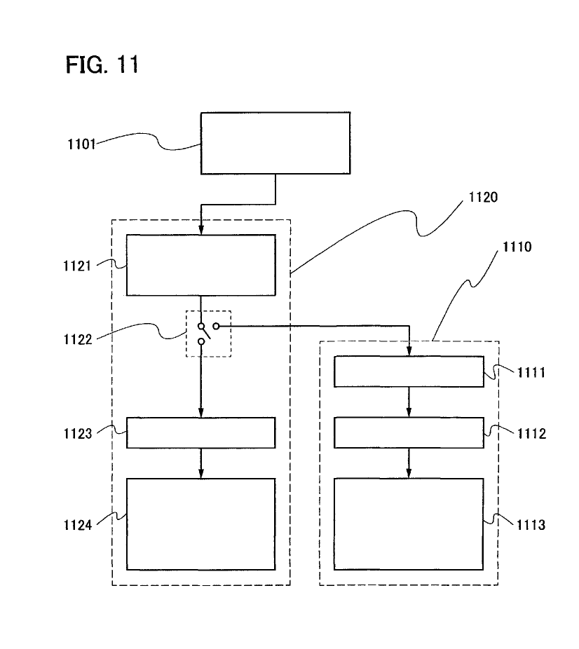

In this embodiment mode, operations of each of the display modules described in Embodiment Modes 1 and 2 are described with reference to FIG. 11.

The display module includes a first display panel 1110 which forms a main screen and a second display panel 1120 which forms a sub screen. In addition, the first display panel 1110 includes a level shifter 1111, a driving portion 1112, and a display portion 1113. The second display panel 1120 includes a circuit unit 1121, a switching switch 1122, a driving portion 1123, and a display portion 1124. Note that an IC chip is mounted on the display module. Alternatively, an IC chip is provided outside the display module. In this embodiment mode, an IC chip mounted on the display module and an IC chip provided outside the display module is collectively referred to as an external IC 1101.

Note that the case is described in which polycrystalline silicon, microcrystalline silicon, or non-crystal silicon is used as a semiconductor layer of a transistor included in the first display panel 1110, and a single-crystal semiconductor layer (an SOI layer) with uniform crystal orientation, which is bonded over a substrate having an insulating surface or an insulating substrate, is used as a semiconductor layer of a transistor included in the second display panel 1120.

Operations of the display module are briefly described. A signal is input from the external IC 1101 to the circuit unit 1121 of the second display panel 1120. A video signal, a clock signal, a start signal, or the like is included in this signal. The circuit unit 1121 outputs a signal for driving the first display panel 1110 or the second display panel 1120. Then, the switching switch 1122 selects whether this signal is input to the driving portion 1112 of the first display panel 1110 through the level shifter 1111 or this signal is input to the driving portion 1123 of the second display panel 1120. Then, when the signal is input to the driving portion 1112, the driving portion 1112 drives the display portion 1113. On the other hand, when the signal is input to the driving portion 1123, the driving portion 1123 drives the display portion 1124.

Operating voltage of the display module is described. The external IC 1101 is operated at low voltage (e.g., 0/3.3 V). This is because a single-crystal silicon is often used as semiconductor layers of transistors included in the external IC 1101, so that the threshold voltage is low, mobility is high, and variation is small.

Here, a single-crystal semiconductor is used as the semiconductor layer of the transistor included in the second display panel 1120. Therefore, the circuit unit 1121 can be operated at almost the same operating voltage as the external IC 1101. Thus, power supply voltage, a clock signal, or the like can be shared between the circuit unit 1121 and the external IC 1101. On the other hand, polycrystalline silicon, microcrystalline silicon, or non-crystal silicon is used as the semiconductor layer of the transistor included in the first display panel 1110. Therefore, the driving portion 1112 needs operating voltage which is higher than the operating voltage of the circuit unit 1121 or the operating voltage of the external IC 1101. Thus, the amplitude of the signal which is input from the circuit unit is increased by the level shifter 1111. Then, the signal, the amplitude of which is increased, is input to the driving portion 1112.

As described above, the first display panel 1110 includes the level shifter 1111 because high operating voltage is necessary. In addition, a polycrystalline semiconductor, a microcrystalline semiconductor, or a non-crystal semiconductor is used as the semiconductor layer of the transistor included in the first display panel 1110. Therefore, the display module can be inexpensively manufactured at low cost.

Here, a semiconductor layer of a transistor included in the circuit unit 1121, a semiconductor layer of a transistor included in the driving portion 1123, and a semiconductor layer of a transistor included in the display portion 1124 are not necessarily the same. For example, the semiconductor layer of the transistor included in the circuit unit 1121 may be a single-crystal semiconductor, and each of the semiconductor layer of the transistor included in the driving portion 1123 and the semiconductor layer of the transistor included in the display portion 1124 may be a polycrystalline semiconductor, a microcrystalline semiconductor, or a non-crystal semiconductor. As another example, each of the semiconductor layer of the transistor included in the circuit unit 1121 and the semiconductor layer of the transistor included in the driving portion 1123 may be a single-crystal semiconductor, and the semiconductor layer of the transistor included in the display portion 1124 may be a polycrystalline semiconductor, a microcrystalline semiconductor, or a non-crystal semiconductor. Note that the present invention is not limited to this, and various structures can be used.

Note that it is preferable that crystallinity of the semiconductor layer of the transistor included in the circuit unit 1121 be higher than crystallinity of the semiconductor layer of the transistor included in the first display panel 1110. This is because it is necessary that the second display panel 1120 be operated at higher speed than the first display panel 1110. For example, the semiconductor layer of the transistor included in the second display panel 1120 can be a polycrystalline semiconductor and the semiconductor layer of the transistor included in the first display panel 1110 can be a microcrystalline semiconductor or a non-crystal semiconductor. Note that the present invention is not limited to this, and the same kind of semiconductor layers may be used as the semiconductor layer of the transistor included in the circuit unit 1121 and the semiconductor layer of the transistor included in the first display panel 1110.

Note that although this embodiment mode is described with reference to various drawings, the contents (or may be part of the contents) described in each drawing can be freely applied to, combined with, or replaced with the contents (or may be part of the contents) described in another drawing. Further, even more drawings can be formed by combining each part with another part in the above-described drawings.

Similarly, the contents (or may be part of the contents) described in each drawing of this embodiment mode can be freely applied to, combined with, or replaced with the contents (or may be part of the contents) described in a drawing in another embodiment mode. Further, even more drawings can be formed by combining each part with part of another embodiment mode in the drawings of this embodiment mode.

Note that this embodiment mode shows an example of an embodied case of the contents (or may be part of the contents) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 4

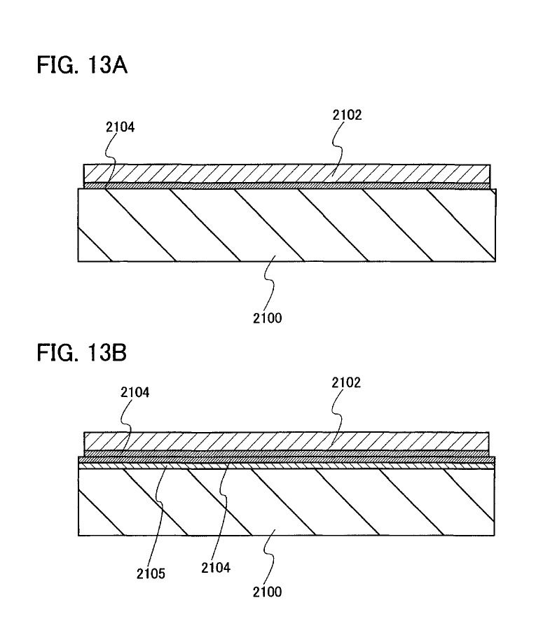

FIGS. 13A and 13B each show an SOI substrate. In FIG. 13A, a base substrate 2100 is a substrate having an insulating surface or an insulating substrate, and any of various glass substrates which are used in the electronics industry, such as aluminosilicate glass substrates, aluminoborosilicate glass substrates, and barium borosilicate glass substrates can be used. Alternatively, a quartz glass substrate or a semiconductor substrate such as a silicon wafer can be used. An SOI layer 2102 is a single-crystal semiconductor, and single-crystal silicon is typically used. Alternatively, a single-crystal semiconductor layer formed of silicon, germanium, or a compound semiconductor such as gallium arsenide or indium phosphide which can be separated from a single-crystal semiconductor substrate by a separation method of hydrogen ion introduction can be used.

Between the base substrate 2100 and the SOI layer 2102 described above, a bonding layer 2104 which has a smooth surface and forms a hydrophilic surface is provided. A silicon oxide film is suitable as the bonding layer 2104. In particular, a silicon oxide film formed by a chemical vapor deposition method using an organic silane gas is preferable. As an organic silane gas, a silicon-containing compound such as tetraethoxysilane (TEOS) (chemical formula: Si(OC₂H₅)₄), tetramethylsilane (TMS) (chemical formula: Si(CH₃)₄), tetramethylcyclotetrasiloxane (TMCTS), octamethylcyclotetrasiloxane (OMCTS), hexamethyldisilazane (HMDS), triethoxysilane (chemical formula: SiH(OC₂H₅)₃), or trisdimethylaminosilane (chemical formula: SiH(N(CH₃)₂)₃) can be used.

The bonding layer 2104 which has a smooth surface and forms a hydrophilic surface is provided with a thickness of 5 to 500 nm. With such a thickness, roughness of a surface on which the bonding layer 2104 is formed can be smoothed and smoothness of a growth surface of the film can be ensured. In addition, distortion between a substrate and the SOI layer which are bonded to each other can be reduced. The base substrate 2100 may be provided with a similar silicon oxide film. That is, when the SOI layer 2102 is bonded to the base substrate 2100 which is a substrate having an insulating surface or an insulating substrate, the base substrate 2100 and the SOI layer 2102 can be firmly bonded to each other when the bonding layer 2104 formed of a silicon oxide film which is preferably formed using organic silane as a material is provided on either one or both surfaces of the base substrate 2100 and the SOI layer 2102 which are to be bonded.

FIG. 13B shows a structure in which the base substrate 2100 is provided with a silicon nitride layer 2105 and the bonding layers 2104. In the case of bonding the SOI layer 2102 to the base substrate 2100, the SOI layer 2102 can be prevented from being contaminated by diffusion of impurities such as mobile ions like alkali metal or alkaline earth metal from a glass substrate which is used as the base substrate 2100. A bonding layer 2104 on the base substrate 2100 side may be provided as appropriate.

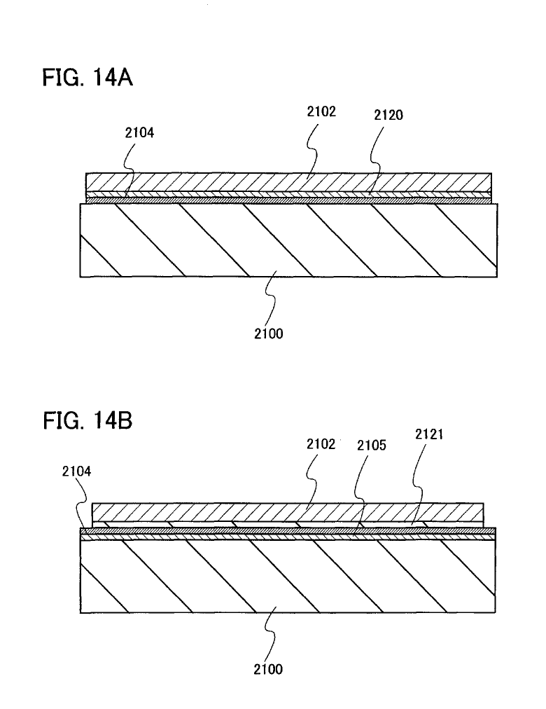

FIG. 14A shows a structure in which a nitrogen-containing insulating layer 2120 is provided between the SOI layer 2102 and the bonding layer 2104. The nitrogen-containing insulating layer 2120 is formed by stacking one or a plurality of films selected from a silicon nitride film, a silicon nitride oxide film, and a silicon oxynitride film. For example, the nitrogen-containing insulating layer 2120 can be formed by stacking a silicon oxynitride film and a silicon nitride oxide film from the SOI layer 2102 side. The bonding layer 2104 is provided in order to form a bond with the base substrate 2100, whereas the nitrogen-containing insulating layer 2120 is preferably provided in order to prevent the SOI layer 2102 from being contaminated by diffusion of impurities such as mobile ions or moisture.

Note that here, a silicon oxynitride film corresponds to a film which contains much oxygen than nitrogen, and in the case where measurement is performed using Rutherford backscattering spectrometry (RBS) and hydrogen forward scattering (HFS), includes oxygen, nitrogen, silicon, and hydrogen at concentrations ranging from 50 to 70 at. %, 0.5 to 15 at. %, 25 to 35 at. %, and 0.1 to 10 at. %, respectively. Further, a silicon nitride oxide film corresponds to a film which contains much nitrogen than oxygen and includes oxygen, nitrogen, silicon, and hydrogen at concentrations ranging from 5 to 30 at. %, 20 to 55 at. %, 25 to 35 at. %, and 10 to 30 at. %, respectively, in the case where measurement is performed using RBS and HFS. Note that percentages of nitrogen, oxygen, silicon, and hydrogen fall within the ranges given above if the total number of atoms contained in the silicon oxynitride film or the silicon nitride oxide film is defined as 100 at. %.

FIG. 14B shows a structure in which the base substrate 2100 is provided with the bonding layer 2104. Between the base substrate 2100 and the bonding layer 2104, the barrier layer 2105 is preferably provided. The silicon nitride layer 2105 is provided in order to prevent the SOI layer 2102 from being contaminated by diffusion of impurities such as mobile ions like alkali metal or alkaline earth metal from a glass substrate which is used as the base substrate 2100. In addition, the SOI layer 2102 is provided with a silicon oxide film 2121. This silicon oxide film 2121 forms a bond with the bonding layer 2104 to fix the SOI layer 2102 over the base substrate 2100. The silicon oxide film 2121 is preferably formed by thermal oxidation. Alternatively, similarly to the bonding layer 2104, the silicon oxide film 2121 may be formed by a chemical vapor deposition method using TEOS. Further alternatively, as the silicon oxide film 2121, chemical oxide can be used. Chemical oxide can be formed by, for example, performing treatment on a surface of a semiconductor substrate by using ozone-containing water. Chemical oxide is preferable because it reflects flatness of the surface of the semiconductor substrate.

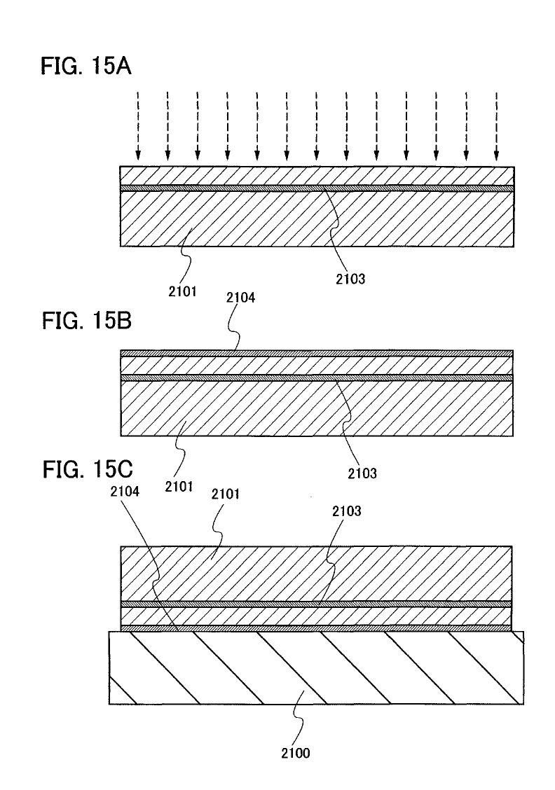

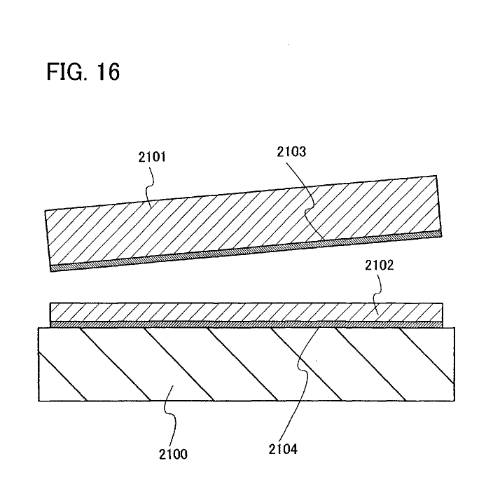

A method for manufacturing such an SOI substrate is described with reference to FIGS. 15A to 15C and FIG. 16.

A semiconductor substrate 2101 shown in FIG. 15A is cleaned, and ions which are accelerated by an electric field are introduced into reach a predetermined depth from the surface of the semiconductor substrate 2101 to form a ion-doping layer 2103. Ions are introduced in consideration of the thickness of an SOI layer which is to be transferred to a base substrate. The thickness of the SOI layer is 5 to 500 nm, preferably 10 to 200 nm. Accelerating voltage for introducing ions into the semiconductor substrate 2101 is set in consideration of such a thickness. The ion-doping layer 2103 is formed by introducing ions of hydrogen, helium, or halogen typified by fluorine. In this case, it is preferable to introduce one kind of ions or plural kinds of ions of different mass numbers consisting of a single kind of atoms. In the case of introducing hydrogen ions, the hydrogen ions preferably include H⁺, H₂⁺, and H₃⁺ ions with a high proportion of H₃⁺ ions. With a high proportion of H₃⁺ ions, introducing efficiency can be increased and introducing time can be shortened. With such a structure, separation can be easily performed.

Since it is necessary to introduce ions at a high dose, the surface of the semiconductor substrate 2101 is roughened in some cases. Therefore, a protective film against introducing of ions may be provided on a surface to which ions are introduced by using a silicon nitride film, a silicon nitride oxide film, or the like with a thickness of 50 to 200 nm.

Next, as shown in FIG. 15B, a silicon oxide film is formed over a surface to which the base substrate is bonded as a bonding layer 2104. As the silicon oxide film, a silicon oxide film formed by a chemical vapor deposition method using an organic silane gas as described above is preferably used. Alternatively, a silicon oxide film formed by a chemical vapor deposition method using a silane gas can be used. In film formation by a chemical vapor deposition method, film formation temperature at, for example, 350° C. or lower, at which degassing of the ion-doping layer 2103 formed in a single-crystal semiconductor substrate does not occur, is used. Heat treatment for separating an SOI layer from a single-crystal or polycrystalline semiconductor substrate is performed at a higher temperature than the film formation temperature.

FIG. 15C shows a mode in which a surface of the base substrate 2100 and a surface of the semiconductor substrate 2101, on which the bonding layer 2104 is formed are disposed in contact to be bonded to each other. The surfaces which are to be bonded are cleaned sufficiently. Then, when the base substrate 2100 and the bonding layer 2104 are disposed in contact, a bond is formed. This bond is formed by Van der Waals forces. When the base substrate 2100 and the semiconductor substrate 2101 are pressed against each other, a stronger bond can be formed by hydrogen bonding.

In order to form a favorable bond, the surfaces which are to form a bond may be activated. For example, the surfaces which are to form a bond are irradiated with an atomic beam or an ion beam. When an atomic beam or an ion beam is used, an inert gas neutral atom beam or inert gas ion beam of argon or the like can be used. Alternatively, plasma irradiation or radical treatment is performed. With such a surface treatment, a bond between different kinds of materials can be easily formed even at a temperature of 200 to 400° C.

After the base substrate 2100 and the semiconductor substrate 2101 are bonded to each other with the bonding layer 2104 interposed therebetween, heat treatment or pressure treatment is preferably performed. When heat treatment or pressure treatment is performed, bonding strength can be increased. Temperature of heat treatment is preferably lower than or equal to the upper temperature limit of the base substrate 2100 and temperature at which the elements included in the ion-doping layer 2103 by the above-described ion irradiation are removed. Pressure treatment is performed so that pressure is applied in a perpendicular direction to the bonded surface, in consideration of pressure resistance of the base substrate 2100 and the semiconductor substrate 2101.

In FIG. 16, after the base substrate 2100 and the semiconductor substrate 2101 are bonded to each other, heat treatment is performed to separate the semiconductor substrate 2101 from the base substrate 2100 with the ion-doping layer 2103 used as a cleavage plane. The heat treatment is preferably performed at a temperature ranging from the film formation temperature of the bonding layer 2104 to the upper temperature limit of the base substrate 2100. When the heat treatment is performed at, for example, 400 to 600° C., the volume of fine voids formed in the ion-doping layer 2103 is changed, so that cleavage can be performed along the ion-doping layer 2103. Since the bonding layer 2104 is bonded to the base substrate 2100, the SOI layer 2102 having the same crystallinity as the semiconductor substrate 2101 remains over the base substrate 2100.

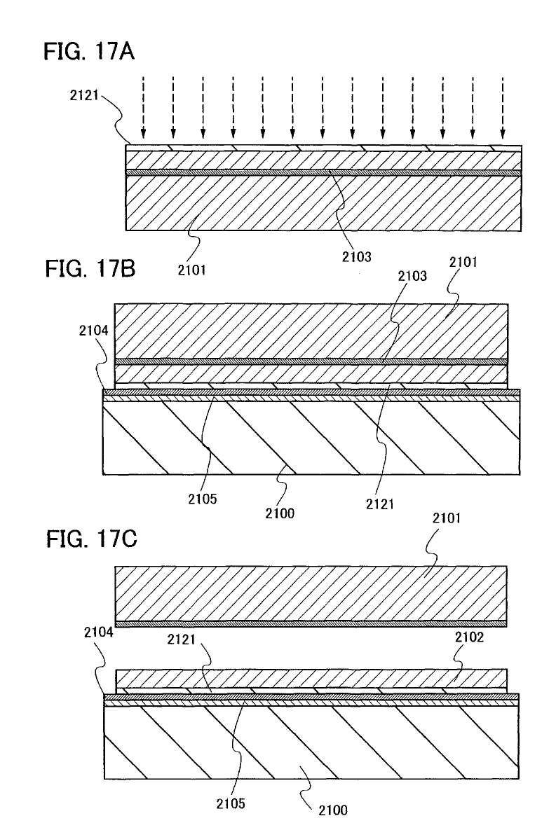

FIGS. 17A to 17C show steps of forming an SOI layer with a bonding layer provided on the base substrate 2100 side. FIG. 17A shows a step in which ions which are accelerated by an electric field are introduced into the semiconductor substrate 2101 which is provided with the silicon oxide film 2121 at a predetermined depth to form the ion-doping layer 2103. Introducing of ions of hydrogen, helium, or a halogen typified by fluorine is performed similarly to the case shown in FIG. 15A. When the silicon oxide film 2121 is formed on the surface of the semiconductor substrate 2101, the surface of the semiconductor substrate 2101 can be prevented from being damaged by ion doping and from losing its flatness.

FIG. 17B shows a step in which a surface of the base substrate 2100 provided with the silicon nitride layer 2105 and the bonding layer 2104 and the surface of the semiconductor substrate 2101, on which the silicon oxide film 2121 is formed are disposed in contact to be bonded. A bond is formed when the bonding layer 2104 over the base substrate 2100 is disposed in contact with the silicon oxide film 2121 formed on the semiconductor substrate 2101.

After that, as shown in FIG. 17C, the semiconductor substrate 2101 is separated. Heat treatment for separating the semiconductor substrate 2101 is performed similarly to the case shown in FIG. 16. In this manner, the SOI substrate shown in FIG. 14B can be obtained.

In this manner, in accordance with this mode, even if a substrate with an upper temperature limit of 700° C. or lower, such as a glass substrate, is used as the base substrate 2100, the SOI layer 2102 having strong adhesiveness of a bonded portion can be obtained. As the base substrate 2100, any of various glass substrates which are used in the electronics industry and are referred to as non-alkali glass substrates, such as aluminosilicate glass substrates, aluminoborosilicate glass substrates, and barium borosilicate glass substrates can be used. That is, a single-crystal semiconductor layer can be formed over a substrate which is longer than one meter on a side. When such a large-area substrate is used, not only a display device such as a liquid crystal display but also a semiconductor integrated circuit can be manufactured.

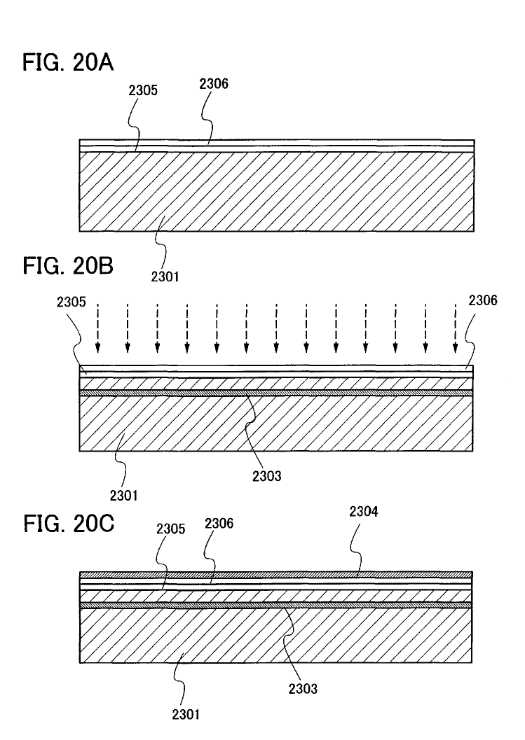

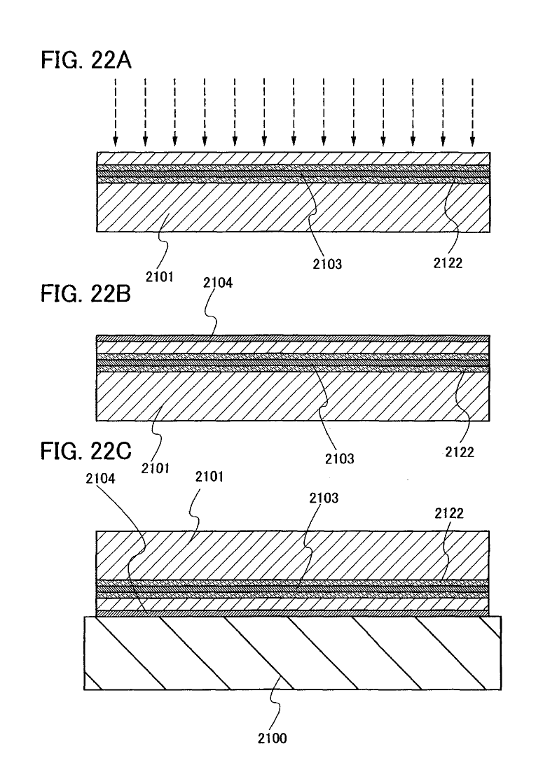

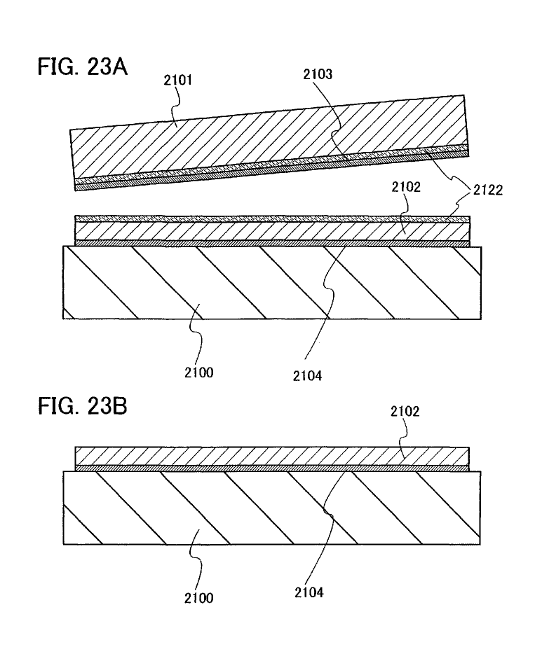

FIGS. 22A to 23B show steps of forming an SOI layer with a BOX layer 2122 provided on the semiconductor substrate 2101. FIG. 22A shows a step in which ions which are accelerated by an electric field are introduced into the semiconductor substrate 2101 which is provided with the BOX layer 2122 to reach a predetermined depth to form the ion-doping layer 2103. Introducing of ions of hydrogen, helium, or a halogen typified by fluorine is performed similarly to the case shown in FIG. 20A. Here, a peak position in ion distribution is set to be in the BOX layer 2122. That is, the ion-doping layer 2103 is provided in the BOX layer 2122.

FIG. 22B shows a step of forming a silicon oxide film over a surface to which the base substrate is bonded as a bonding layer 2104. As the silicon oxide film, a silicon oxide film formed by a chemical vapor deposition method using an organic silane gas as described above is preferably used. Alternatively, a silicon oxide film formed by a chemical vapor deposition method using a silane gas can be used. In film formation by a chemical vapor deposition method, film formation temperature at, for example, 350° C. or lower, at which degassing of the ion-doping layer 2103 formed in a single-crystal semiconductor substrate does not occur, is used. Heat treatment for separating an SOI layer from a single-crystal or polycrystalline semiconductor substrate is performed at a higher temperature than the film formation temperature.

FIG. 22C shows a step in which a surface of the base substrate 2100 and a surface of the semiconductor substrate 2101, on which the bonding layer 2104 is formed are disposed in contact to be bonded to each other. The surfaces which are to be bonded are cleaned sufficiently. Then, when the base substrate 2100 and the bonding layer 2104 are disposed in contact, a bond is formed. This bond is formed by Van der Waals forces. When the base substrate 2100 and the semiconductor substrate 2101 are pressed against each other, a stronger bond can be formed by hydrogen bonding.

In order to form a favorable bond, the surfaces which are to form a bond may be activated. For example, the surfaces which are to form a bond are irradiated with an atomic beam or an ion beam. When an atomic beam or an ion beam is used, an inert gas neutral atom beam or inert gas ion beam of argon or the like can be used. Alternatively, plasma irradiation or radical treatment is performed. With such a surface treatment, a bond between different kinds of materials can be easily formed even at a temperature of 200 to 400° C.

After the base substrate 2100 and the semiconductor substrate 2101 are bonded to each other with the bonding layer 2104 interposed therebetween, heat treatment or pressure treatment is preferably performed. When heat treatment or pressure treatment is performed, bonding strength can be increased. Temperature of heat treatment is preferably lower than or equal to the upper temperature limit of the base substrate 2100. Pressure treatment is performed so that pressure is applied in a perpendicular direction to the bonded surface, in consideration of pressure resistance of the base substrate 2100 and the semiconductor substrate 2101.

In FIG. 23A, after the base substrate 2100 and the semiconductor substrate 2101 are bonded to each other, heat treatment is performed to separate the semiconductor substrate 2101 from the base substrate 2100 with the ion-doping layer 2103 used as a cleavage plane. The heat treatment is preferably performed at a temperature ranging from the film formation temperature of the bonding layer 2104 to the upper temperature limit of the base substrate 2100. When the heat treatment is performed at, for example, 400 to 600° C., the volume of fine voids formed in the ion-doping layer 2103 is changed, so that cleavage can be performed along the ion-doping layer 2103. Since the bonding layer 2104 is bonded to the base substrate 2100, the SOI layer 2102 having the same crystallinity as the semiconductor substrate 2101 remains over the base substrate 2100.

FIG. 23B shows a step of removing the BOX layer 2122 which remains over the semiconductor substrate 2101 by wet etching using dilute hydrofluoric acid.

In the steps shown in FIGS. 22A to 23B, a dangling bond, a crystal defect, or the like of a separated surface are generated in the BOX layer 2122. That is, a dangling bond, a crystal defect, or the like are not generated in a semiconductor layer included in the semiconductor substrate 2101. In addition, when the BOX layer 2122 is removed, the semiconductor layer can be prevented from losing uniformity of the film thickness.

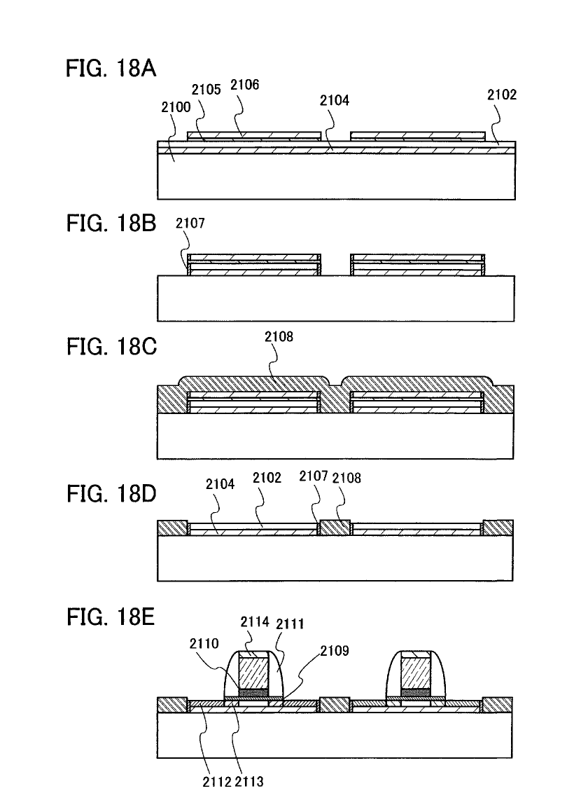

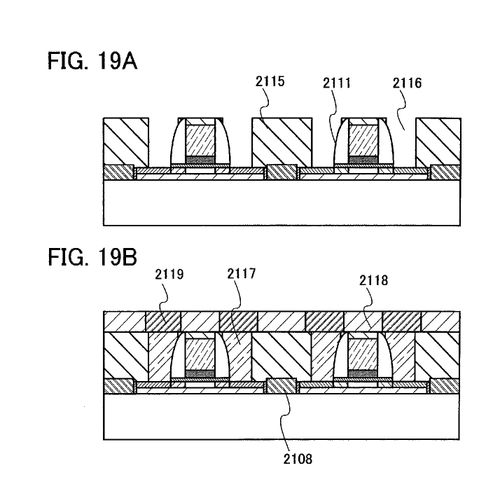

Subsequently, a semiconductor device using an SOI substrate is described with reference to FIGS. 18A to 18E and FIGS. 19A and 19B. In FIG. 18A, the SOI layer is provided over the base substrate 2100 with the bonding layer 2104 interposed therebetween. Over the SOI layer 2102, the silicon nitride layer 2105 and a silicon oxide layer 2106 are formed in accordance with an element formation region. The silicon oxide layer 2106 is used as a hard mask when the SOI layer 2102 is etched for element isolation. The silicon nitride layer 2105 functions as an etching stopper.

The thickness of the SOI layer 2102 is 5 to 500 nm, preferably 10 to 200 nm. The thickness of the SOI layer 2102 can be set as appropriate by controlling the depth of the weakened layer 2103 shown in FIGS. 15A to 15C. In order to control the threshold voltage, a p-type impurity such as boron, aluminum, or gallium is added to the SOI layer 2102. For example, boron may be added as a p-type impurity at a concentration of 5×10¹⁶ to 1×10¹⁸ cm⁻³.

FIG. 18B shows a step of etching the SOI layer 2102 and the bonding layer 2104 by using the silicon oxide layer 2106 as a mask. Exposed end surfaces of the SOI layer 2102 and the bonding layer 2104 are nitrided by plasma treatment. By this nitridation treatment, a silicon nitride layer 2107 is formed at least at a peripheral end portion of the SOI layer 2102. The silicon nitride layer 2107 has insulating properties and has an effect of preventing leakage current from flowing through an end surface of the SOI layer 2102. In addition, since the silicon nitride layer 2107 has resistance to oxidation, it can prevent an oxide film from growing from the end surface into a bird's beak between the SOI layer 2102 and the bonding layer 2104.

FIG. 18C shows a step of depositing an element isolation insulating layer 2108. As the element isolation insulating layer 2108, a silicon oxide film is deposited by a chemical vapor deposition method by using TEOS. The element isolation insulating layer 2108 is deposited thickly so that the SOT layer 2102 is buried.

FIG. 18D shows a step of removing the element isolation insulating layer 2108 to expose the silicon nitride layer 2105. This removing step can be performed by dry etching, or may be performed by chemical mechanical polishing. The silicon nitride layer 2105 functions as an etching stopper. The element isolation insulating layer 2108 remains so as to be embedded between the SOI layers 2102. After that, the silicon nitride layer 2105 is removed.

In FIG. 18E, after the SOI layer 2102 is exposed, a gate insulating layer 2109, a gate electrode 2110, and a sidewall insulating layer 2111 are formed, and a first impurity region 2112 and a second impurity region 2113 are formed. An insulating layer 2114 is formed using silicon nitride and is used as a hard mask when the gate electrode 2110 is etched.

In FIG. 19A, an interlayer insulating layer 2115 is formed. As the interlayer insulating layer 2115, a borophosphosilicate glass (BPSG) film is formed and then planarized by reflow. Alternatively, a silicon oxide film may be formed using TEOS and then planarized by chemical mechanical polishing. In planarization treatment, the insulating layer 2114 over the gate electrode 2110 functions as an etching stopper. A contact hole 2116 is formed in the interlayer insulating layer 2115. The contact hole 2116 is formed in a self-aligned manner by utilizing the sidewall insulating layer 2111.

After that, as shown in FIG. 19B, a contact plug 2117 is formed by CVD by using tungsten hexafluoride. Further, an insulating layer 2118 is formed; an opening is formed in accordance with the contact plug 2117; and a wiring 2119 is provided. The wiring 2119 is formed using aluminum or an aluminum alloy and is provided with upper and lower metal films of molybdenum, chromium, titanium, or the like as barrier metal films.

In this manner, a field effect transistor can be manufactured using the SOI layer 2102 which is bonded to the base substrate 2100. Since the SOI layer 2102 in accordance with this mode is a single-crystal semiconductor with uniform crystal orientation, high-performance field-effect transistors which are uniform can be obtained. That is, variation in values of important transistor characteristics, such as the threshold voltage and mobility can be suppressed, so that high performance such as high mobility can be achieved.

Note that although this embodiment mode is described with reference to various drawings, the contents (or may be part of the contents) described in each drawing can be freely applied to, combined with, or replaced with the contents (or may be part of the contents) described in another drawing. Further, even more drawings can be formed by combining each part with another part in the above-described drawings.

Similarly, the contents (or may be part of the contents) described in each drawing of this embodiment mode can be freely applied to, combined with, or replaced with the contents (or may be part of the contents) described in a drawing in another embodiment mode. Further, even more drawings can be formed by combining each part with part of another embodiment mode in the drawings of this embodiment mode.

Note that this embodiment mode shows an example of an embodied case of the contents (or may be part of the contents) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 5

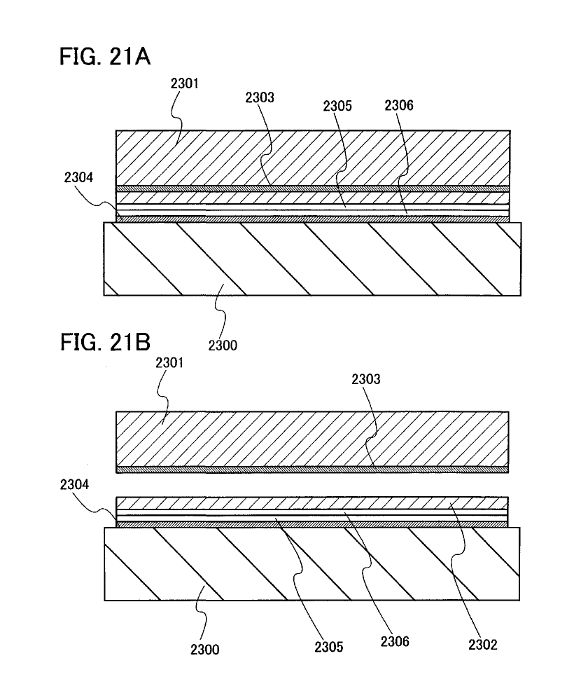

A method for manufacturing an SOI substrate, which is different from that of Embodiment Mode 4, is described with reference to FIGS. 20A to 20C and FIGS. 21A and 21B. In FIG. 20A, a silicon oxynitride film 2305 is formed over a single-crystal silicon substrate 2301 from which a natural oxide film has been removed with a thickness of 100 nm by plasma CVD by using an SiH₄ gas and an N₂O gas. In addition, a silicon nitride oxide film 2306 is formed with a thickness of 50 nm by using an SiH₄ gas and an N₂O gas.

Then, as shown in FIG. 20B, hydrogen ions are introduced from the surface of the silicon nitride oxide film 2306 by using an ion doping apparatus. The ion doping apparatus is an apparatus used to introduce an ionized gas which is accelerated by an electric field into a substrate without mass separation. When this apparatus is used, ion doping can be performed with high efficiency and at high dose even in the case of a large-area substrate. In this example, hydrogen is ionized to form a ion-doping layer 2303 in the single-crystal silicon substrate 2301. Ion doping is performed with accelerated voltage of 80 kV and dose of 2×10¹⁶/cm².

In this case, it is preferable to introduce one kind of ions or plural kinds of ions of different mass numbers consisting of a single kind of atoms. In the case of introducing hydrogen ions, the hydrogen ions preferably include H⁺, H₂⁺, and H₃⁺ ions with a high proportion of H₃⁺ ions of about 80%. When a large number of higher-order ions with small mass numbers as described above are contained in the single-crystal silicon substrate 2301, cleavage of the ion-doping layer 2303 can be easily performed in a heat treatment step. In this case, when the silicon nitride oxide film 2306 and the silicon oxynitride film 2305 are provided on the ion-doping surface of the single-crystal silicon substrate 2301, the surface of the single-crystal silicon substrate 2301 can be prevented from being roughened by ion doping.

Next, as shown in FIG. 20C, a silicon oxide film 2304 is formed over the silicon nitride oxide film 2306. The silicon oxide film 2304 is formed with a thickness of 50 nm by plasma CVD by using tetraethoxysilane (TEOS) (chemical formula: Si(OC₂H₅)₄) and an oxygen gas. The film formation temperature is set to be 350° C. or lower so that hydrogen is not removed from the ion-doping layer 2303.

FIG. 20A shows a step of superposing a glass substrate 2300 which is subjected to ultrasonic cleaning by using ozone-containing water and the single-crystal silicon substrate 2301 on each other with the silicon oxide film 2304 interposed therebetween, and pressing the substrates against each other to bond the substrates. After that, heat treatment is performed at 400° C. for 10 minutes in a nitrogen atmosphere and then at 500° C. for two hours, and the temperature is held constant at 400° C. for several hours and then gradually lowered to room temperature. Accordingly, a crack can be formed in the ion-doping layer 2303 to separate the single-crystal silicon substrate 2301, and the silicon oxide film 2304 and the glass substrate 2300 can be bonded firmly.

In this manner, a single-crystal silicon layer 2302 can be formed over the glass substrate 2300 at a temperature at which the glass substrate 2300 is not distorted. The single-crystal silicon layer 2302 manufactured in this example is firmly bonded to the glass substrate 2300, so that there is no separation of the silicon layer even when a tape peel test is performed. That is, a single-crystal silicon layer can be provided over any of various glass substrates which are used in the electronics industry and are referred to as non-alkali glass substrates, such as aluminosilicate glass substrates, aluminoborosilicate glass substrates, and barium borosilicate glass substrates can be used, and various integrated circuits and display devices can be manufactured by using a substrate which is longer than one meter on a side.

Note that although this embodiment mode is described with reference to various drawings, the contents (or may be part of the contents) described in each drawing can be freely applied to, combined with, or replaced with the contents (or may be part of the contents) described in another drawing. Further, even more drawings can be formed by combining each part with another part in the above-described drawings.

Similarly, the contents (or may be part of the contents) described in each drawing of this embodiment mode can be freely applied to, combined with, or replaced with the contents (or may be part of the contents) described in a drawing in another embodiment mode. Further, even more drawings can be formed by combining each part with part of another embodiment mode in the drawings of this embodiment mode.

Note that this embodiment mode shows an example of an embodied case of the contents (or may be part of the contents) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 6

In this embodiment mode, a pixel structure of a display device is described. In particular, a pixel structure of a display device using an organic EL element is described.

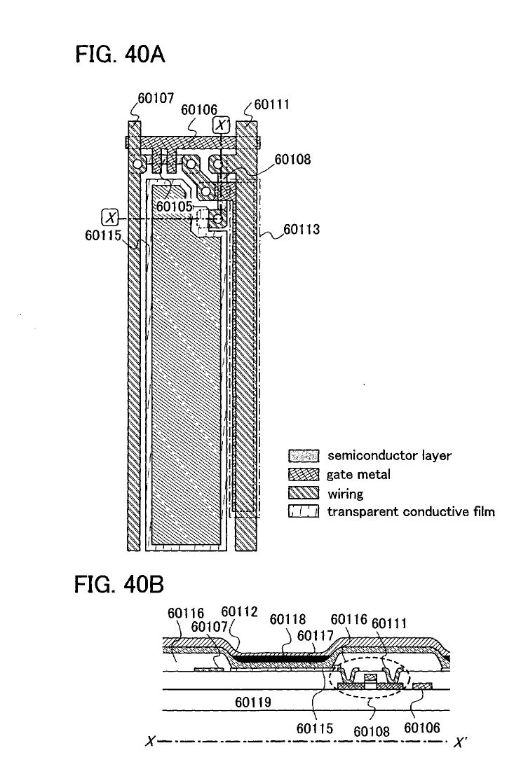

FIG. 40A is an example of a top view (a layout diagram) of a pixel which includes two transistors. FIG. 40B is an example of a cross-sectional view taken along X-X′ in FIG. 40A.

FIGS. 40A and 40B shows a first transistor 60105, a first wiring 60106, a second wiring 60107, a second transistor 60108, a third wiring 60111, a counter electrode 60112, a capacitor 60113, a pixel electrode 60115, a partition wall 60116, an organic conductive film 60117, an organic thin film 60118, and a substrate 60119. Note that it is preferable that the first transistor 60105, the first wiring 60106, the second wiring 60107, the second transistor 60108, and the third wiring 60111 are used as a switching transistor, a gate signal line, a source signal line, a driving transistor, and a current supply line, respectively.

A gate electrode of the first transistor 60105 is electrically connected to the first wiring 60106. One of a source electrode and a drain electrode of the first transistor 60105 is electrically connected to the second wiring 60107. The other of the source electrode and the drain electrode of the first transistor 60105 is electrically connected to a gate electrode of the second transistor 60108 and one of electrodes of the capacitor 60113. Note that the gate electrode of the first transistor 60105 includes a plurality of gate electrodes. Thus, leakage current in an off state of the first transistor 60105 can be reduced.

One of a source electrode and a drain electrode of the second transistor 60108 is electrically connected to the third wiring 60111. The other of the source electrode and the drain electrode of the second transistor 60108 is electrically connected to the pixel electrode 60115. Thus, current flowing through the pixel electrode 60115 can be controlled by the second transistor 60108.

The organic conductive film 60117 is provided over the pixel electrode 60115, and the organic thin film 60118 (an organic compound layer) is provided thereover. The counter electrode 60112 is provided over the organic thin film 60118 (the organic compound layer). Note that the counter electrode 60112 may be formed over the entire surface so as to be connected to all the pixels in common, or may be patterned using a shadow mask or the like.

Light emitted from the organic thin film 60118 (the organic compound layer) is transmitted through either the pixel electrode 60115 or the counter electrode 60112.

In FIG. 40B, the case where light is emitted on the pixel electrode side, i.e., a side over which the transistor and the like are formed is referred to as bottom emission, and the case where light is emitted on the counter electrode side is referred to as top emission.

In the case of bottom emission, it is preferable to form the pixel electrode 60115 using a light-transmitting conductive film. On the other hand, in the case of top emission, it is preferable to form the counter electrode 60112 using a light-transmitting conductive film.

In a light-emitting device for color display, EL elements having respective light emission colors of R, G, and B may be separately formed, or an EL element having a single color may be formed over the entire surface and light emission of R, G, and B is obtained by using a color filter.

Note that the structures shown in FIGS. 40A and 40B are just examples, and various structures can be employed for a pixel layout, a cross-sectional structure, a stacking order of electrodes of an EL element, and the like, as well as the structures shown in FIGS. 40A and 40B. Further, as a light-emitting layer, various elements such as a crystalline element like an LED, and an element formed using an inorganic thin film can be used as well as the element formed using the organic thin film shown in the drawing.

Note that although this embodiment mode is described with reference to various drawings, the contents (or may be part of the contents) described in each drawing can be freely applied to, combined with, or replaced with the contents (or may be part of the contents) described in another drawing. Further, even more drawings can be formed by combining each part with another part in the above-described drawings.

Similarly, the contents (or may be part of the contents) described in each drawing of this embodiment mode can be freely applied to, combined with, or replaced with the contents (or may be part of the contents) described in a drawing in another embodiment mode. Further, even more drawings can be formed by combining each part with part of another embodiment mode in the drawings of this embodiment mode.

Note that this embodiment mode shows an example of an embodied case of the contents (or may be part of the contents) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

### Embodiment Mode 7

In this embodiment mode, examples of electronic devices are described.

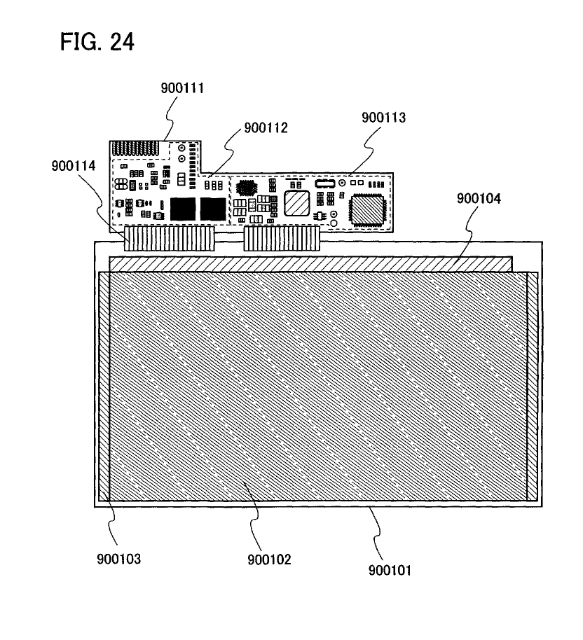

FIG. 24 shows a display panel module in which a display panel 900101 and a circuit board 900111 are combined. The display panel 900101 includes a pixel portion 900102, a scan line driver circuit 900103, and a signal line driver circuit 900104. The circuit board 900111 is provided with a control circuit 900112, a signal dividing circuit 900113, and the like, for example. The display panel 900101 and the circuit board 900111 are connected by a connection wiring 900114. As the connection wiring 900114, an FPC or the like can be used.

In the display panel 900101, the pixel portion 900102 and part of peripheral driver circuits (a driver circuit having low operation frequency among a plurality of driver circuits) may be formed over the same substrate by using transistors, and another part of the peripheral driver circuits (a driver circuit having high operation frequency among the plurality of driver circuits) may be formed over an IC chip. The IC chip may be mounted on the display panel 900101 by COG (chip on glass) or the like. Thus, the area of the circuit board 900111 can be reduced, so that a small display device can be obtained. Alternatively, the IC chip may be mounted on the display panel 900101 by using TAB (tape automated bonding) or a printed circuit board. Thus, the area of the circuit board 900111 can be reduced, so that a display device with a narrower frame can be obtained.

For example, in order to reduce power consumption, a pixel portion may be formed over a glass substrate by using transistors, and all peripheral circuits may be formed over an IC chip. The IC chip may be mounted on a display panel by COG or TAB.

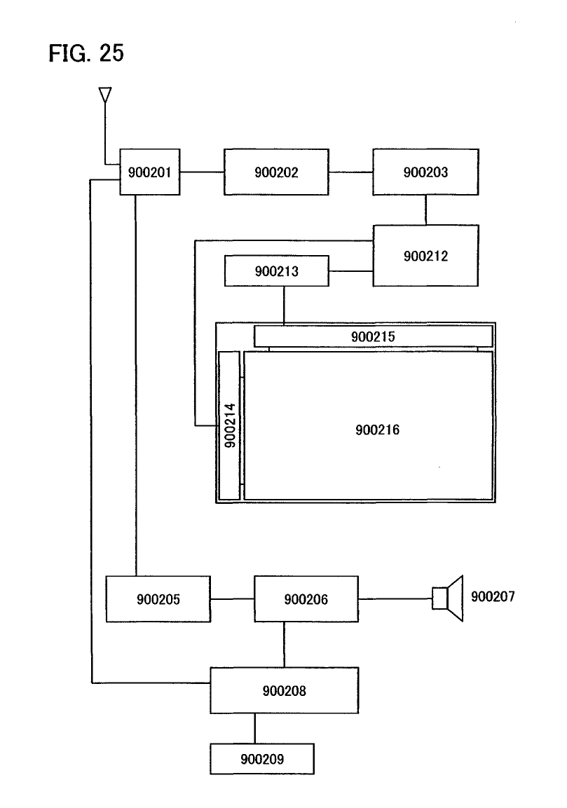

A television receiver can be completed with the display panel module shown in FIG. 24. FIG. 25 is a block diagram showing a main structure of a television receiver. A tuner 900201 receives a video signal and an audio signal. The video signal is processed by a video signal amplifier circuit 900202, a video signal processing circuit 900203 for converting a signal output from the video signal amplifier circuit 900202 into a color signal corresponding to each color of red, green, and blue, and a control circuit 900212 for converting the video signal into a signal which meets input specifications of a driver circuit. The control circuit 900212 outputs signals to a scan line drive circuit 900214 and a signal line drive circuit 900215. In the case of digital driving, a structure may be used in which a signal dividing circuit 900213 is provided on the signal line side and an input digital signal is divided into m (m is a positive integer) pieces to be supplied. The scanning lines drive circuit 900214 and the signal line drive circuit 900215 are electrically connected to a display panel 900216.

Among the signals received by the tuner 900201, the audio signal is transmitted to an audio signal amplifier circuit 900205, and output thereof is supplied to a speaker 900207 through an audio signal processing circuit 900206. A control circuit 900208 receives control information on a receiving station (reception frequency) and sound volume from an input portion 900209, and transmits a signal to the tuner 900201 or the audio signal processing circuit 900206.

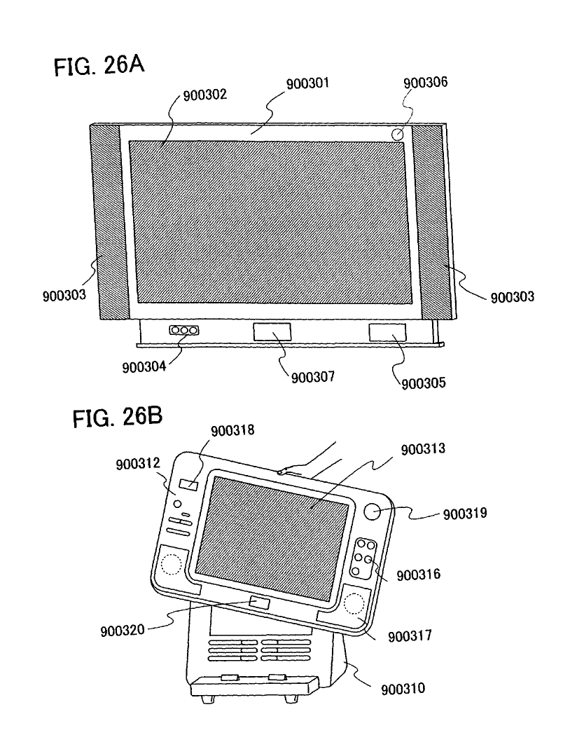

FIG. 26A shows a television receiver incorporated with a display panel module which is different from that of FIG. 25. In FIG. 26A, a display screen 900302 stored in a housing 900301 is formed using the display panel module. Note that speakers 900303, operation switches 900304, an input means 900305, a sensor 900306 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 900307, or the like may be provided as appropriate.

FIG. 26B shows a television receiver, only a display of which can be carried wirelessly. A battery and a signal receiver are incorporated in a housing 900312. The battery drives a display portion 900313, speaker portions 900317, a sensor 900319 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), and a microphone 900320. Electricity can be repeatedly stored in the battery by a charger 900310. The charger 900310 can transmit and receive a video signal and can transmit the video signal to the signal receiver of the display. The device shown in FIG. 26B is controlled by operation keys 900316. Alternatively, the device shown in FIG. 26B can transmit a signal to the charger 900310 by operating the operation keys 900316. That is, the device may be an image audio two-way communication device. Further alternatively, the device shown in FIG. 26B can transmit a signal to the charger 900310 by operating the operation keys 900316, and can control communication of another electronic device when the electronic device is made to receive a signal which can be transmitted from the charger 900310. That is, the device may be a general-purpose remote control device. Note that an input means 900318 or the like may be provided as appropriate. Note that the contents (or may be part of the contents) described in each drawing of this embodiment mode can be applied to the display portion 900313.

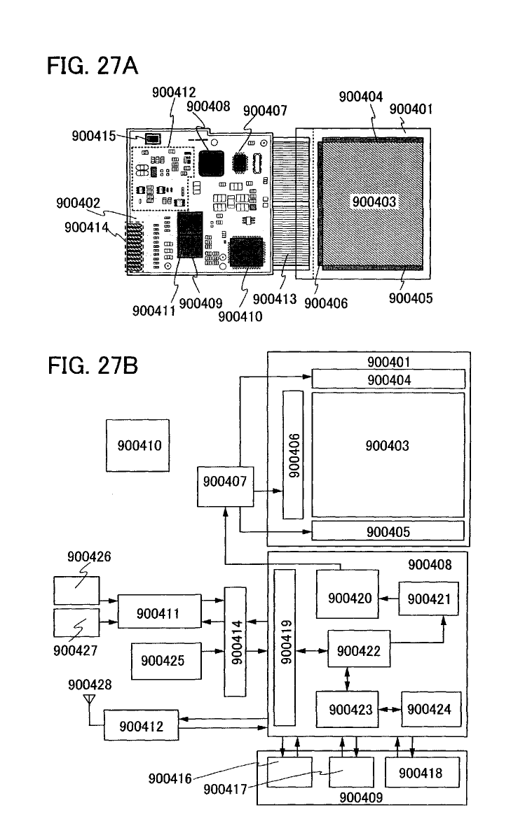

FIG. 27A shows a module in which a display panel 900401 and a printed wiring board 900402 are combined. The display panel 900401 may be provided with a pixel portion 900403 including a plurality of pixels, a first scan line driver circuit 900404, a second scan line driver circuit 900405, and a signal line driver circuit 900406 which supplies a video signal to a selected pixel.

The printed wiring board 900402 is provided with a timing controller 900407, a central processing unit (CPU) 900408, a memory 900409, a power supply circuit 900410, an audio processing circuit 900411, a transmitting/receiving circuit 900412, and the like. The printed wiring board 900402 and the display panel 900401 are connected by a flexible printed circuit (FPC) 900413. The flexible printed circuit (FPC) 900413 may be provided with a storage capacitor, a buffer circuit, or the like so as to prevent noise on power supply voltage or a signal, and increase in rise time of a signal. Note that the timing controller 900407, the audio processing circuit 900411, the memory 900409, the central processing unit (CPU) 900408, the power supply circuit 900410, and the like can be mounted on the display panel 900401 by using a COG (chip on glass) method. When a COG method is used, the size of the printed wiring board 900402 can be reduced.

Various control signals are input and output through an interface (I/F) portion 900414 provided for the printed wiring board 900402. In addition, an antenna port 900415 for transmitting and receiving a signal to/from an antenna is provided for the printed wiring board 900402.

FIG. 27B is a block diagram of the module shown in FIG. 27A. The module includes a VRAM 900416, a DRAM 900417, a flash memory 900418, and the like as the memory 900409. The VRAM 900416 stores data on an image displayed on the panel. The DRAM 900417 stores video data or audio data. The flash memory 900418 stores various programs.

The power supply circuit 900410 supplies electric power for operating the display panel 900401, the timing controller 900407, the central processing unit (CPU) 900408, the audio processing circuit 900411, the memory 900409, and the transmitting/receiving circuit 900412. Note that depending on panel specifications, the power supply circuit 900410 is provided with a current source in some cases.

The central processing unit (CPU) 900408 includes a control signal generation circuit 900420, a decoder 900421, a register 900422, an arithmetic circuit 900423, a RAM 900424, an interface (I/F) portion 900419 for the central processing unit (CPU) 900408, and the like. Various signals which are input to the central processing unit (CPU) 900408 through the interface (I/F) portion 900414 are once stored in the register 900422, and then input to the arithmetic circuit 900423, the decoder 900421, and the like. The arithmetic circuit 900423 performs operation based on the input signal so as to designate a location to which various instructions are sent. On the other hand, the signal input to the decoder 900421 is decoded and input to the control signal generation circuit 900420. The control signal generation circuit 900420 generates a signal including various instructions based on the input signal, and transmits the signal to locations designated by the arithmetic circuit 900423, specifically the memory 900409, the transmitting/receiving circuit 900412, the audio processing circuit 900411, the timing controller 900407, and the like.

The memory 900409, the transmitting/receiving circuit 900412, the audio processing circuit 900411, and the timing controller 900407 operate in accordance with respective instructions. Operations thereof are briefly described below.

A signal input from an input means 900425 is transmitted to the central processing unit (CPU) 900408 mounted on the printed wiring board 900402 through the interface (I/F) portion 900414. The control signal generation circuit 900420 converts image data stored in the VRAM 900416 into a predetermined format based on the signal transmitted from the input means 900425 such as a pointing device or a keyboard, and transmits the converted data to the timing controller 900407.

The timing controller 900407 performs data processing of the signal including the image data transmitted from the central processing unit (CPU) 900408 in accordance with the panel specifications, and supplies the signal to the display panel 900401. The timing controller 900407 generates an Hsync signal, a Vsync signal, a clock signal (CLK), alternating voltage (AC Cont), and a switching signal L/R based on power supply voltage input from the power supply circuit 900410 or various signals input from the central processing unit (CPU) 900408, and supplies the signals to the display panel 900401.

The transmitting/receiving circuit 900412 processes a signal which is transmitted and received as a radio wave by an antenna 900428. Specifically, the transmitting/receiving circuit 900412 may include a high-frequency circuit such as an isolator, a band pass filter, a VCO (voltage controlled oscillator), an LPF (low pass filter), a coupler, or a balun. Among signals transmitted and received by the transmitting/receiving circuit 900412, a signal including audio information is transmitted to the audio processing circuit 900411 in accordance with an instruction from the central processing unit (CPU) 900408.

The signal including the audio information, which is transmitted in accordance with the instruction from the central processing unit (CPU) 900408, is demodulated into an audio signal by the audio processing circuit 900411 and is transmitted to a speaker 900427. An audio signal transmitted from a microphone 900426 is modulated by the audio processing circuit 900411 and is transmitted to the transmitting/receiving circuit 900412 in accordance with an instruction from the central processing unit (CPU) 900408.

The timing controller 900407, the central processing unit (CPU) 900408, the power supply circuit 900410, the audio processing circuit 900411, and the memory 900409 can be mounted as a package of this embodiment mode.

Needless to say, the present invention is not limited to the television receiver, and can be applied to various uses particularly as a large display medium such as an information display board at a train station, an airport, or the like, or an advertisement display board on the street, as well as a monitor of a personal computer.

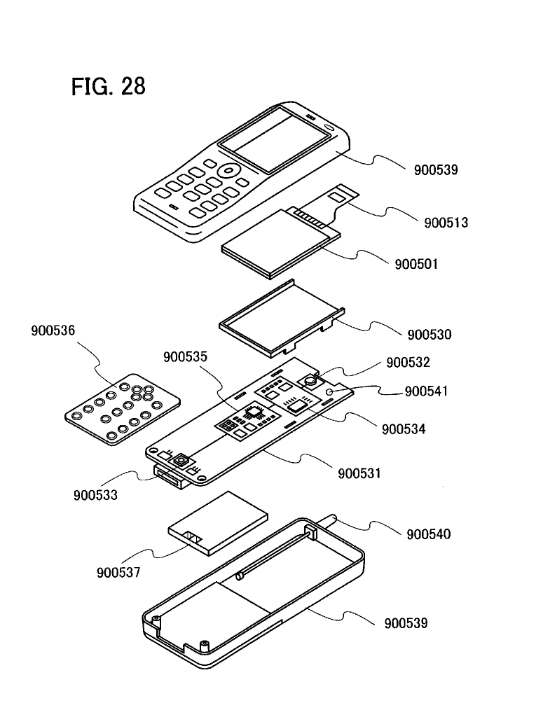

Next, a structural example of a mobile phone is described with reference to FIG. 28.

A display panel 900501 is incorporated in a housing 900530 so as to be detachable. The shape and the size of the housing 900530 can be changed as appropriate in accordance with the size of the display panel 900501. The housing 900530 to which the display panel 900501 is fixed is fitted into a printed circuit board 900531 and is assembled as a module.

The display panel 900501 is connected to the printed wiring board 900531 through an FPC 900513. The printed wiring board 900531 is provided with a speaker 900532, a microphone 900533, a transmitting/receiving circuit 900534, a signal processing circuit 900535 including a CPU, a timing controller, and the like, and a sensor 900541 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray). Such a module, an input means 900536, and a battery 900537 are combined and stored in a housing 900539. An antenna 900540 is provided with the housing 900539. A pixel portion of the display panel 900501 is provided so as to be seen from an opening window formed in the housing 900539.

In the display panel 900501, the pixel portion and part of peripheral driver circuits (a driver circuit having low operation frequency among a plurality of driver circuits) may be formed over the same substrate by using transistors, and another part of the peripheral driver circuits (a driver circuit having high operation frequency among the plurality of driver circuits) may be formed over an IC chip. The IC chip may be mounted on the display panel 900501 by COG (chip on glass). Alternatively, the IC chip may be connected to a glass substrate by using TAB (tape automated bonding) or a printed circuit board. With such a structure, power consumption of the mobile phone can be reduced, so that operation time of the mobile phone per charge can be extended. In addition, cost of the mobile phone can be reduced.

The mobile phone shown in FIG. 28 has various functions such as a function of displaying a variety of information (e.g., a still image, a moving image, and a text image); a function of displaying a calendar, a date, time, or the like on a display portion; a function of operating or editing the information displayed on the display portion; a function of controlling processing by a variety of software (programs); a wireless communication function; a function of communicating with another mobile phone, a fixed phone, or an audio communication device by using the wireless communication function; a function of connecting with a variety of computer networks by using the wireless communication function; a function of transmitting or receiving a variety of data by using the wireless communication function; a function of operating a vibrator in accordance with incoming call, reception of data, or an alarm; and a function of generating a sound in accordance with incoming call, reception of data, or an alarm. Note that functions of the mobile phone shown in FIG. 28 are not limited to them, and the mobile phone can have various functions.

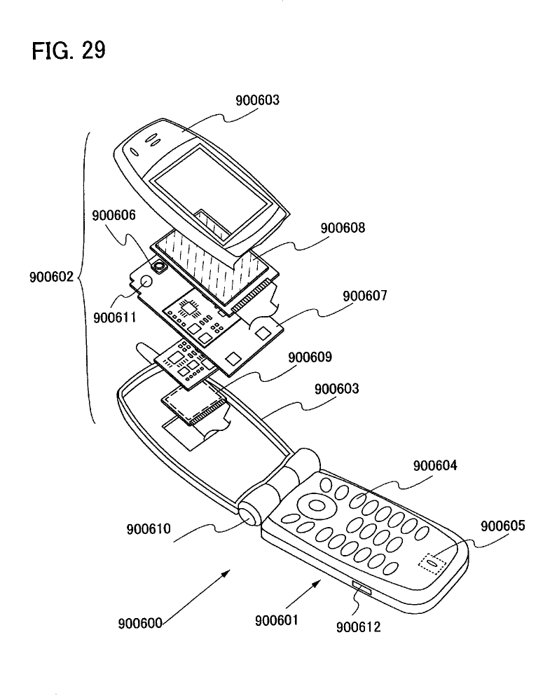

In a mobile phone shown in FIG. 29, a main body (A) 900601 which is provided with an operation switch 900604, a microphone 900605, an input means 900612 and the like is connected to a main body (B) 900602 which is provided with a display panel (A) 900608, a display panel (B) 900609, a speaker 900606, a sensor 900611 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), and the like by using a hinge 900610 so that the mobile phone can be opened and closed. The display panel (A) 900608 and the display panel (B) 900609 are stored in a housing 900603 of the main body (B) 900602 together with a circuit board 900607. Each of pixel portions of the display panel (A) 900608 and the display panel (B) 900609 is provided so as to be seen from an opening window formed in the housing 900603.

Specifications of the display panel (A) 900608 and the display panel (B) 900609, such as the number of pixels, can be set as appropriate in accordance with functions of a mobile phone 900600. For example, the display panel (A) 900608 can be used as a main screen and the display panel (B) 900609 can be used as a sub screen.

Each of the mobile phones of this embodiment mode can be changed in various modes depending on functions or applications thereof. For example, it may be a camera-equipped mobile phone by incorporating an imaging element in a portion of the hinge 900610. When the operation switch 900604, the display panel (A) 900608, and the display panel (B) 900609 are stored in one housing, the above-described advantageous effects can be obtained. Further, similar advantageous effects can be obtained when the structure of this embodiment mode is applied to an information display terminal provided with a plurality of display portions.

The mobile phone shown in FIG. 29 has various functions such as a function of displaying a variety of information (e.g., a still image, a moving image, and a text image); a function of displaying a calendar, a date, time, or the like on a display portion; a function of operating or editing the information displayed on the display portion; a function of controlling processing by a variety of software (programs); a wireless communication function; a function of communicating with another mobile phone, a fixed phone, or an audio communication device by using the wireless communication function; a function of connecting with a variety of computer networks by using the wireless communication function; a function of transmitting or receiving a variety of data by using the wireless communication function; a function of operating a vibrator in accordance with incoming call, reception of data, or an alarm; and a function of generating a sound in accordance with incoming call, reception of data, or an alarm. Note that functions of the mobile phone shown in FIG. 29 are not limited to them, and the mobile phone can have various functions.

The contents (or may be part of the contents) described in each drawing of this embodiment mode can be applied to various electronic devices. Specifically, the contents (or may be part of the contents) described in each drawing of this embodiment mode can be applied to display portions of electronic devices. Examples of such electronic devices are cameras such as a video camera and a digital camera, a goggle-type display, a navigation system, an audio reproducing device (e.g., a car audio component or an audio component), a computer, a game machine, a portable information terminal (e.g., a mobile computer, a mobile phone, a mobile game machine, or an electronic book), an image reproducing device provided with a recording medium (specifically, a device which reproduces a recording medium such as a digital versatile disc (DVD) and has a display for displaying a reproduced image), and the like.

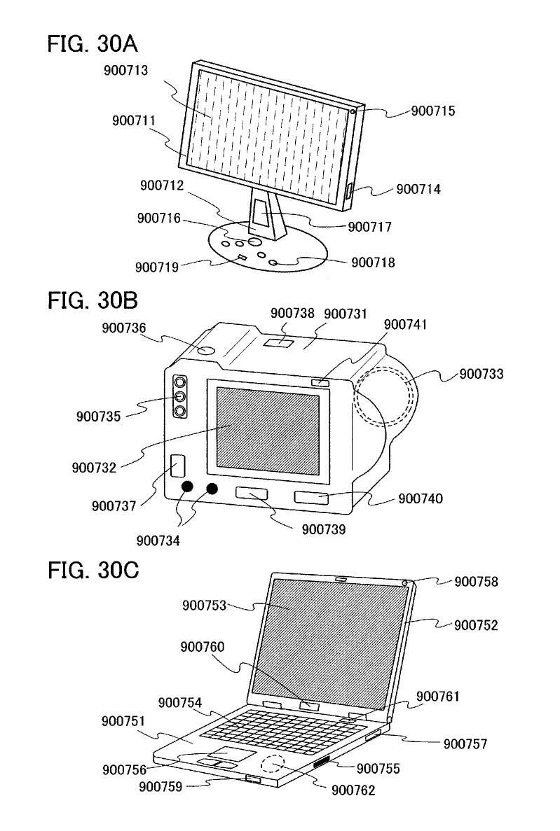

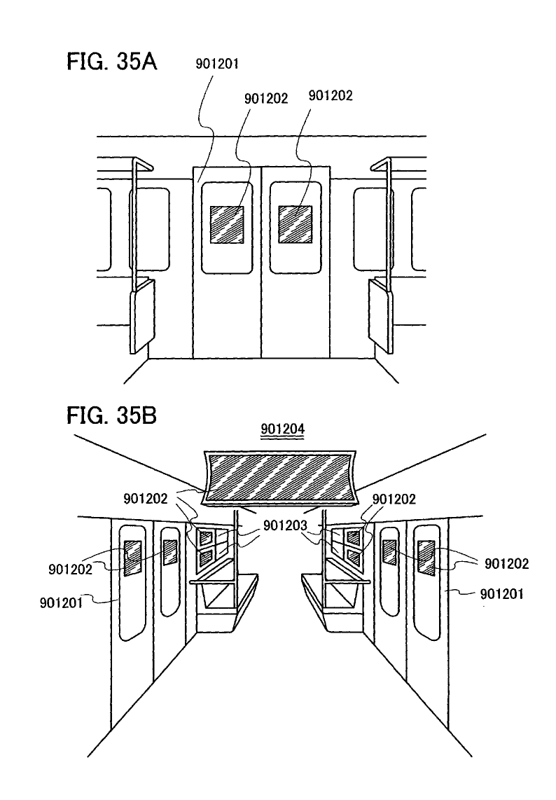

FIG. 30A shows a display, which includes a housing 900711, a support base 900712, a display portion 900713, an input means 900714, a sensor 900715 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 900716, a speaker 900717, operation keys 900718, an LED lamp 900719, and the like. The display shown in FIG. 30A has a function of displaying a variety of information (e.g., a still image, a moving image, and a text image) on the display portion. Note that the display shown in FIG. 35A is not limited to having this function, and can have various functions.

FIG. 30B shows a camera, which includes a main body 900731, a display portion 900732, an image receiving portion 900733, operation keys 900734, an external connection port 900735, a shutter button 900736, an input means 900737, a sensor 900738 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 900739, a speaker 900740, an LED lamp 900741, and the like. The camera shown in FIG. 30B has a function of photographing a still image and a moving image; a function of automatically correcting the photographed image (the still image or the moving image); a function of storing the photographed image in a recording medium (provided outside or incorporated in the camera); and a function of displaying the photographed image on the display portion. Note that the camera shown in FIG. 30B is not limited to having these functions, and can have various functions.

FIG. 30C shows a computer, which includes a main body 900751, a housing 900752, a display portion 900753, a keyboard 900754, an external connection port 900755, a pointing device 900756, an input means 900757, a sensor 900758 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 900759, a speaker 900760, an LED lamp 900761, a reader/writer 900762, and the like. The computer shown in FIG. 30C has a function of displaying a variety of information (e.g., a still image, a moving image, and a text image) on the display portion; a function of controlling processing by a variety of software (programs); a communication function such as wireless communication or wire communication; a function of connecting to various computer networks by using the communication function; and a function of transmitting or receiving a variety of data by using the communication function. Note that the computer shown in FIG. 30C is not limited to having these functions, and can have various functions.

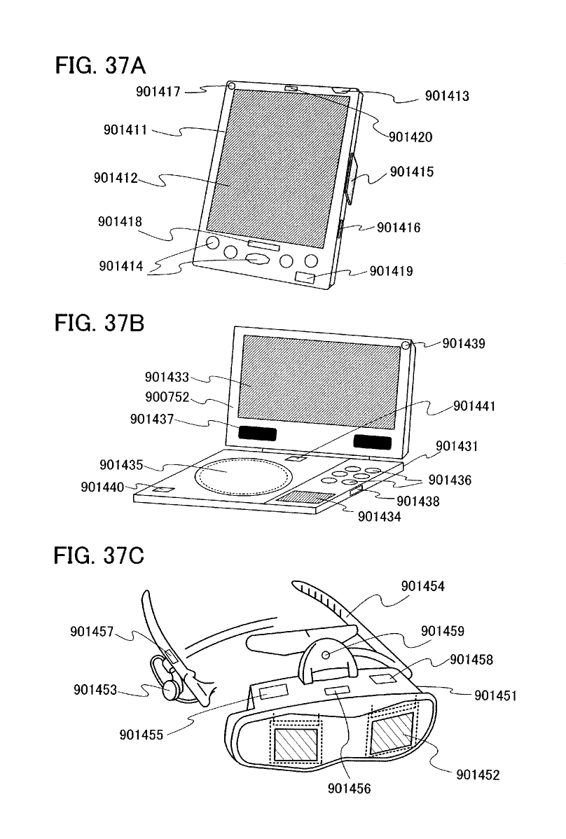

FIG. 37A shows a mobile computer, which includes a main body 901411, a display portion 901412, a switch 901413, operation keys, 901414, an infrared port 901415, an input means 901416, a sensor 901417 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 901418, a speaker 901419, an LED lamp 901420, and the like. The mobile computer shown in FIG. 37A has a function of displaying a variety of information (e.g., a still image, a moving image, and a text image) on the display portion; a touch panel function on the display portion; a function of displaying a calendar, a date, the time, and the like on the display portion; a function of controlling processing by a variety of software (programs); a wireless communication function; a function of connecting to various computer networks by using the wireless communication function; and a function of transmitting or receiving a variety of data by using the wireless communication function. Note that the mobile computer shown in FIG. 37A is not limited to having these functions, and can have various functions.

FIG. 37B shows a portable image reproducing device provided with a recording medium (e.g., a DVD reproducing device), which includes a main body 901431, a housing 901432, a display portion A 901433, a display portion B 901434, a recording medium (e.g., DVD) reading portion 901435, operation keys 901436, a speaker portion 901437, an input means 901438, a sensor 901439 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 901440, an LED lamp 901441, and the like. The display portion A 901433 can mainly display image information, and the display portion B 901434 can mainly display text information.

FIG. 37C shows a goggle-type display, which includes a main body 901451, a display portion 901452, an earphone 901453, a support portion 901454, an input means 901455, a sensor 901456 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 901457, a speaker 901458, a LED lamp 901459 and the like. The goggle-type display shown in FIG. 37C has a function of displaying an image (e.g., a still image, a moving image, or a text image) which is externally obtained on the display portion. Note that the goggle-type display shown in FIG. 37C is not limited to having these functions, and can have various functions.

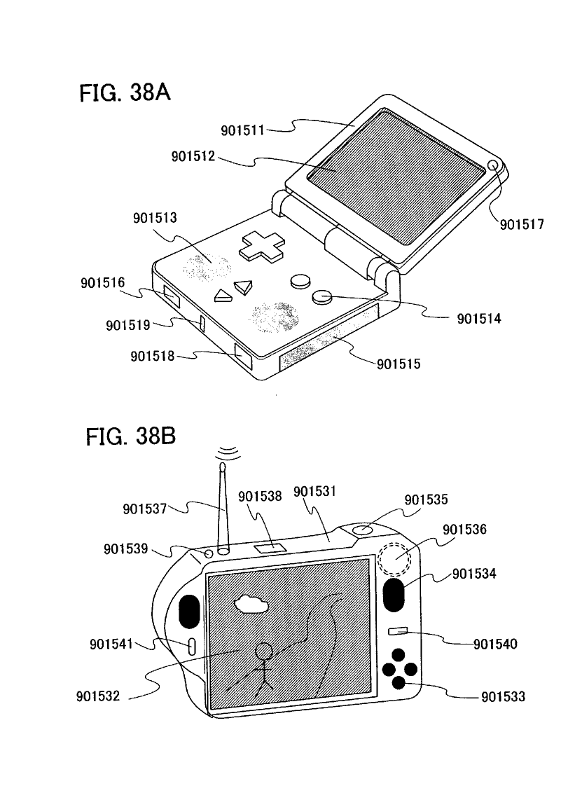

FIG. 38A shows a portable game machine, which includes a housing 901511, a display portion 901512, speaker portions 901513, operation keys 901514, a recording medium insert portion 901515, an input means 901516, a sensor 901517 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 901518, an LED lamp 901519, and the like. The portable game machine shown in FIG. 28A has a function of reading a program or data stored in the recording medium to display on the display portion, and a function of sharing information with another portable game machine by wireless communication. Note that the portable game machine shown in FIG. 38A is not limited to having these functions, and can have various functions.

FIG. 38B shows a digital camera having a television reception function, which includes a main body 901531, a display portion 901532, operation keys 901533, a speaker 901534, a shutter button 901535, an image receiving portion 901536, an antenna 901537, an input means 901538, a sensor 901539 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 901540, an LED lamp 901541, and the like. The digital camera having the television reception function shown in FIG. 38B has a function of photographing a still image and a moving image; a function of automatically correcting the photographed image; a function of obtaining a variety of information from the antenna; a function of storing the photographed image or the information obtained from the antenna; and a function of displaying the photographed image or the information obtained from the antenna on the display portion. Note that the digital camera having the television reception function shown in FIG. 38B is not limited to having these functions, and can have various functions.

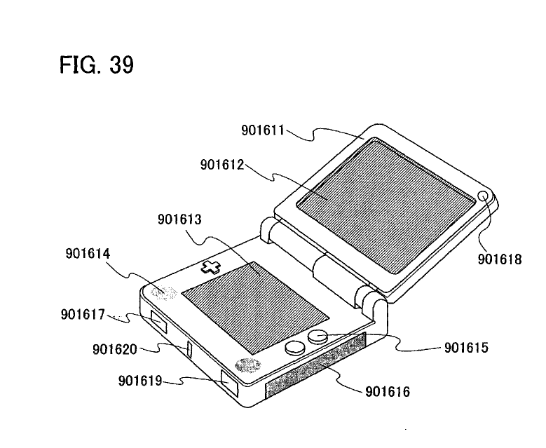

FIG. 39 shows a portable game machine, which includes a housing 901611, a first display portion 901612, a second display portion 901613, speaker portions 901614, operation keys 901615, a recording medium insert portion 901616, an input means 901617, a sensor 901618 (having a function of measuring force, displacement, position, speed, acceleration, angular velocity, rotation number, distance, light, liquid, magnetism, temperature, chemical reaction, sound, time, hardness, electric field, current, voltage, electric power, radial ray, flow rate, humidity, gradient, vibration, smell, or infrared ray), a microphone 901619, an LED lamp 901620, and the like. The portable game machine shown in FIG. 39 has a function of reading a program or data stored in the recording medium to display on the display portion, and a function of sharing information with another portable game machine by wireless communication. Note that the portable game machine shown in FIG. 39 is not limited to having these functions, and can have various functions.

As shown in FIGS. 30A to 30C, FIGS. 37A to 37C, and FIGS. 38A to 38B, an electronic device includes a display portion for displaying some information. When the electronic device includes two display panels, one of display panels (i.e., a peripheral portion of a display region of the one of the display panels) is provided with circuits which are necessary for operating the display panels or circuits which are necessary for the electronic device in which the display panels are incorporated. Thus, the electronic device can be made smaller. Further, since the number of electronic components which are mounted on display portions can be reduced, the electronic device can be made thinner.

Next, an application of a semiconductor device is described.

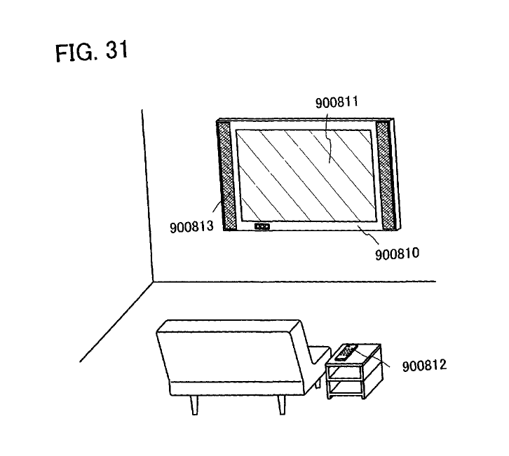

FIG. 31 shows an example in which the semiconductor device is incorporated in a structure. FIG. 31 shows a housing 900810, a display panel 900811, a remote controller 900812 which is an operation portion, a speaker portion 900813, and the like. The semiconductor device is incorporated in the structure as a wall-hanging type, so that the semiconductor device can be provided without requiring a wide space.

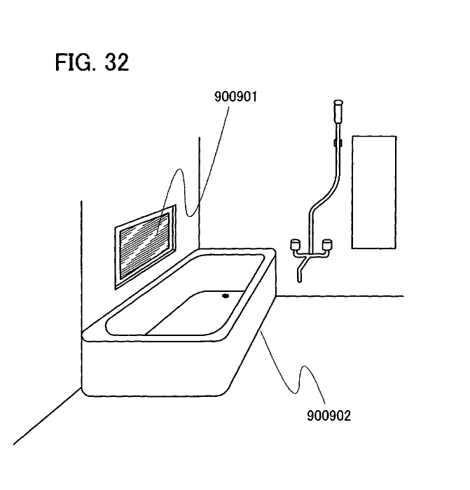

FIG. 32 shows another example in which the semiconductor device is incorporated in a structure. A display panel 900901 is incorporated in a prefabricated bath unit 900902, so that a bather can view the display panel 900901. The display panel 900901 has a function of displaying information by an operation of the bather. The display panel 900901 can be utilized for advertisement or an amusement means.

Note that the semiconductor device can be provided in various places as well as on a sidewall of the prefabricated bath unit 900902 shown in FIG. 32. For example, the semiconductor device may be incorporated in part of a mirror or the bathtub itself. At this time, the shape of the display panel 900901 may be a shape in accordance with the mirror or the bathtub.

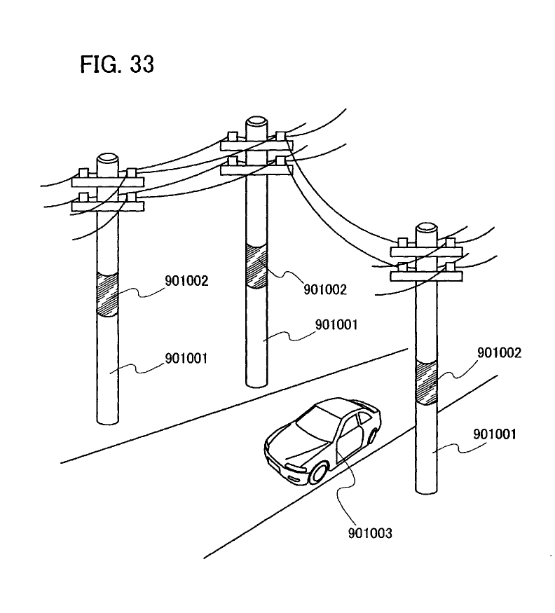

FIG. 33 shows another example in which the semiconductor device is incorporated in a structure. Display panels 901002 are curved in accordance with curved surfaces of columnar objects 901001. Note that here, the columnar objects 901001 are described as telephone poles.

The display panels 901002 shown in FIG. 33 are provided in positions higher than a human eye level. When the display panels 901002 are provided for structures standing outside to each other in large numbers, such as telephone poles, advertisement can be performed to an unspecified number of viewers. Here, since the display panels 901002 can easily display the same images by control from outside and can easily switch images instantly, extremely effective information display and advertising effects can be expected. When self-luminous display elements are provided in the display panels 901002, the display panels 901002 are effectively used as highly visible display media even at night. When the display panels 901002 are provided for the telephone poles, power supply means of the display panels 901002 can be easily secured. In an emergency such as a disaster, the display panels 901002 can be means for quickly transmitting precise information to victims.

Note that as each of the display panels 901002, a display panel in which a display element is driven by providing a switching element such as an organic transistor over a film-shaped substrate so that an image is displayed can be used.

Note that although this embodiment describes the wall, the prefabricated bath unit, and the columnar object as examples of the structure, this embodiment mode is not limited to this, and the semiconductor device can be provided for various structures.

Next, an example is described in which the semiconductor device is incorporated in a moving object.

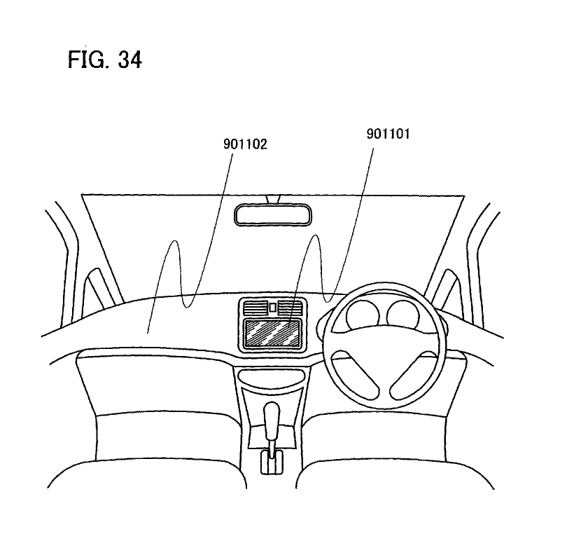

FIG. 34 shows an example in which the semiconductor device is incorporated in a car. A display panel 901102 is incorporated in a car body 901101 of the car and can display information on an operation of the car or information input from inside or outside of the car on an on-demand basis. Note that the display panel 901102 may have a navigation function.

Note that the semiconductor device can be provided in various positions as well as the car body 901101 shown in FIG. 34. For example, the semiconductor device may be incorporated in a glass window, a door, a steering wheel, a shift lever, a seat, a room mirror, or the like. At this time, the shape of the display panel 901102 may be a shape in accordance with a shape of an object in which the display panel 901102 is provided.

FIGS. 35A and 35B each show an example in which the semiconductor device is incorporated in a train car.

FIG. 35A shows an example in which display panels 901202 are provided for glasses of a door 901201 of the train car. The display panels 901202 have an advantage over conventional paper-based advertisement that labor cost which is necessary for switching advertisement is not needed. Since the display panels 901202 can instantly switch images displayed on display portions by external signals, images on the display panels can be switched as the type of train passenger changes in accordance with different time periods, for example, so that a more effective advertising effect can be expected.

FIG. 35B shows an example in which display panels 901202 are provided for glass windows 901203 and a ceiling 901204 as well as the glasses of the doors 901201 of the train car. Since the semiconductor device can be easily provided in a position in which the semiconductor device is conventionally difficult to be provided in this manner, an effective advertisement effect can be obtained. Since the semiconductor device can instantly switch images displayed on the display portion by external signals, cost and time generated in advertisement switching can be reduced, so that more flexible advertisement operation and information transmission can be performed.

Note that the semiconductor device can be provided in various positions as well as the doors 901201, the glass windows 901203, and the ceiling 901204 which are shown in FIGS. 35A and 35B. For example, the semiconductor device may be incorporated in a hand strap, a seat, a handrail, a floor, or the like. At this time, the shape of the display panel 901202 may be a shape in accordance with a shape of an object in which the display panel 901202 is provided.

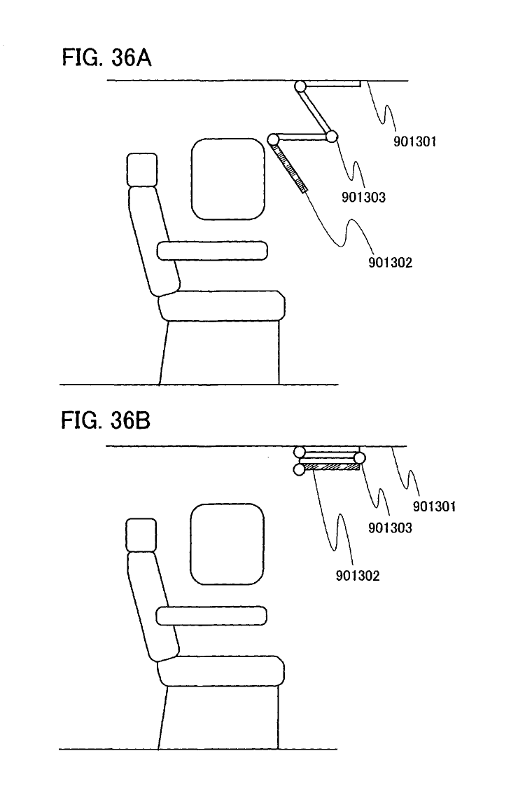

FIGS. 36A and 36B each show an example in which the semiconductor device is incorporated in a passenger airplane.

FIG. 36A shows a shape in use when a display panel 901302 is provided for a ceiling 901301 above a seat of the passenger airplane. The display panel 901302 is incorporated in the ceiling 901301 through a hinge portion 901303, and a passenger can view the display panel 901302 by a telescopic motion of the hinge portion 901303. The display panel 901302 has a function of displaying information by an operation of the passenger. The display panel 901302 can be utilized for advertisement or an amusement means. When the display panel 901302 is stored on the ceiling 901301 by folding the hinge portion 901303 as shown in FIG. 36B, safety during takeoff and landing can be secured. Note that the display panel 901302 can also be utilized as a medium and a guide light by lighting display elements of the display panel 901302 in an emergency.

Note that the semiconductor device can be incorporated in various positions as well as the ceiling 901301 shown in FIGS. 36A and 36B. For example, the semiconductor device may be incorporated in a seat, a table, an armrest, a window, or the like. A large display panel which can be viewed simultaneously by a plurality of people may be provided on a wall of an airframe. At this time, the shape of the display panel 901302 may be a shape in accordance with a shape of an object in which the display panel 901302 is provided.

Note that although this embodiment mode describes the train car body, the car body, and the airplane body as examples of moving objects, the present invention is not limited to them, and the semiconductor device can be provided in various objects such as a motorbike, a four-wheeled vehicle (including a car, a bus, and the like), a train (including a monorail, a railroad, and the like), and a vessel. Since display on display panels in a moving object can be switched instantly by external signals, the semiconductor device can be used for an advertisement display board for an unspecified number of customers, an information display board in an emergency, or the like by providing the semiconductor device in the moving object.

Note that although the case where one display panel is included and the case where a plurality of display panels are included are described at the same time in the structures shown in this embodiment mode, a structure where a first display panel and a second display panel are included may be used, as described in the above embodiment modes. Note that in the case where the first display panel and the second display panel are included, a compact display module can be formed by using a structure where the second display panel is included to be back on to the first display panel. Thus, the electronic device can be made smaller.

Note that although this embodiment mode is described with reference to various drawings, the contents (or may be part of the contents) described in each drawing can be freely applied to, combined with, or replaced with the contents (or may be part of the contents) described in another drawing. Further, even more drawings can be formed by combining each part with another part in the above-described drawings.

Similarly, the contents (or may be part of the contents) described in each drawing of this embodiment mode can be freely applied to, combined with, or replaced with the contents (or may be part of the contents) described in a drawing in another embodiment mode. Further, even more drawings can be formed by combining each part with part of another embodiment mode in the drawings of this embodiment mode.

Note that this embodiment mode shows an example of an embodied case of the contents (or may be part of the contents) described in other embodiment modes, an example of slight transformation thereof, an example of partial modification thereof, an example of improvement thereof, an example of detailed description thereof, an application example thereof, an example of related part thereof, or the like. Therefore, the contents described in other embodiment modes can be freely applied to, combined with, or replaced with this embodiment mode.

This application is based on Japanese Patent Application serial no. 2007-132898 filed with Japan Patent Office on May 18, 2007, the entire contents of which are hereby incorporated by reference.

What is claimed is:

1. A liquid crystal display device comprising:
a first display panel including a first terminal and a first display screen having a first liquid crystal element;
a second display panel including a second terminal, a circuit group, and a second display screen having a second liquid crystal element; and
a substrate including a wiring,
wherein the circuit group is electrically connected to the first terminal through the second terminal and the wiring, and
wherein the second display panel comprises a transistor including a semiconductor layer formed of a single-crystal semiconductor.

2. The liquid crystal display device according to claim 1, wherein a diagonal measurement of the first display screen is larger than a diagonal measurement of the second display screen.

3. The liquid crystal display device according to claim 1, wherein the number of pixels of the first display screen is larger than the number of pixels of the second display screen.

4. The liquid crystal display device according to claim 1, wherein the circuit group includes a timing controller.

5. The liquid crystal display device according to claim 1, wherein the circuit group includes a power supply circuit.

6. The liquid crystal display device according to claim 1, wherein the circuit group is shared between the first display panel and the second display panel.

7. The liquid crystal display device according to claim 1, wherein the first display panel includes a transistor including a semiconductor layer formed of a polycrystalline semiconductor.

8. The liquid crystal display device according to claim 1, wherein the first display panel includes a transistor including a semiconductor layer formed of a non-crystal semiconductor.

9. The liquid crystal display device according to claim 1, wherein the circuit group includes a transistor including a semiconductor layer formed of a single-crystal semiconductor, and
wherein the second display panel includes a transistor including a semiconductor layer formed of a polycrystalline semiconductor.

10. The liquid crystal display device according to claim 1, wherein the circuit group includes a transistor including a semiconductor layer formed of a single-crystal semiconductor, and
wherein the second display panel includes a transistor including a semiconductor layer formed of a non-crystal semiconductor.

11. An electronic device comprising the liquid crystal display device according to claim 1.

12. A liquid crystal display device comprising:
a first display panel including a first terminal and a first display screen having a first liquid crystal element;
a second display panel including a second terminal, a circuit group, and a second display screen having a second liquid crystal element;
a substrate including a wiring; and
an integrated circuit,
wherein the circuit group is electrically connected to the first terminal through the second terminal and the wiring,
wherein the integrated circuit is electrically connected to the second terminal through the wiring, and
wherein the second display panel includes a transistor including a semiconductor layer formed of a single-crystal semiconductor.

13. The liquid crystal display device according to claim 12, wherein a diagonal measurement of the first display screen is larger than a diagonal measurement of the second display screen.

14. The liquid crystal display device according to claim 12, wherein the number of pixels of the first display screen is larger than the number of pixels of the second display screen.

15. The liquid crystal display device according to claim 12, wherein the circuit group includes a timing controller.

16. The liquid crystal display device according to claim 12, wherein the circuit group includes a power supply circuit.

17. The liquid crystal display device according to claim 12, wherein the circuit group is shared between the first display panel and the second display panel.

18. The liquid crystal display device according to claim 12, wherein the first display panel includes a transistor including a semiconductor layer formed of a polycrystalline semiconductor.

19. The liquid crystal display device according to claim 12, wherein the first display panel includes a transistor including a semiconductor layer formed of a non-crystal semiconductor.

20. The liquid crystal display device according to claim 12, wherein the circuit group includes a transistor including a semiconductor layer formed of a single-crystal semiconductor, and
wherein the second display panel includes a transistor including a semiconductor layer formed of a polycrystalline semiconductor.

21. The liquid crystal display device according to claim 12, wherein the circuit group includes a transistor including a semiconductor layer formed of a single-crystal semiconductor, and
wherein the second display panel includes a transistor including a semiconductor layer formed of a non-crystal semiconductor.

22. An electronic device comprising the liquid crystal display device according to claim 12.

23. A liquid crystal display device comprising:
a first display panel including a first terminal and a first display screen having a first liquid crystal element;
a second display panel including a second terminal, a circuit group, and a second display screen having a second liquid crystal element;
a substrate including a wiring; and
a sensor,
wherein the circuit group is electrically connected to the first terminal through the second terminal and the wiring, and
wherein the sensor is electrically connected to the second terminal through the wiring.

24. The liquid crystal display device according to claim 23, wherein a diagonal measurement of the first display screen is larger than a diagonal measurement of the second display screen.

25. The liquid crystal display device according to claim 23, wherein the number of pixels of the first display screen is larger than the number of pixels of the second display screen.

26. The liquid crystal display device according to claim 23, wherein the circuit group includes a timing controller.

27. The liquid crystal display device according to claim 23, wherein the circuit group includes a power supply circuit.

28. The liquid crystal display device according to claim 23, wherein the circuit group is shared between the first display panel and the second display panel.

29. The liquid crystal display device according to claim 23, wherein the second display panel includes a transistor including a semiconductor layer formed of a single-crystal semiconductor.

30. The liquid crystal display device according to claim 23, wherein the first display panel includes a transistor including a semiconductor layer formed of a polycrystalline semiconductor, and
wherein the second display panel includes a transistor including a semiconductor layer formed of a single-crystal semiconductor.

31. The liquid crystal display device according to claim 23, wherein the first display panel includes a transistor including a semiconductor layer formed of a non-crystal semiconductor, and
wherein the second display panel includes a transistor including a semiconductor layer formed of a single-crystal semiconductor.

32. The liquid crystal display device according to claim 23, wherein the circuit group includes a transistor including a semiconductor layer formed of a single-crystal semiconductor, and
wherein the second display panel includes a transistor including a semiconductor layer formed of a polycrystalline semiconductor.

33. The liquid crystal display device according to claim 23, wherein the circuit group includes a transistor including a semiconductor layer formed of a single-crystal semiconductor, and
wherein the second display panel includes a transistor including a semiconductor layer formed of a non-crystal semiconductor.

34. An electronic device comprising the liquid crystal display device according to claim 23.

35. A liquid crystal display device comprising:
a first display panel including a first terminal and a first display screen having a first liquid crystal element;
a second display panel including a second terminal, a circuit group, and a second display screen having a second liquid crystal element;
a substrate including a wiring;
an integrated circuit; and
a sensor,
wherein the circuit group is electrically connected to the first display panel through the wiring,
wherein the integrated circuit is electrically connected to the first display panel and the second display panel through the wiring,
wherein the circuit group is electrically connected to the first terminal through the second terminal and the wiring,
wherein the integrated circuit is electrically connected to the second terminal through the wiring, and
wherein the sensor is electrically connected to the second terminal through the wiring.

36. The liquid crystal display device according to claim 35, wherein a diagonal measurement of the first display screen is larger than a diagonal measurement of the second display screen.

37. The liquid crystal display device according to claim 35, wherein the number of pixels of the first display screen is larger than the number of pixels of the second display screen.

38. The liquid crystal display device according to claim 35, wherein the circuit group includes a timing controller.

39. The liquid crystal display device according to claim 35, wherein the circuit group includes a power supply circuit.

40. The liquid crystal display device according to claim 35, wherein the circuit group is shared between the first display panel and the second display panel.

41. The liquid crystal display device according to claim 35, wherein the second display panel includes a transistor including a semiconductor layer formed of a single-crystal semiconductor.

42. The liquid crystal display device according to claim 35, wherein the first display panel includes a transistor including a semiconductor layer formed of a polycrystalline semiconductor, and
wherein the second display panel includes a transistor including a semiconductor layer formed of a single-crystal semiconductor.

43. The liquid crystal display device according to claim 35, wherein the first display panel includes a transistor including a semiconductor layer formed of a non-crystal semiconductor, and
wherein the second display panel includes a transistor including a semiconductor layer formed of a single-crystal semiconductor.

44. The liquid crystal display device according to claim 35, wherein the circuit group includes a transistor including a semiconductor layer formed of a single-crystal semiconductor, and
wherein the second display panel includes a transistor including a semiconductor layer formed of a polycrystalline semiconductor.

45. The liquid crystal display device according to claim 35, wherein the circuit group includes a transistor including a semiconductor layer formed of a single-crystal semiconductor, and
wherein the second display panel includes a transistor including a semiconductor layer formed of a non-crystal semiconductor.

46. An electronic device comprising the liquid crystal display device according to claim 35.

47. A liquid crystal display device comprising:
a first display panel including a first terminal, a level shifter, a driver circuit, and a first display screen having a first liquid crystal element;
a second display panel including a second terminal, a circuit group, and a second display screen having a second liquid crystal element; and
a substrate including a wiring,
wherein the circuit group is electrically connected to the first terminal through the second terminal and the wiring.

48. The liquid crystal display device according to claim 47, wherein a diagonal measurement of the first display screen is larger than a diagonal measurement of the second display screen.

49. The liquid crystal display device according to claim 47, wherein the number of pixels of the first display screen is larger than the number of pixels of the second display screen.

50. The liquid crystal display device according to claim 47, wherein the circuit group includes a timing controller.

51. The liquid crystal display device according to claim 47, wherein the circuit group includes a power supply circuit.

52. The liquid crystal display device according to claim 47, wherein the circuit group is shared between the first display panel and the second display panel.

53. The liquid crystal display device according to claim 47, wherein the second display panel includes a transistor including a semiconductor layer formed of a single-crystal semiconductor.

54. The liquid crystal display device according to claim 47, wherein the first display panel includes a transistor including a semiconductor layer formed of a polycrystalline semiconductor, and
wherein the second display panel includes a transistor including a semiconductor layer formed of a single-crystal semiconductor.

55. The liquid crystal display device according to claim 47, wherein the first display panel includes a transistor including a semiconductor layer formed of a non-crystal semiconductor, and
wherein the second display panel includes a transistor including a semiconductor layer formed of a single-crystal semiconductor.

56. The liquid crystal display device according to claim 47, wherein the circuit group includes a transistor including a semiconductor layer formed of a single-crystal semiconductor, and
wherein the second display panel includes a transistor including a semiconductor layer formed of a polycrystalline semiconductor.

57. The liquid crystal display device according to claim 47, wherein the circuit group includes a transistor including a semiconductor layer formed of a single-crystal semiconductor, and
wherein the second display panel includes a transistor including a semiconductor layer formed of a non-crystal semiconductor.

58. An electronic device comprising the liquid crystal display device according to claim 47.

59. A liquid crystal display device comprising:
a first display panel including a first terminal, a level shifter, a driver circuit, and a first display screen having a first liquid crystal element;
a second display panel including a second terminal, a circuit group, and a second display screen having a second liquid crystal element;
a substrate including a wiring; and
an integrated circuit,
wherein the circuit group is electrically connected to the first terminal through the second terminal and the wiring, and
wherein the integrated circuit is electrically connected to the second terminal through the wiring.

60. The liquid crystal display device according to claim 59, wherein a diagonal measurement of the first display screen is larger than a diagonal measurement of the second display screen.

61. The liquid crystal display device according to claim 59, wherein the number of pixels of the first display screen is larger than the number of pixels of the second display screen.

62. The liquid crystal display device according to claim 59, wherein the circuit group includes a timing controller.

63. The liquid crystal display device according to claim 59, wherein the circuit group includes a power supply circuit.

64. The liquid crystal display device according to claim 59, wherein the circuit group is shared between the first display panel and the second display panel.

65. The liquid crystal display device according to claim 59, wherein the second display panel includes a transistor including a semiconductor layer formed of a single-crystal semiconductor.

66. The liquid crystal display device according to claim 59, wherein the first display panel includes a transistor including a semiconductor layer formed of a polycrystalline semiconductor, and
wherein the second display panel includes a transistor including a semiconductor layer formed of a single-crystal semiconductor.

67. The liquid crystal display device according to claim 59, wherein the first display panel includes a transistor including a semiconductor layer formed of a non-crystal semiconductor, and
wherein the second display panel includes a transistor including a semiconductor layer formed of a single-crystal semiconductor.

68. The liquid crystal display device according to claim 59, wherein the circuit group includes a transistor including a semiconductor layer formed of a single-crystal semiconductor, and
wherein the second display panel includes a transistor including a semiconductor layer formed of a polycrystalline semiconductor.

69. The liquid crystal display device according to claim 59, wherein the circuit group includes a transistor including a semiconductor layer formed of a single-crystal semiconductor, and
wherein the second display panel includes a transistor including a semiconductor layer formed of a non-crystal semiconductor.

70. An electronic device comprising the liquid crystal display device according to claim 59.

71. A liquid crystal display device comprising:
a first display panel including a first terminal, a level shifter, a driver circuit, and a first display screen having a first liquid crystal element;
a second display panel including a second terminal, a circuit group, and a second display screen having a second liquid crystal element;
a substrate including a wiring; and
a sensor,
wherein the circuit group is electrically connected to the first terminal through the second terminal and the wiring, and
wherein the sensor is electrically connected to the second terminal through the wiring.

72. The liquid crystal display device according to claim 71, wherein a diagonal measurement of the first display screen is larger than a diagonal measurement of the second display screen.

73. The liquid crystal display device according to claim 71, wherein the number of pixels of the first display screen is larger than the number of pixels of the second display screen.

74. The liquid crystal display device according to claim 71, wherein the circuit group includes a timing controller.

75. The liquid crystal display device according to claim 71, wherein the circuit group includes a power supply circuit.

76. The liquid crystal display device according to claim 71, wherein the circuit group is shared between the first display panel and the second display panel.

77. The liquid crystal display device according to claim 71, wherein the second display panel includes a transistor including a semiconductor layer formed of a single-crystal semiconductor.

78. The liquid crystal display device according to claim 71, wherein the first display panel includes a transistor including a semiconductor layer formed of a polycrystalline semiconductor, and
wherein the second display panel includes a transistor including a semiconductor layer formed of a single-crystal semiconductor.

79. The liquid crystal display device according to claim 71, wherein the first display panel includes a transistor including a semiconductor layer formed of a non-crystal semiconductor, and
wherein the second display panel includes a transistor including a semiconductor layer formed of a single-crystal semiconductor.

80. The liquid crystal display device according to claim 71, wherein the circuit group includes a transistor including a semiconductor layer formed of a single-crystal semiconductor, and
wherein the second display panel includes a transistor including a semiconductor layer formed of a polycrystalline semiconductor.

81. The liquid crystal display device according to claim 71, wherein the circuit group includes a transistor including a semiconductor layer formed of a single-crystal semiconductor, and
wherein the second display panel includes a transistor including a semiconductor layer formed of a non-crystal semiconductor.

82. An electronic device comprising the liquid crystal display device according to claim 71.

83. A liquid crystal display device comprising:
a first display panel including a first terminal, a level shifter, a driver circuit, and a first display screen having a first liquid crystal element;
a second display panel including a second terminal, a circuit group, and a second display screen having a second liquid crystal element;
a substrate including a wiring;
an integrated circuit; and
a sensor,
wherein the circuit group is electrically connected to the first display panel through the wiring,
wherein the integrated circuit is electrically connected to the first display panel through the wiring,
wherein the circuit group is electrically connected to the first terminal through the second terminal and the wiring,
wherein the integrated circuit is electrically connected to the second terminal through the wiring, and
wherein the sensor is electrically connected to the second terminal through the wiring.

84. The liquid crystal display device according to claim 83, wherein a diagonal measurement of the first display screen is larger than a diagonal measurement of the second display screen.

85. The liquid crystal display device according to claim 83, wherein the number of pixels of the first display screen is larger than the number of pixels of the second display screen.

86. The liquid crystal display device according to claim 83, wherein the circuit group includes a timing controller.

87. The liquid crystal display device according to claim 83, wherein the circuit group includes a power supply circuit.

88. The liquid crystal display device according to claim 83, wherein the circuit group is shared between the first display panel and the second display panel.

89. The liquid crystal display device according to claim 83, wherein the second display panel includes a transistor including a semiconductor layer formed of a single-crystal semiconductor.

90. The liquid crystal display device according to claim 83,wherein the first display panel includes a transistor including a semiconductor layer formed of a polycrystalline semiconductor, and
wherein the second display panel includes a transistor including a semiconductor layer formed of a single-crystal semiconductor.

91. The liquid crystal display device according to claim 83,wherein the first display panel includes a transistor including a semiconductor layer formed of a non-crystal semiconductor, and
wherein the second display panel includes a transistor including a semiconductor layer formed of a single-crystal semiconductor.

92. The liquid crystal display device according to claim 83, wherein the circuit group includes a transistor including a semiconductor layer formed of a single-crystal semiconductor, and
wherein the second display panel includes a transistor including a semiconductor layer formed of a polycrystalline semiconductor.

93. The liquid crystal display device according to claim 83, wherein the circuit group includes a transistor including a semiconductor layer formed of a single-crystal semiconductor, and
wherein the second display panel includes a transistor including a semiconductor layer formed of a non-crystal semiconductor.

94. An electronic device comprising the liquid crystal display device according to claim 83.
